(19) United States
(12) Patent Application Publication
(10) Pub. No.: US 2022/0132564 A1
(43) Pub. Date: Apr. 28, 2022

(54) TERMINAL APPARATUS AND METHOD

(71) Applicants: SHARP KABUSHIKI KAISHA, Sakai City, Osaka (JP); FG Innovation Company Limited, Hong Kong (CN)

(72) Inventors: WATARU OUCHI, Sakai City, Osaka (JP); TAEWOO LEE, Sakai City, Osaka (JP); DAIICHIRO NAKASHIMA, Sakai City, Osaka (JP); SHOICHI SUZUKI, Sakai City, Osaka (JP)

(21) Appl. No.: 17/427,842

(22) PCT Filed: Mar. 4, 2020
(86) PCT No.: PCT/JP2020/009164

§ 371 Date: Aug. 2, 2021

(30) Foreign Application Priority Data
Mar. 28, 2019 (JP) 2019-063115

(51) Int. Cl. H04W 74/08; H04W 72/04

(52) U.S. Cl. CPC H04W 74/085; H04W 74/0866; H04W 80/02; H04W 72/0453; H04W 72/0446

(57) ABSTRACT

Communication is efficiently performed. A transmitter configured to transmit a random access preamble; a receiver configured to receive one or multiple MAC RARs corresponding to the random access preamble; and a MAC layer unit configured to perform a random access procedure are included. In a case that the random access procedure is not considered to be complete for an NR-Unlicensed (NR-U) cell, prior to transmission of the random access preamble, the transmitter performs a type 2 Channel Access Procedure (CAP) in a case that a value larger than a prescribed value is set to PREAMBLE_BACKOFF, and the transmitter performs a type 1 CAP in a case that a value smaller than the prescribed value is set to the PREAMBLE_BACKOFF.

### TECHNICAL FIELD

The present invention relates to a terminal apparatus and a method. This application claims priority based on JP 2019-63115 filed on Mar. 28, 2019, the contents of which are incorporated herein by reference.

### BACKGROUND ART

In the 3^{rd} Generation Partnership Project (3GPP), a radio access method and a radio network for cellular mobile communications (hereinafter referred to as “Long Term Evolution (LTE)” or “Evolved. Universal Terrestrial Radio Access (EUTRA)”) have been studied. In LTE, a base station apparatus may also be referred to as an evolved. NodeB (eNodeB), and a terminal apparatus may also be referred to as a User Equipment (UE). LTE is a cellular communication system in which multiple areas covered by a base station apparatus are distributed in a cell structure. One base station apparatus may manage one or multiple serving cells.

3GPP has been studying a next generation radio communication standard (New Radio (NR)) (NPL 1) to make a proposal for International Mobile Telecommunication (IMT)-2020, a standard for a next generation mobile communication system developed by the International Telecommunication Union (ITU). NR is required to satisfy requirements for three scenarios including enhanced Mobile BroadBand (eMBB), massive Machine Type Communication (mMTC), and Ultra Reliable and Low Latency Communication (URLLC) in a single technology framework.

In addition, the study of NR-Unlicensed (NR-U), which is a radio communication scheme and/or a radio communication system whereby the NR Radio Access Technology (NR-RAT) is applied to unlicensed frequency band (Unlicensed band, unlicensed spectrum), has been carried out (NPL 2).

### CITATION LIST

### Non Patent Literature

NPL 1: “New SID proposal: Study on New Radio Access Technology”, RP-160671, NTT DOCOMO, 3GPP TSG RAN Meeting #71, Goteborg, Sweden, 7-10 Mar. 2016.
NPL 2: “TR 38.889 v0.0.2 Study on NR-based. Access to Unlicensed Spectrum”, R1-1807617, Qualcomm incorporated, 3GPP TSG RAN WG1. Meeting #93, Busan, Korea, 21-25 May 2018.

### SUMMARY OF INVENTION

### Technical Problem

An aspect of the present invention provides a base station apparatus that efficiently performs communication, and a method used in the base station apparatus.

### Solution to Problem

(1) The first aspect of the present invention is a terminal apparatus including: a transmitter configured to transmit a random access preamble; a receiver configured to receive one or multiple Medium Access Control Random Access Responses (MAC RARs) corresponding to the random access preamble; and a MAC layer unit configured to perform a random access procedure, wherein in a case that the random access procedure is not considered to be complete for an NR-Unlicensed (NR-U) cell, prior to transmission of the random access preamble, the transmitter performs a type 2 Channel Access Procedure (CAP) in a case that a value larger than a prescribed value is set to PREAMBLE_BACKOFF, and the transmitter performs a type 1 CAP in a case that a value smaller than the prescribed value is set to the PREAMBLE_BACKOFF.

(2) The second aspect of the present invention is a method used for a terminal apparatus, including the steps of: transmitting a random access preamble; receiving one or multiple Medium Access Control Random Access Responses (MAC RARs) corresponding to the random access preamble; performing a random access procedure; and in a case that the random access procedure is not considered to be complete for an NR-Unlicensed (NR-U) cell, prior to transmission of the random access preamble, performing a type 2 Channel Access Procedure (CAP) in a case that a value larger than a prescribed value is set to PREAMBLE_BACKOFF, and performing a type 1 CAP in a case that a value smaller than the prescribed value is set to the PREAMBLE_BACKOFF.

### Advantageous Effects of Invention

According to an aspect of the present invention, the terminal apparatus can efficiently perform communication. The base station apparatus can efficiently perform communication.

### BRIEF DESCRIPTION OF DRAWINGS

FIG. 1 is a conceptual diagram of a radio communication system according to an aspect of the present embodiment.

FIG. 2 is an example illustrating a relationship between N^{slot}_{symb}, SCS configuration μ, and CP configuration according to an aspect of the present embodiment.

FIG. 3 is a schematic diagram illustrating an example of a resource grid in a subframe according to an aspect of the present embodiment.

FIG. 4 is a diagram illustrating an example of a relationship between a PUCCH format and length N^{PUCCH}_{symb} of the PUCCH format according to an aspect of the present embodiment.

FIG. 5 is a schematic block diagram illustrating a configuration of a terminal apparatus 1 according to an aspect of the present embodiment.

FIG. 6 is a schematic block diagram illustrating a configuration of a base station apparatus 3 according to an aspect of the present embodiment.

FIG. 7 is a diagram illustrating an example of a random access procedure according to an aspect of the present embodiment.

FIG. 8 is a diagram illustrating an example of a channel access procedure (CAP) according to an aspect of the present embodiment.

FIG. 9 is a diagram illustrating an example of a channel access priority class (CAPC) and a CW adjustment procedure (CWAP) according to an aspect of the present embodiment.

FIG. 10 is a diagram illustrating an example of the CAP and the CWAP in a case of SR transmission according to an aspect of the present embodiment.

FIG. 11 is a diagram illustrating an example of triggering/activation of a CSI report for possible CSI-RS configurations according to an aspect of the present embodiment.

FIG. 12 is a diagram illustrating an example of a configurable subband size according to an aspect of the present embodiment.

FIG. 13 is a diagram illustrating an example of priority report levels for part 2 CSI according to an aspect of the present embodiment.

FIG. 14 is a diagram illustrating an example of mapping patterns of a CSI wideband and a CSI subband according to an aspect of the present embodiment.

FIG. 15 is a diagram illustrating an example of frequency mapping (resource allocation, mapping to physical resources) according to the present embodiment.

FIG. 16 is a diagram illustrating an example of a configuration of a MAC subheader and a MAC PDU according to the present embodiment.

FIG. 17 is a diagram illustrating an example of a configuration of a MAC RAR and RAR grant fields for NR according to the present embodiment.

FIG. 18 is a diagram illustrating an example (example 1) of a configuration of the MAC RAR and the RAR grant fields for NR-U according to the present embodiment.

FIG. 19 is a diagram illustrating another example (example 2) of the configuration of the MAC RAR and the RAR grant fields for NR-U according to the present embodiment.

FIG. 20 is a diagram illustrating another example (example 3) of the configuration of the MAC RAR and the RAR grant fields for NR-U according to the present embodiment.

FIG. 21 is a diagram illustrating another example (example 4) of the configuration of the MAC RAR and the RAR grant fields for NR-U according to the present embodiment.

FIG. 22 is a diagram illustrating an example of fields (PUSCH starting position field, PSP field) indicating a transmission start position of a PUSCH in the time domain (start position in the time domain, start position in a slot) and a start position of the PUSCH corresponding to each SCS according to the present embodiment.

FIG. 23 is a diagram illustrating an example of a frequency resource allocation type of the PUSCH for NR-U according to the present embodiment.

FIG. 24 is a diagram illustrating an example of a Backoff Parameter Value (BPV) according to the present embodiment.

FIG. 25 is a diagram illustrating a procedure until Msg1 is transmitted in a case that the random access procedure has not completed according to the present embodiment.

### DESCRIPTION OF EMBODIMENTS

An embodiments present invention wilt be described below.

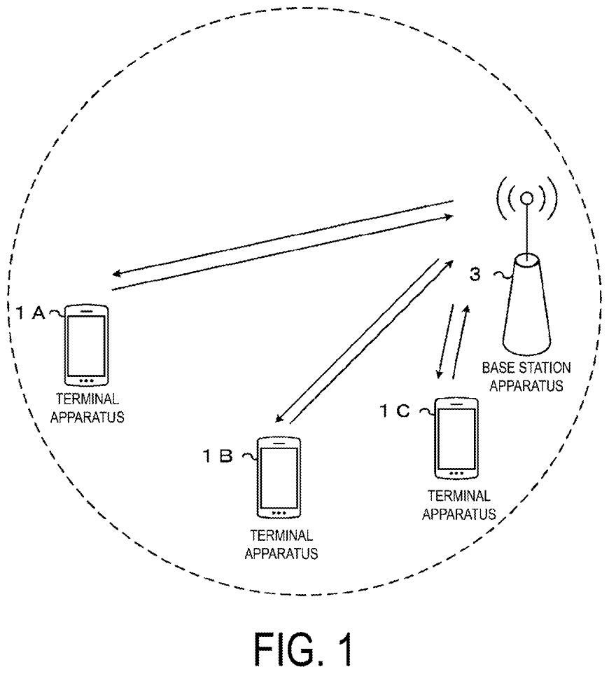

FIG. 1 is a conceptual diagram of a radio communication system according to an aspect of the present embodiment. In FIG. 1, the radio communication system includes terminal apparatuses 1A to 1C and a base station apparatus 3. The terminal apparatuses 1A to 1C may be hereinafter also referred to as a terminal apparatus 1. Note that the base station apparatus 3 may include a part or all of a communication apparatus, a node, a NodeB (NB), an eNB, a gNB, a network apparatus (core network, gateway), and an access point. The terminal apparatus 1 may be referred to as a User Equipment (UE). Note that the eNB is a node that provides an SUTRA user plane and control plane protocol termination for one or multiple terminal apparatuses 1, and in particular, the eNB that is connected to a fifth generation core network (SGC) through a Next Generation (NG) interface is referred to as an ng-eNB. The gNB is a node that provides an NR user plane and control plane protocol termination for one or multiple terminal apparatuses 1, and is connected to the SGC through the NG interface.

The base station apparatus 3 may include one or both of a Master Cell Group (MCG) and a Secondary Cell Group (SCG). The MCG is a group of serving cells at least including a Primary Cell (PCell). The SCG is a group of serving cells at least including a Primary Secondary Cell (PSCell). The PCell may be a serving cell that is given based on initial connection. The MCG may include one or multiple Secondary Cells (SCells). The SCG may include one or multiple SCells. The PCell and the PSCell may be referred to as a Special Cell (SpCell). Configuring one CC by using one SpCell and one or multiple SCells and performing communication may be referred to as carrier aggregation.

The MCG may include one or multiple serving cells in EUTRA. The SCG may include one or multiple serving cells in NR. The MCG may include one or multiple serving cells in NR. The SCG may include one or multiple serving cells in EUTRA. The MCG and the SCG may include one or multiple serving cells of either of EUTRA and NR. Here, “in EUTRA” may include meaning that an EUTRA Radio Access Technology (RAT) is applied. “in NR” may include meaning that an NR RAT is applied.

The MCG may include one or multiple serving cells in EUTRA. The SCG may include one or multiple serving cells in NR-U. The MCG may include one Or multiple serving cells in NR. The SCG may include one or multiple serving cells in NR-U. The MCG may include one or multiple serving cells of any one of EUTRA, NR, and NR-U. The SCG may include one or multiple serving cells of any one of EUTRA, NR, and NR-U. NR-U has the aim of performing communication/access/service of the NR scheme in a frequency band (operating band) that does not require frequency license. In a frequency band in which NR-U communication is performed, communication of a terminal apparatus and/or an access point (and/or a base station apparatus) that performs a radio LAN (Wireless Local Area Network) service (communication and/or scheme), a Wireless Access Systems (WAS) service, an IEEE802.11 service, a WiFi service, a Fixed Wireless Access (FWA) service, an Intelligent Transport Systems (ITS) service, and a Licensed Assisted Access (LAA) service may be performed. In contrast, NR has the aim of performing communication/access/service of the NR scheme in a frequency band that requires frequency license. LTE has the aim of performing communication/access/service of the LTE scheme in a frequency band that requires frequency license. LAA has the aim of performing communication/access/service of the LTE scheme in a frequency band that does not require frequency license.

Operating bands (carrier frequencies and frequency bandwidths) applied to each of EUTRA, NR, and NR-U may be individually defined (prescribed).

The MCG may include a first base station apparatus. The SCG may include a second base station apparatus. In other words, the PCell may include the first base station apparatus. The PSCell may include the second base station apparatus. Each of the first base station apparatus and the second base station apparatus may be the same as the base station apparatus 3.

In the following, frame configuration will be described.

In the radio communication system according to an aspect of the present embodiment, Orthogonal Frequency Division Multiplex (OFDM) is at least used. An OFDM symbol is a unit of OFDM in the time domain. The OFDM symbol at least includes one or multiple subcarriers. The OFDM symbol is converted into a time-continuous signal in baseband signal generation. In the downlink, Cyclic Prefix—Orthogonal Frequency Division Multiplex (CP-OFDM) is at least used. In the uplink, either of CP-OFDM and Discrete Fourier Transform—spread—Orthogonal Frequency Division Multiplex (DFT-s-OFDM) is used. DFT-s-OFDM may be given through application of Transform preceding to CP-OFDM.

A subcarrier spacing (SCS) may be given by subcarrier spacing Δf=2^{μ}·15 kHz. For example, SCS configuration μ may be configured to be any one of 0, 1, 2, 3, 4, and/or 5. For a certain BandWidth Part (BWP), the SCS configuration u may be given by a higher layer parameter. In other words, the value of u may be configured for each BWP (for each downlink BWP, for each uplink BWP) regardless of the downlink and/or the uplink.

In the radio communication system according to an aspect of the present embodiment, a time unit T_{c} is used for expression of the length in the time domain. The time unit T_{c} may be given by T_{c}=1/(Δfₘₐₓ·N_{f})Δfₘₐₓ may be a maximum value of the SCS supported in the radio communication system according to an aspect of the present embodiment. Δfₘₐₓ may be Δfₘₐₓ=480 kHz. N_{f} may be N_{f}=4096. A constant κ is κ=Δfₘₐₓ·N_{f}/(Δf_{ref}N_{f,ref})=64. Δf_{ref} may be 15 kHz. N_{f,ref} may be 2048.

The constant κ may be a value indicating a relationship between a reference SCS and T_{c}. The constant κ may be used for the length of a subframe. Based at least on the constant κ, the number of slots included in the subframe may be given. Δf_{ref} is a reference SCS, and N_{f,ref} is a value corresponding to the reference SCS.

Transmission of a signal in the downlink and/or transmission of a signal in the uplink is configured by a frame of 10 ms. The frame includes 10 subframes. The length of the subframe is 1 ms. The length of the frame may be given regardless of SCS Δf. In other words, configuration of the frame may be given regardless of the value of μ. The length of the subframe may be given regardless of SCS Δf. In other words, configuration of the subframe may be given regardless μ.

For a certain SCS configuration μ, the number and indexes of slots included in one subframe may be given. For example, a slot number n^{μ}ₛ may be given in ascending order in a range from 0 to N^{subframe, μ}ₛₗₒₜ−1 in the subframe. For the SCS configuration μ, the number and indexes of slots included in one frame may be given. The slot number n^{μ}_{s,f} may be given in ascending order in a range from 0 to N^{frame, μ}ₛₗₒₜ−1 in the frame. N^{slot}_{symb} continuous OFDM symbols may be included in one slot, N^{slot}_{symb} may be given based at least on a part or all of Cyclic Prefix (CP) configuration. The CP configuration may be given based at least on a higher layer parameter. The CP configuration may be given based at least on dedicated RRC signaling. The slot number may also be referred to as a slot index.

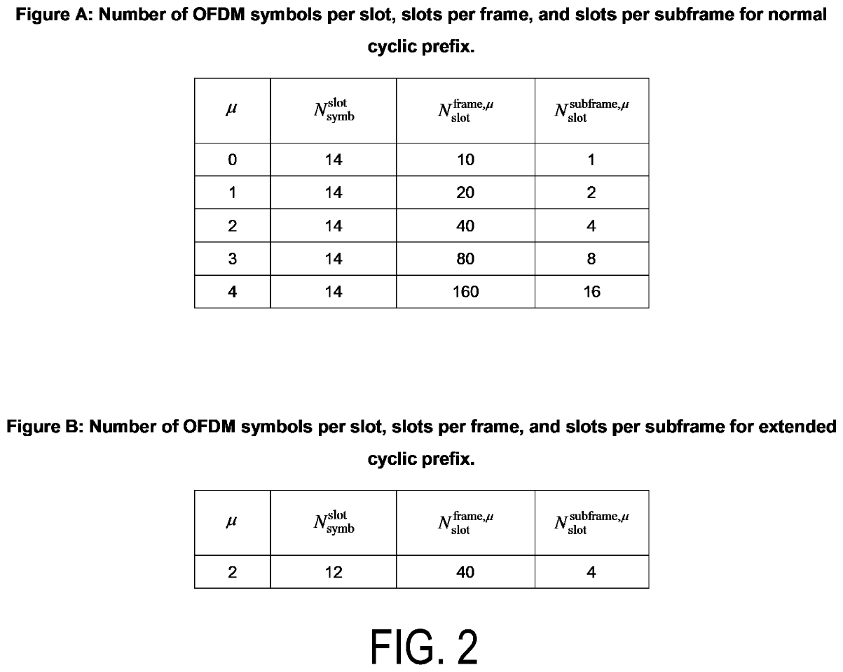

FIG. 2 is an example illustrating a relationship between N^{slot}_{symb}, the SCS configuration μ, and the CP configuration according to an aspect of the present embodiment. In FIG. 2A, for example, in a case that the SCS configuration μ is 2 and the CP configuration is a normal CP (NCP), N^{slot}_{symb}=14, N^{frame, μ}ₛₗₒₜ=40, and N^{subframe, μ}ₛₗₒₜ=4. In FIG. 2B, for example, in a case that the SCS configuration μ is 2 and the CP configuration is an extended CP (ECP), N^{slot}_{symb}=12, N^{frame, μ}ₛₗₒₜ=40, and N^{subframe, μ}ₛₗₒₜ=4.

In the following, description of physical resources according to the present embodiment will be given.

An antenna port is defined in a manner in which a channel through which a symbol is transmitted in one antenna port can be estimated from a channel through which another symbol is transmitted in the same antenna port. In a case that large scale property of a channel through which a symbol is transmitted in one antenna port can be estimated from a channel through which a symbol is transmitted in another antenna port, the two antenna ports may be referred to as being QCL (Quasi Co-Located). The large scale property may at least include long term performance of a channel. The large scale property may at least include a part or all of delay spread, Doppler spread, Doppler shift, an average gain, an average delay, and a beam parameter (spatial Rx parameters). The fact that the first antenna port and the second antenna port are QCL with respect to a beam parameter may mean that a receive beam assumed by a receiver for the first antenna port and a receive beam assumed by the receiver for the second antenna port arc the same. The fact that the first antenna port and the second antenna port are QCL with respect to a beam parameter may mean that a transmit beam assumed by a receiver for the first antenna port and a transmit beam assumed by the receiver for the second antenna port are the same. In a case that the large scale property of a channel through which a symbol is transmitted in one antenna port can be estimated from a channel through which a symbol is transmitted in another antenna port, the terminal apparatus 1 may assume that the two antenna ports are QCL. The fact that two antenna ports are QCL may mean that it is assumed that the two antenna ports are QCL.

For a set of the SCS configuration μ and the carrier, a resource grid defined by N^{size, μ}_{grid, x}N^{RB}_{sc} subcarriers and N^{subframe, μ}_{symb} OFDM symbols is given. N^{size, μ}_{grid, x} may indicate the number of resource blocks given for the SCS configuration μ of a carrier x. N^{size, μ}_{grid, x} may indicate a bandwidth of the carrier. N^{size, μ}_{grid, x} may correspond to a value of a higher layer parameter CarrierBandwidth. The carrier x may indicate either of a downlink carrier and an uplink carrier. In other words, x may be either of “DL” and “UL”, N^{RB}_{sc} may indicate the number of subcarriers included in one resource block. N^{RB}_{sc} may be 12. At least one resource grid may be given for each antenna port p, and/or for each SCS configuration μ, and/or for each configuration of a Transmission direction. The transmission direction at least includes a Downlink (DU) and an Uplink (UL). A set of parameters at least including a part or all of the antenna port p, the SCS configuration μ, and the configuration of the transmission direction may also be hereinafter referred to as a first radio parameter set. In other words, one resource grid may be given for each first radio parameter set. Note that the radio parameter set may be one or multiple sets including one or multiple radio parameters (physical layer parameters or higher layer parameters).

In the downlink, a carrier included in a serving cell is referred to as a downlink carrier (or a downlink component carrier). In the uplink, a carrier included in a serving cell is referred to as an uplink carrier (uplink component carrier). The downlink component carrier and the uplink component carrier may be collectively referred to as a component carrier (or a carrier).

A type of the serving cell may be any one of a PCell, a PSCell, and an SCell. The PCell may be a serving cell that is identified based at least on a cell ID (physical layer cell ID, physical cell ID) acquired from an SSB (Synchronization signal/Physical broadcast channel block) in initial connection. The SCell may be a serving cell that is used in carrier aggregation. The SCell may be a serving cell that is given based at least on dedicated ICRC signaling.

Each element in the resource grid given for each first radio parameter set may be referred to as a resource element (RE). The resource element is identified by an index k_{sc} in the frequency domain and an index 1_{sym} in the time domain. For a certain first radio parameter set, the resource element is identified by the index k_{sc} in the frequency domain and the index 1_{sym} in the time domain. The resource element identified by the index k_{sc} in the frequency domain and the index 1_{sym} in the time domain may also be referred to as a resource element (k_{sc}, 1_{sym}). The index k_{sc} in the frequency domain indicates a value of any one out of 0 to N^{μ}_{RB}N^{RB}_{sc}−1. N^{μ}_{RB} may be the number of resource blocks given for the SCS configuration μ. N^{μ}_{RB} may be N^{size, μ}_{grid, x}. N^{μ}_{RB} is the number of subcarriers included in the resource block, and N^{RB}_{sc}=12. The index k_{sc} in the frequency domain may correspond to the subcarrier index k_{sc}. The index in the time domain may correspond to the OFDM symbol index 1_{sym}. One or multiple resource elements may correspond to a physical resource and a complex value (complex value modulation symbol). One or multiple information bits (information bits for control information, a transport block, and a higher layer parameter) may be mapped for each of one or multiple resource elements corresponding to the physical resource and/or the complex value.

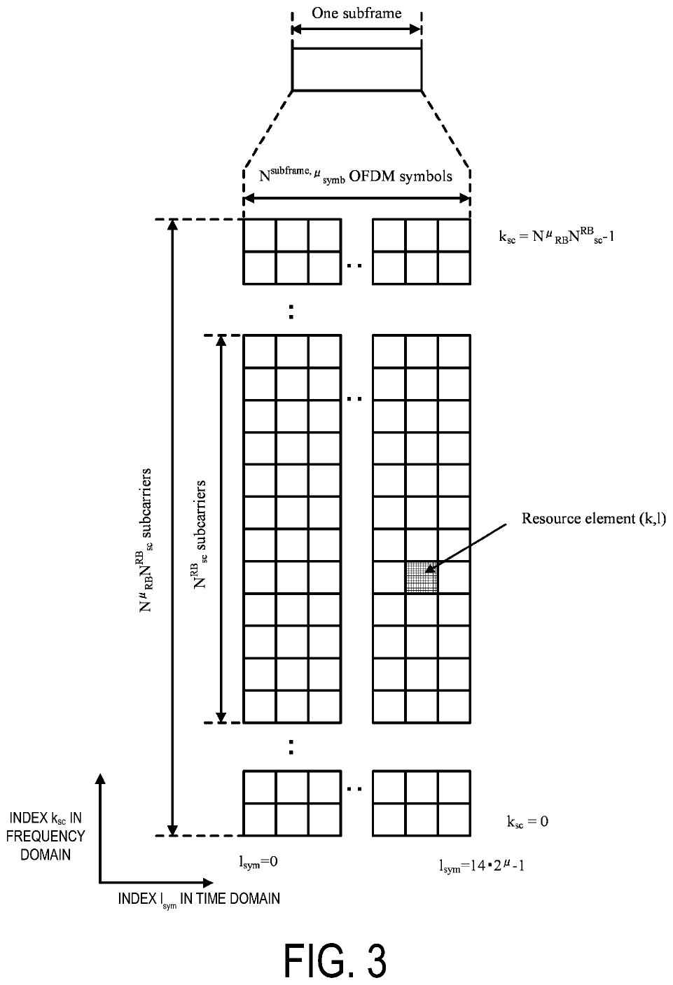

FIG. 3 is a schematic diagram illustrating an example of the resource grid in the subframe according to an aspect of the present embodiment. In the resource grid of FIG. 3, the horizontal axis is the index 1_{sym} in the time domain, and the vertical axis is the index k_{sc} in the frequency domain. In one subframe, the frequency domain of the resource grid includes N^{μ}_{RB}N^{RB}_{sc} subcarriers. In one subframe, the time domain of the resource grid may include 14·2^{μ} OFDM symbols. One resource block includes N^{RB}, subcarriers. The time domain of the resource block may correspond to 1 OFDM symbol. The time domain of the resource block may correspond to 14 OFDM symbols. The time domain of the resource block may correspond to one or multiple slots. The time domain of the resource block may correspond to one subframe.

For the terminal apparatus 1, performing transmission and/or reception by using only a subset of resource grids may be indicated. The subset of resource grids is also referred to as a MVP, and the BWP may be given based at least on a part or all of a higher layer parameter and/or DCI. The BWP may also be referred to as a Carrier Bandwidth Part (CBP). For the terminal apparatus 1, performing transmission and/or reception by using all of the sets of resource grids need not be indicated. For the terminal apparatus 1, performing transmission and/or reception by using a part of frequency resources in the resource grid may be indicated. One BWP may include multiple resource blocks in the frequency domain. One BWP may include multiple contiguous resource blocks in the frequency domain. The BWP configured for the downlink carrier may also be referred to as a downlink BWP. The BWP configured for the uplink carrier may also be referred to as an uplink BWP. The BWP may be a subset of bands of a carrier (a subset of frequency domains in a carrier).

One or multiple downlink BWPs may be configured for each of serving cells. One or multiple uplink BWPs may be configured for each of serving cells.

One downlink BWP out of the one or multiple downlink BWPs configured for the serving cell may be configured for an active downlink BWP. Downlink BWP switch is used for deactivating one active downlink BWP, and activating an inactive downlink BWP other than the one active downlink BWP. Switching of the downlink BWP may be controlled by a BWP field that is included in downlink control information. Switching of the downlink BWP may be controlled based on a higher layer parameter.

In the active downlink BWP, a DL-SCH may be received. In the active downlink BWP, a PDCCH may be monitored. In the active downlink BWP, a PDSCH may be received.

In the inactive downlink BWP, the DL-SCH is not received. In the inactive downlink BWP, the PDCCH is not monitored. CSI for the inactive downlink BWP is not reported.

Two or more downlink BWPs out of the one or multiple downlink BWPs configured for the serving cell need not be configured for the active downlink BWP.

One uplink BWP out, of the one or multiple uplink BWPs configured for the serving cell may be configured for the active uplink BWP. Uplink BWP switch is used for deactivating one active uplink BWP, and activating an inactive uplink BWP other than the one active uplink BWP. Switching of the uplink BWP may be controlled by a BWP field that is included in downlink control information. Switching of the uplink BWP may be controlled based on a higher layer parameter.

In the active uplink BWP, a UL-SCH may be transmitted. In the active uplink BWP, a PUCCH may be transmitted. In the active uplink BWP, a PRACH may be transmitted. In the active uplink BWP, an SRS may be transmitted.

In the inactive uplink BWP, the UL-SCH is not transmitted. In the inactive uplink BWP, the PUCCH is not transmitted. In the inactive uplink BWP, the PRACH is not transmitted. In the inactive uplink BWP, the SRS is not transmitted.

Two or more uplink BWPs out of the one or multiple uplink BWPs configured for one serving cell need not be configured for the active uplink BWP. In other words, it is only necessary that at least one active uplink BWP be provided for the serving cell including the uplink BWP.

The higher layer parameter is a parameter included in a higher layer signaling. The higher layer signaling may be a Radio Resource Control (RRC) signaling, or may be a Medium Access Control Control Element (MAC CE). Here, the higher layer signaling may be a signal of an RRC layer, or may be a signal of an MAC layer. Note that the higher layer parameter given by the signal of the RRC layer may be notified and configured from the base station apparatus 3 to the terminal apparatus 1.

The higher layer signaling may be common RRC signaling. The common RRC signaling may at least include a part or all of the following feature C1 to feature C3.

Feature C1) To be mapped to a BCCH logical channel or a CCCH logical channel

Feature C2) A ReconfigurationWithSync information element is at least included Feature C3) To be mapped to a PBCH

The ReconfigurationWithSync information element may include information indicating configuration used in a serving cell in common. The configuration used in a serving cell in common may at least include configuration of the MACK The configuration of the PRACH may at least indicate one or multiple random access preamble indexes. The configuration of the PRACH may at least indicate time/frequency resources of the PRACH.

The common RRC signaling may at least include a common RRC parameter. The common RRC parameter may be a (Cell-specific) parameter that is used in a serving cell in common.

The higher layer signaling may be dedicated RRC signaling. The dedicated RRC signaling may at least include a part or all of the following features D1 to D2.

Feature D1) To be mapped to a DCCH logical channel

Feature D2) The ReconfigurationWithSync information element is not included

For example, a Master Information Block (MIB) and a System Information Block (SIB) may be included in the common RRC signaling. A message of a higher layer that is mapped to the DCCH logical channel and that at least includes the ReconfigurationWithSync information element may be included in the common RRC signaling. A message of a higher layer that is mapped to the DCCH logical channel and that does not include the ReconfigurationWithSync information element may be included in the dedicated RRC signaling. Note that the MIB and the SIB may be collectively referred to as system information.

Note that the higher layer parameter including one or multiple higher layer parameters may be referred to as an information element (IE). The higher layer parameter and/or the IF including one or multiple higher layer parameters and/or one or multiple IEs may be referred to as a message (a message of a higher layer, an RRC message), an information block (IB), or system information.

The SIB may at least indicate a time index of the SSB. The SIB may at least include information related to PRACH resources. The SIB may at least include information related to configuration of initial connection.

The ReconfigurationWithSync information element may at least include information related to PRACH resources. The ReconfigurationWithSync information element may at least include information related to configuration of initial connection.

The dedicated RRC signaling may at least include a dedicated RRC parameter. The dedicated RRC parameter may be a (UE-specific) parameter that is used dedicatedly for the terminal apparatus 1. The dedicated RRC signaling may at least include the common RRC parameter.

The common RRC parameter and the dedicated RRC parameter may also be referred to as a higher layer parameter.

In the following, physical channels and physical signals according to various aspects of the present embodiment will be described.

The uplink physical channel may correspond to a set of resource elements for carrying information that is generated in a higher layer. The uplink physical channel is a physical channel that is used in the uplink carrier. In the radio communication system according to an aspect of the present embodiment, at least a part or all of the following uplink physical channels are used.
Physical Uplink Control CHannel (PUCCH)
Physical Uplink Shared CHannel (PUSCH)
Physical Random Access CHannel (PRACH)

The PUCCH may be used for transmitting uplink control information (UCI). The uplink control information includes a part or all of channel state information (CSI), a scheduling request (SR), Hybrid Automatic Repeat request ACKnowledgement (HARQ-ACK) information corresponding to a transport block (TB). Note that the TB may be referred to as a Medium Access Control Protocol Data Unit (MAC PDU), a Downlink-Shared Channel (DL-SCH), and a Physical Downlink Shared Channel (PDSCH).

One or multiple types of uplink control information may be multiplexed on the PUCCH. The multiplexed PUCCH may be transmitted. In other words, multiple HARQ-ACKs may be multiplexed on the PUCCH, multiple pieces of CSI may be multiplexed on the PUCCH, multiple SRs may be multiplexed on the PUCCH, the HARQ-ACK and the CSI may be multiplexed on the PUCCH, the HARQ-ACK and the SR may be multiplexed on the PUCCH, or the PUCCH may be multiplexed with another type of UCI.

HARQ-ACK information may at least include HARQ-ACK bits corresponding to the TB. The HARQ-ACK bits may indicate an acknowledgement (ACK) or a negative-acknowledgement (NACK) corresponding to the TB. The ACK may be a value indicating that decoding of the TB has successfully completed. The NACK may be a value indicating that decoding of the TB has not successfully completed. The HARQ-ACK information may include at least one HARQ-ACK codebook including one or multiple HARQ-ACK bits. The fact that the HARQ-ACK bits correspond to one or multiple TBs may mean that the HARQ-ACK bits correspond to the PDSCH including the one or multiple TBs.

The HARQ-ACK bits may indicate an ACK or a NACK corresponding to one Code Block Group (CBG) included in the TB. The HARQ-ACK may also be referred to as HARQ feedback, HARQ information, or HARQ control information.

The SR may be at least used for requesting resources of the PUSCH for initial transmission. The SR may be used for requesting UL-SCH resources for new transmission. SR bits may be used for indicating either of a positive SR or a negative SR. The fact that the SR bits indicate the positive SR may also be referred to as “the positive SR is transmitted”, The positive SR may indicate that resources of the PUSCH for initial transmission are requested by the terminal apparatus 1. The positive SR may indicate that the SR is triggered by a higher layer. The positive SR may be transmitted in a case that transmission of the SR is indicated by a higher layer. The fact that the SR bits indicate the negative SR may also be referred to as “the negative SR is transmitted”. The negative SR may indicate that resources of the PUSCH for initial transmission are not requested by the terminal apparatus 1. The negative SR may indicate that the SR is not triggered by a higher layer. The negative SR may be transmitted in a case that transmission of the SR is not indicated by a higher layer.

The SR bits may be used for indicating either of the positive SR or the negative SR for any one of one or multiple SR configurations. Each of the one or multiple SR configurations may correspond to one or multiple logical channels. The positive SR for a certain SR configuration may be a positive SR for any one or all of the one or multiple logical channels corresponding to the certain SR configuration. The negative SR need not correspond to a specific SR configuration. The fact that the negative SR is indicated may mean that the negative SR is indicated for all of the SR configurations.

The SR configuration may be a Scheduling Request ID (SR-ID). The SR-ID may be given by a higher layer parameter.

The CSI may at least include a part or all of a channel quality indicator (CQI), a precoder matrix indicator (PMI), and a rank indicator (RI). The CO is an indicator related to quality of a channel (for example, propagation intensity), and the PMI is an indicator indicating a precoder. The RI is an indicator indicating a transmission rank (or the number of transmission layers).

The CSI may be given based at least on reception of a physical signal (for example, a. CSI-RS) that is at least used for channel measurement. In the CSI, a value selected by the terminal apparatus 1 may be included. The CSI may be selected by the terminal apparatus 1, based at least on reception of a physical signal that is at least used for channel measurement. The channel measurement may include interference measurement. Note that the CSI-RS may be set based on CSI-RS configuration, or may be set based on SSB configuration.

A CSI report is a report of the CSI. The CSI report may include CSI part 1 and/or CSI part 2. The CSI part 1 may at least include a part or all of wideband channel quality information (wideband CQI), a wideband precoder matrix indicator (wideband PMI), and an RI. The number of bits of the CSI part 1 multiplexed on the PUCCH may be a prescribed value regardless of a value of the RI of the CSI report. The number of bits of the CSI part 2 multiplexed on the PUCCH may be given based on the value of the RI of the CSI report. The rank indicator of the CSI report may be a value of a rank indicator that is used for calculation of the CSI report. The RI of CSI information may be a value indicated by an RI field included in the CSI report.

A set of Ills allowed in the CSI report may be a part or all of 1 to 8. The set of RIs allowed in the CSI report may be given based at least on a higher layer parameter RankRestriction. In a case that the set of RIs allowed in the CSI report includes only one value, the RIs of the CSI report may be the one value.

Priority may be configured for the CSI report. The priority of the CSI report may be given based at least on a part or all of configuration related to behaviors (processing) of the CSI report in the time domain, a type of contents of the CSI report, an index of the CSI report, and/or an index of a serving cell in which measurement of the CSI report is configured.

The configuration related to the behaviors (processing) of the CSI report in the time domain may be configuration indicating any one of whether the CSI report is aperiodically performed, whether the CSI report is semi-persistently performed, or semi-statically performed.

The type of the contents of the CSI report may indicate whether or not the CSI report includes RSRP (Reference Signals Received. Power) of layer 1.

The index of the CSI report may be given by a higher layer parameter.

The PUCCH supports one or multiple PUCCH formats (PUCCH format 0 to PUCCH format 4). The PUCCH format may be transmitted on the PUCCH. The fact that the PUCCH format is transmitted may mean that the PUCCH is transmitted.

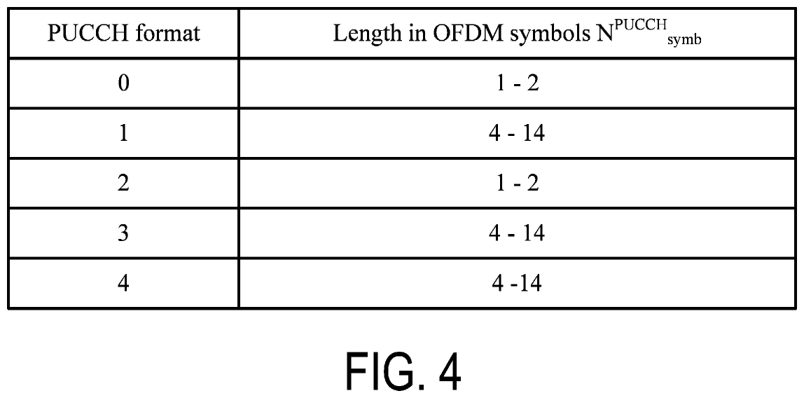

FIG. 4 is a diagram illustrating an example of a relationship between the PUCCH format and length N^{PUCCH}_{symb} of the PUCCH format according to an aspect of the present embodiment. The length N^{PUCCH}_{symb} of PUCCH format 0 is 1 or 2 OFDM symbols. The length N^{PUCCH}_{symb} of PUCCH format 1 is any one of 4 to 14 OFDM symbols. The length N^{PUCCH}_{symb} of PUCCH format 2 is 1 or 2 OFDM symbols. The length N^{PUCCH}_{symb} of PUCCH format 3 is any one of 4 to 14 OFDM symbols. The length N^{PUCCH}_{symb} of PUCCH format 4 is any one of 4 to 14 OFDM symbols.

The PUSCH is at least used for transmitting the TB (the MAC PDU, the UL-SCH). The PUSCH may be used for at least transmitting a part or all of the TB, the HARQ-ACK information, the CSI, and the SR. The PUSCH is at least used for transmitting a random access message 3 (message 3 (Msg3)) corresponding to an RAR (Msg2) and/or an RAR grant in a random access procedure. Note that the TB may correspond to each of the uplink and the downlink. In other words, the PUSCH may be used for transmitting the TB for the uplink. The PDSCH may be used for transmitting the TB for the downlink.

The PRACH is at least used for transmitting a random access preamble (random access message 1, message 1 (Msg1)). The PRACH may be at least used for indicating a part or all of an initial connection establishment procedure, a handover procedure, a connection re-establishment procedure, an initial access procedure, synchronization (timing adjustment) for transmission of the PUSCH, and a request of resources for the PUSCH. The random access preamble may be used for notifying an index (random access preamble index) that is given by a higher layer of the terminal apparatus 1 to the base station apparatus 3.

The random access preamble may be given by performing cyclic shift on a Zadoff-Chu sequence corresponding to a physical route sequence index u. The Zadoff-Chu sequence may be generated based on the physical route sequence index u. In one serving cell, multiple random access preambles may be defined. The random access preamble may be identified based at least on the index of the random access preamble. Different random access preambles corresponding to different indexes of the random access preambles may correspond to different combinations of the physical route sequence index u and the cyclic shift. The physical route sequence index u and the cyclic shift may be given based at least on information included in the system information. The physical route sequence index u may be an index for identifying a sequence included in the random access preamble. The random access preamble may be identified based at least on the physical route sequence index u.

In FIG. 1, in uplink radio communication, the following uplink physical signals are used. The uplink physical signals need not be used for transmitting information output from a higher layer, but are used by a physical layer.
UpLink Demodulation Reference Signal (UL DMRS)
Sounding Reference Signal (SRS)
UpLink Phase Tracking Reference Signal (UL PTRS)

The UL DMRS is related to transmission of the PUSCH and/or the PUCCH. The UL DMRS is multiplexed on the PUSCH or the PUCCH. The base station apparatus 3 may use the UL DMRS for performing channel compensation of the PUSCH or the PUCCH. In the following, concurrent transmission of the PUSCH and the UL DMRS related to the PUSCH is simply referred to as transmission of the PUSCH. In the following, concurrent transmission of the PUCCH and the UL DMRS related to the PUCCH is simply referred to as transmission of the PUCCH. The UL DMRS related to the PUSCH is also referred to as the UL DMRS for the PUSCH. The UL DMRS related to the PUCCH is also referred to as the UL DMRS for the PUCCH.

The SRS need not be related to transmission of the PUSCH or the PUCCH. The base station apparatus 3 may use the SRS for measurement of a channel state. The SRS may be transmitted at the end of a subframe in an uplink slot or in a certain number of OFDM symbols from the end.

The UL PTRS may be a reference signal that is at least used for phase tracking. The UL PTRS may be related to a UL DMRS group at least including an antenna port used for one or multiple UL DMRSs. The fact that the UL PTRS and the UL DMRS group are related to each other may mean that an antenna port of the UL PTRS and a part or all of antenna ports included in the UL DMRS group are at least QCL. The UL DMRS group may be identified based at least on an antenna port having the smallest index in the UL DMRSs included in the UL DMRS group. The UL PTRS may be mapped to an antenna port having the smallest index in one or multiple antenna ports to which one codeword is mapped. The UL PTRS may be mapped to the first layer in a case that one codeword is at least mapped to the first layer and the second layer. The UL PTRS need not be mapped to the second layer. The index of the antenna port to which the UL PTRS is mapped may be given based at least on downlink control information.

In FIG. 1, in downlink radio communication from the base station apparatus 3 to the terminal apparatus 1, the following downlink physical channels are used. The downlink physical channels are used by a physical layer for transmitting information output from a higher layer.
Physical Broadcast Channel (PBCH)
Physical Downlink Control Channel (PDCCH)
Physical Downlink Shared Channel (PDSCH)

The PBCH is at least used for transmitting the MIB and/or a PBCH payload. The PBCH payload may at least include information indicating an index related to transmission timing of the SSB (SSB occasion). The PBCH payload may include information related to an identifier (index) of the SSB. The PBCH may be transmitted based on a prescribed transmission interval. The PBCH may be transmitted at intervals of 80 milliseconds (ms). The PBCH may be transmitted at intervals of 160 ms. The contents of the information included in the PBCH may be updated every 80 ms. A part or all of the pieces of the information included in the PBCH may be updated every 160 ms. The PBCH may include 288 subcarriers. The PBCH may include 2, 3, or 4 OFDM symbols. The MIB may include information related to an identifier (index) of the SSB. The MIB may include information indicating at least a part of a number of the slot, a number of a subframe, and/or a number of a radio frame in which the PBCH is transmitted.

The PDCCH is at least used for transmission of downlink control information (DCI). The PDCCH may be transmitted including at least the DCI. The PDCCH may be transmitted including the DCI. The DCI may also be referred to as a DCI format. The DCI may at least indicate either of a downlink grant or an uplink grant. The DCI format used for scheduling of the PDSCH may also be referred to as a downlink DCI format and/or a downlink grant. The DCI format used for scheduling of the PUSCH may also be referred to as an uplink DCI format and/or an uplink grant. The downlink grant may also be referred to as downlink assignment or downlink allocation. The uplink DCI format at least includes one or both of DCI format 0_0 and DCI format 0_1.

DCI format 0_0 may at least include a part or all of 1A to 1J.

1A) DCI format identification field (Identifier for DCI formats field)

1B) Frequency domain resource allocation field (Frequency domain resource assignment field)

1C) Time domain resource allocation field (Time domain resource assignment field)

1D) Frequency hopping flag field

1E) Modulation and Coding Scheme field (MCS field)

1F) First CSI request field (First CSI request field)

1G) New Data Indicator field (NDI field)

1H) Redundancy Version field (RV field)

1I) HARQ process ID field, HARQ process number field (HPID field)

1J) Transmission Power Control (TPC) command for PUSCH field (TPC command for scheduled PUSCH field)

1A may be at least used for indicating which one of one or multiple DCI formats the DCI format including 1A corresponds to. The one or multiple DCI formats may be given based at least on a part or all of DCI format 1_0, DCI format 1_1, DCI format 0_0, and/or DCI format 0_1.

1B may be at least used for indicating allocation of the frequency resource for the PUSCH that is scheduled by the DCI format including 1B.

1C may be at least used for indicating allocation of the time resource for the PUSCH that is scheduled by the DCI format including 1C.

1D may be at least used for indicating whether or not frequency hopping is applied to the PUSCH that is scheduled by the DCI format including 1D.

1E may be at least used for indicating a part or all of a modulation scheme for the PUSCH that is scheduled by the DCI format including 1E and/or a target coding rate. The target coding rate may be a target coding rate for the TB of the PUSCH. The size of the TB (TBS) may be given based at least on the target coding rate.

1F is at least used for indicating the report of the CSI. The size of 1F may be a prescribed value. The size of 1F may be 0, may be 1, may be 2, or may be 3. The size of 1F may be determined according to the number of CSI configurations configured for the terminal apparatus 1.

1G is used for indicating whether transmission of the PUSCH corresponding to 1I that is scheduled by the DCI format is new transmission or retransmission, based on whether a value of 1G is toggled. In a case that the value of 1G is toggled, the PUSCH corresponding to 1I is new transmission, otherwise the PUSCH corresponding to 1I is retransmission. 1G may be DCI indicating whether the base station apparatus 3 requests retransmission of the PUSCH corresponding to 1I.

1 H is used for indicating a start position of a bit sequence of the PUSCH that is scheduled by the DCI format.

1I is used for indicating a number of a HARQ process (HPID) to which the PUSCH that is scheduled by the DCI format corresponds.

1J is used for adjusting transmission power of the PUSCH that is scheduled by the DCI format.

DCI format 0_1 at least includes a part or all of 2A to 2K.

2A) DCI format identification field

2B) Frequency domain resource allocation field

2C) Time domain resource allocation field

2D) Frequency hopping flag field

2E) MCS field

2F) Second CSI request field

2G) BWP field

2H) NDI field

2I) RV field

2J) HPID field

2K) TPC command for PUSCH field

The BWP field may be used for indicating an uplink BWP to which the PUSCH that is scheduled by DCI format 0_1 is mapped.

The second CSI request field is at least used for indicating the report of the CSI. The size of the second CSI request field may be given based at least on a higher layer parameter ReportTriggerSize.

The fields having the same terms as those of 1A to 1J described above include the same details, and thus description thereof will be omitted.

The downlink DCI format at least includes one or both of DCI format 1_0 and DCI format 1_1.

DCI format 1_0 may at least include a part or all of 3A to 3L.

3A) DCI format identification field (Identifier for DCI formats field)

3B) Frequency domain resource allocation field (Frequency domain resource assignment field)

3C) Time domain resource allocation field (Time domain resource assignment field)

3D) Frequency hopping flag field

3E) Modulation and Coding Scheme field (MCS field)

3F) First CSI request field (First CSI request field)

3G) Timing indication from PDSCH to HARQ feedback field (PDSCH to HARQ feedback timing indicator field)

3H) PUCCH resource indication field (PUCCH resource indicator field)

3I) NDI field

3J) RV field

3K) HPID field

3L) TPC command for PUCCH field (TPC command for scheduled PUCCH field)

3B to 3E may be used for the PDSCH that is scheduled by the DCI format.

3G may be a field indicating timing K1. In a case that the index of the slot including the last OFDM symbol of the PDSCH is a slot n, the index of the slot including the PUCCH or the PUSCH at least including the HARQ-ACK corresponding to the TB included in the PDSCH may be n+K1. In a case that the index of the slot including the last OFDM symbol of the PDSCH is the slot n, the index of the slot including the first OFDM symbol of the PUCCH or the first OFDM symbol of the PUSCH at least including the HARQ-ACK corresponding to the TB included in the PDSCH may be n+K1.

3H may be a field indicating an index of one or multiple PUCCH resources included in a PUCCH resource set.

3I is used for indicating whether transmission of the PDSCH corresponding to 3K that is scheduled by the DCI format is new transmission or retransmission, based on whether a value of 3I is toggled. In a case that a value of 3K is toggled, the PDSCH corresponding to 3K is new transmission, otherwise the PDSCH corresponding to 3K is retransmission.

3J may be used for indicating a start position of a bit sequence of the PDSCH that is scheduled by the DCI format.

3K may be used for indicating a number of a HARQ process to which the PDSCH that is scheduled by the DCI format corresponds.

3L may be used for adjusting transmission power of the PUCCH corresponding to the PDSCH that is scheduled by the DCI format.

DCI format 1_1 may at least include a part or all of 4A to 4N.

4A) DCI format identification field

4B) Frequency domain resource allocation field

4C) Time domain resource allocation field

4D) Frequency hopping flag field

4E) MCS field

4F) First CSI request field

4G) Timing indication from PDSCH to HARQ feedback field

4H) PUCCH resource indication field

4J) BWP field

4K) NDI field

4L) RV field

4M) HPID field

4N) TPC command for PUCCH field

3A and 4A are used for identifying the DCI format, similarly to 1A and 2A.

4B to 4E may be used for the PDSCH that is scheduled by the DCI format.

4J may be used for indicating a downlink BWP to which the PDSCH that is scheduled by DCI format 1_1 is mapped.

The fields having the same terms as those of 3A to 3L described above include the same details, and thus description thereof will be omitted.

Each DCI format may include padding bits so as to match a prescribed bit size (payload size).

DCI format 2 may include a parameter that is used for transmission power control of the PUSCH or the PUCCH.

In various aspects of the present embodiment, unless otherwise specifically noted, the number of resource blocks (RBs) indicates the number of resource blocks in the frequency domain. The indexes of the resource blocks are assigned in ascending order from the resource block mapped to a low frequency domain to the resource block mapped to a high frequency domain. The resource block is a general term for a common resource block and a physical resource block.

One physical channel may be mapped to one serving cell. One physical channel may be mapped to one CBP that is configured for one carrier included in one serving cell.

The terminal apparatus 1 is given one or multiple control resource sets (CORESETs). The terminal apparatus 1 monitors the PDCCH in the one or multiple CORESETs.

The CORESET may indicate the time frequency domain to which one or multiple PDCCHs may be mapped. The CORESET may be a domain in which the terminal apparatus 1 monitors the PDCCH. The CORESET may include contiguous resources (Localized resources). The CORESET may include non-contiguous resources (distributed resources).

In the frequency domain, a unit of mapping of the CORESET may be a resource block (RB). For example, in the frequency domain, a unit of mapping of the CORESET may be 6 resource blocks. In other words, mapping of the CORESET in the frequency domain may be performed in 6 RBs×n (n is 1, 2, . . . ). In the time domain, a unit of mapping of the CORESET may be an OFDM symbol. For example, in the time domain, the unit of mapping of the CORESET may be one OFDM symbol.

The frequency domain of the CORESET may be given based at least on a higher layer signaling and/or DCI.

The time domain of the CORESET may be given based at least on a higher layer signaling and/or DCI.

A certain CORESET may be a Common CORESET. The common CORESET may be a CORESET that is configured for multiple terminal apparatuses 1 in common. The common CORESET may be given based at least on a part or all of an MIB, an SIB, common RRC signaling, and a cell ID. For example, the time resource and/or the frequency resource of the CORESET in which monitoring of the PDCCH used for scheduling of the SIB is configured may be given based at least on the MIB.

A certain CORESET may be a Dedicated CORESET. The dedicated CORESET may be a CORESET that is configured to be used dedicatedly for the terminal apparatus 1. The dedicated CORESET may be given based at least on dedicated RRC signaling.

A set of candidates of the PDCCH monitored by the terminal apparatus 1 may be defined from the perspective of a search space. In other words, the set of PDCCH candidates monitored by the terminal apparatus 1 may be given by a search space.

The search space may include one or multiple PDCCH candidates of one or multiple Aggregation levels. The aggregation level of the PDCCH candidates may indicate the number of CCEs constituting the PDCCH.

The terminal apparatus 1 may monitor at least one or multiple search spaces in the slot in which DRX (Discontinuous reception) is not configured. DRX may be given based at least on a higher layer parameter. The terminal apparatus 1 may monitor at least one or multiple Search space sets in the slot in which DRX is not configured.

The search space set may at least include one or multiple search spaces. A type of the search space set may be any one of a type 0 PDCCH common search space, a type 0a PDCCH common search space, a type 1 PDCCH common search space, a type 2 PDCCH common search space, a type 3 PDCCH common search space, and/or a UE-specific PDCCH search space.

The type 0 PDCCH common search space, the type 0a PDCCH common search space, the type 1 PDCCH common search space, the type 2 PDCCH common search space, and the type 3 PDCCH common search space may also be referred to as a Common Search Space (CSS). The UE-specific PDCCH search space may also be referred to as a UE specific Search Space (USS).

Each of the search space sets may be related to one control resource set. Each of the search space sets may be at least included in one control resource set. For each of the search space sets, the index of the control resource set related to the search space set may be given.

The type 0 PDCCH common search space may be at least used for a DCI format that carries a Cyclic Redundancy Check (CRC) sequence scrambled with a System Information-Radio Network Temporary Identifier (SI-RNTI). Configuration of the type 0 PDCCH common search space may be given based at least on 4 bits of Least Significant Bits (LSB) of a higher layer parameter PDCCH-ConfigSIB1. The higher layer parameter PDCCH-ConfigSIB1 may be included in the MIB. The configuration of the type 0 PDCCH common search space may be given based at least on a higher layer parameter SearchSpaceZero. Interpretation of the bits of the higher layer parameter SearchSpaceZero may be similar to interpretation of the 4 bits of the LSB of the higher layer parameter PDCCH-ConfigSIB1. The configuration of the type 0 PDCCH common search space may be given based at least on a higher layer parameter SearchSpaceSIB1. The higher layer parameter SearchSpaceSIB1 may be included in a higher layer parameter PDCCH-ConfigCommon. The PDCCH detected in the type 0 PDCCH common search space may be at least used for scheduling of the PDSCH that is transmitted including the SIB1. The SIB1 is a type of SIB. The SIB1 may include scheduling information of the SIB other than the SIB1. The terminal apparatus 1 may receive the higher layer parameter PDCCH-ConfigCommon in EUTRA. The terminal apparatus 1 may receive the higher layer parameter PDCCH-ConfigCommon in the MCG.

The type 0a PDCCH common search space may be at least used for a DCI format that carries a Cyclic Redundancy Check (CRC) sequence scrambled with a System Information-Radio Network Temporary Identifier (SI-RNTI). Configuration of the type 0a PDCCH common search space may be given based at least on a higher layer parameter SearchSpaceOtherSystemInformation. The higher layer parameter SearchSpaceOtherSystemInformation may be included in the SIB1. The higher layer parameter SearchSpaceOtherSystemInformation may be included in the higher layer parameter PDCCH-ConfigCommon. The PDCCH detected in the type 0 PDCCH common search space may be at least used for scheduling of the PDSCH that is transmitted including the SIB other than the SIB1.

The type 1 PDCCH common search space may be at least used for a DCI format that carries a CRC sequence scrambled with a Random Access-Radio Network Temporary Identifier (RA-RNTI) and/or a CRC sequence scrambled with a Temporary Common-Radio Network Temporary Identifier (TC-RNTI). The RA-RNTI may be given based at least on time/frequency resources of the random access preamble that is transmitted by the terminal apparatus 1. The TC-RNTI may be given by the PDSCH (also referred to as a random access message 2, message 2 (Msg2), or a random access response (RAR)) that is scheduled by the DCI format carrying the CRC sequence scrambled with the RA-RNTI. The type I PDCCH common search space may be given based at least on a higher layer parameter ra-SearchSpace. The higher layer parameter ra-SearchSpace may be included in the SIB1. The higher layer parameter ra-SearchSpace may be included in the higher layer parameter PDCCH-ConfigCommon.

The type 2 PDCCH common search space may be used for a DCI format that carries a CRC sequence scrambled with a Paging—Radio Network Temporary Identifier (P-RNTI). The P-RNTI may be at least used for transmission of the DCI format including information for notifying of a change of the SIB. The type 2 PDCCH common search space may be given based at least on a higher layer parameter PagingSearchSpace. The higher layer parameter PagingSearchSpace may be included in the SIB1. The higher layer parameter PagingSearchSpace may be included in the higher layer parameter PDCCH-ConfigCommon.

The type 3 PDCCH common search space may be used for a DCI format that carries a CRC sequence scrambled with a Cell-Radio Network Temporary Identifier (C-RNTI). The C-RNTI may be given based at least on the PDSCH (which may also be referred to as a random access message 4, message 4 (Msg4), or contention resolution) that is scheduled by the DCI format carrying the CRC sequence scrambled with the TC-RNTI. The type 3 PDCCH common search space may be a search space set given in a case that a higher layer parameter SearchSpaceType is set to ‘common’.

The UE-specific PDCCH search space may be at least used for a DCI format that carries a CRC sequence scrambled with a C-RNTI.

In a case that the C-RNTI is given to the terminal apparatus 1, the type 0 PDCCH common search space, the type 0a PDCCH common search space, the type 1 PDCCH common search space, and/or the type 2 PDCCH common search space may be at least used for the DCI format carrying the CRC sequence scrambled with the C-RNTI.

In a case that the C-RNTI is given to the terminal apparatus 1, the search space set given based at least on any one of the higher layer parameter PDCCH-ConfigSIB1, the higher layer parameter SearchSpaceZero, the higher layer parameter SearchSpaceSIB1, the higher layer parameter SearchSpaceOtherSystemInformation, the higher layer parameter ra-SearchSpace, and the higher layer parameter PagingSearchSpace may be at least used for the DCI format carrying the CRC sequence scrambled with the C-RNTI.

The common CORESET may at least include one or both of the CSS and the USS. The dedicated CORESET may at least include one or both of the CSS and the USS.

The physical resources of the search space include configuration units (Control Channel Elements (CCEs)) of a control channel. The CCE includes six Resource Element Groups (REGs). The REG may include one OFDM symbol of one Physical Resource Block (PRB). In other words, the REG may include 12 Resource Elements (REs). The PRB may also be simply referred to as a resource block (RB).

The PDSCH is at least used for transmitting the TB. The PDSCH may be at least used for transmitting the random access message 2 (RAR, Msg2). The PDSCH may be at least used for transmitting system information including a parameter used for initial access.

In FIG. 1, in downlink radio communication, the following downlink physical signals are used. The downlink physical signals need not be used for transmitting information output from a higher layer, but are used by a physical layer.
Synchronization signal
DownLink DeModulation Reference Signal (DL DMRS)
Channel State Information-Reference Signal (CSI-RS)
DownLink Phase Tracking Reference Signal (DL PTRS)
Tracking Reference Signal (TRS)

The synchronization signal is used by the terminal apparatus 1 to establish synchronization with a downlink frequency domain and/or time domain. Note that the synchronization signal includes a Primary Synchronization Signal (PSS) and a Secondary Synchronization Signal (SSS).

The SSB (SS/PBCH block) at least includes a part or all of the PSS, the SSS, and the PBCH. The antenna port of each of a part or all of the PSS, the SSS, and the PBCH included in the SS block may be the same. A part or all of the PSS, the SSS, and the PBCH included in the SSB may be mapped to OFDM symbols. The CP configuration of each of a part or all of the PSS, the SSS, and the PBCH included in the SSB may be the same. The same value may be applied to the SCS configuration μ for each of a part or all of the PSS, the SSS, and the PBCH included in the SSB.

The DL DMRS is related to transmission of the PBCH, the PDCCH, and/or the PDSCH. The DL DMRS is multiplexed on the PBCH, the PDCCH, and/or the PDSCH. In order to channel compensation of the PBCH, the PDCCH, or the PDSCH, the terminal apparatus 1 may use the DL DMRS corresponding to the PBCH, the PDCCH, or the PDSCH. In the following, concurrent transmission of the PBCH and the DL DMRS related to the PBCH may be referred to as transmission of the PBCH. Concurrent transmission of the PDCCH and the DL DMRS related to the PDCCH may be simply referred to as transmission of the PDCCH. Concurrent transmission of the PDSCH and the DL DMRS related to the PDSCH may be simply referred to as transmission of the PDSCH. The DL DMRS related to the PBCH may also be referred to as a DL DMRS for the PBCH. The DL DMRS related to the PDSCH may also be referred to as a DL DMRS for the PDSCH. The DL DMRS related to the PDCCH may also be referred to as a DL DMRS related to the PDCCH.

The DL DMRS may be a reference signal that is configured individually for the terminal apparatus 1. The sequence of the DL DMRS may be given based at least on a parameter that is configured individually for the terminal apparatus 1. The sequence of the DL DMRS may be given based at least on a UE-specific value (for example, the C-RNTI or the like). The DL DMRS may be transmitted individually for the PDCCH and/or the PDSCH.

The CSI-RS may be a signal that is at least used for calculation of the CSI. The CSI-RS may be used for measuring Reference Signal Received Power (RSRP) and Reference Signal Received Quality (RSRQ). The pattern of the CSI-RS assumed by the terminal apparatus 1 may be given at least by a higher layer parameter.

The PTRS may be a signal that is at least used for compensation of phase noise. The pattern of the PTRS assumed by the terminal apparatus 1 may be given based at least on a higher layer parameter and/or DCI.

The DL PTRS may be related to the DL DMRS group at least including an antenna port used for one or multiple DL DMRSs. The fact that the DL PTRS and the DL DMRS group are related to each other may mean that an antenna port of the DL PTRS and a part or all of antenna ports included in the DL DMRS group are at least QCL. The DL DMRS group may be identified based at least on an antenna port having the smallest index in the DL DMRSs included in the DL DMRS group.

The TRS may be a signal that is at least used for synchronization of time and/or frequency. The pattern of the TRS assumed by the terminal apparatus may be given based at least on a higher layer parameter and/or DCI.

The downlink physical channel and the downlink physical signal may also be referred to as a downlink signal. The uplink physical channel and the uplink physical signal may also be referred to as an uplink signal. The downlink signal and the uplink signal may also be collectively referred to as a physical signal or a signal. The downlink physical channel and the uplink physical channel may be collectively referred to as a physical channel. In the downlink, the physical signal may include a part or all of the SSB, the PDCCH (CORESET), the PDSCH, the DL DMRS, the CSI-RS, the DL PTRS, and the TRS. In the uplink, the physical signal may include a part or all of the PRACH, the PUCCH, the PUSCH, the UL DMRS, the UL PTRS, and the SRS. The physical signal may be a signal other than the signals described above. In other words, the physical signal may include one or multiple types of physical channels and/or physical signals, or may include one or multiple physical channels and/or physical signals.

A Broadcast CHannel (BCH), an Uplink-Shared CHannel (UL-SCH), and a Downlink-Shared CHannel (DL-SCH) are transport channels. A channel used in a medium access control (MAC) layer may be referred to as a transport channel. A unit of the transport channel used in the MAC layer may also be referred to as a TB or an MAC PDU. Control of the HARQ is performed for each TB in the MAC layer. The TB is a unit of data that the MAC layer delivers to a physical layer. In the physical layer, the TBs are mapped to codewords, and modulation processing is performed for each codeword.

The base station apparatus 3 and the terminal apparatus 1 exchange (transmit and/or receive) a higher layer signaling in a higher layer. For example, the base station apparatus 3 and the terminal apparatus 1 may transmit and/or receive RRC signaling (RRC message, RRC information, RRC parameter, RRC information element) in a radio resource control (RRC) layer. The base station apparatus 3 and the terminal apparatus 1 may transmit and/or receive a MAC Control Element (CE) in the MAC layer. Here, the RRC signaling and/or the MAC CE is also referred to as a higher layer signaling.

The PUSCH and the PDSCH may be at least used for transmitting the RRC signaling and/or the MAC CE. Here, the RRC signaling transmitted on the PDSCH from the base station apparatus 3 may be signaling that is common to multiple terminal apparatuses 1 in a serving cell. The signaling common to multiple terminal apparatuses 1 in a serving cell may also be referred to as common RRC signaling. The RRC signaling transmitted on the PDSCH from the base station apparatus 3 may be signaling (which may also be referred to as dedicated signaling or UE specific signaling) that is dedicated to a certain terminal apparatus 1. The signaling dedicated to the terminal apparatus 1 may also be referred to as dedicated RRC signaling. A higher layer parameter specific to a serving cell may be transmitted by using the signaling common to multiple terminal apparatuses 1 in a serving cell or the signaling dedicated to a certain terminal apparatus 1. The UE-specific higher layer parameter may be transmitted by using the signaling dedicated to a certain terminal apparatus 1.

A Broadcast Control CHannel (BCCH), a Common Control CHannel (CCCH), and a Dedicated Control CHannel (DCCH) are logical channels. For example, the BCCH is a channel of a higher layer that is used for transmitting the MIB. The Common Control CHannel (CCCH) is a channel of a higher layer that is used for transmitting common information in multiple terminal apparatuses 1. Here, the CCCH may be, for example, used for the terminal apparatus 1 that is not in a state of RRC connection. The Dedicated Control CHannel (DCCH) is a channel of a higher layer that is at least used for transmitting control information (dedicated control information) that is dedicated to the terminal apparatus 1. Here, the DCCH may be, for example, used for the terminal apparatus 1 that is in a state of RRC connection.

The BCCH in the logical channel may be mapped to the BCH, the DL-SCH, or the UL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to the PUSCH in the physical channel. The DL-SCH in the transport channel may be mapped to the PDSCH in the physical channel. The BCH in the transport channel may be mapped to the PBCH in the physical channel.

In the following, a configuration example of the terminal apparatus 1 according to an aspect of the present embodiment will be described.

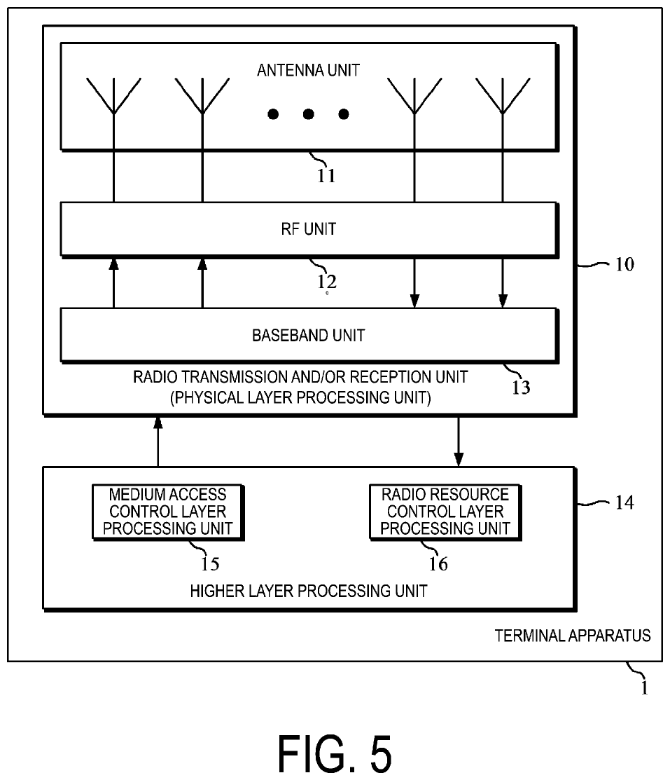

FIG. 5 is a schematic block diagram illustrating a configuration of the terminal apparatus 1 according to an aspect of the present embodiment. As illustrated in the figure, the terminal apparatus 1 includes a radio transmission and/or reception unit 10 and a higher layer processing unit 14. The radio transmission and/or reception unit 10 at least includes a part or all of an antenna unit 11, a Radio Frequency (RF) unit 12, and a baseband unit 13. The higher layer processing unit 14 at least includes a part or all of a medium access control layer processing unit 15 and a radio resource control layer processing unit 16. The radio transmission and/or reception unit 10 may also be referred to as a transmitter, a receiver, a physical layer processing unit, and/or a lower layer processing unit.

The higher layer processing unit 14 outputs uplink data (TB, UL-SCH) generated through operation of a user or the like to the radio transmission and/or reception unit 10. The higher layer processing unit 14 performs processing of a MAC layer, a packet data convergence protocol (PDCP) layer, a radio link control (RLC) layer, and an RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 performs management of various pieces of configuration information/parameters of its apparatus. The radio resource control layer processing unit 16 sets various pieces of configuration information/parameters, based on a higher layer signaling received from the base station apparatus 3. Specifically, the radio resource control layer processing unit 16 sets various pieces of configuration information/parameters, based on information indicating the various pieces of configuration information/parameters received from the base station apparatus 3. The parameters may be higher layer parameters and/or information elements.

The radio transmission and/or reception unit 10 performs processing of the physical layer, such as modulation, demodulation, coding, and decoding. The radio transmission and/or reception unit 10 separates, demodulates, and decodes a received physical signal, and outputs the decoded information to the higher layer processing unit 14. Such processing may be referred to as reception processing. The radio transmission and/or reception unit 10 performs modulation, coding, and baseband signal generation of data (conversion into a time continuous signal) to generate a physical signal (uplink signal), and transmits the physical signal to the base station apparatus 3. Such processing may be referred to as transmission processing.

The RF unit 12 converts a signal received through the antenna unit 11 into a baseband signal by means of orthogonal demodulation (down conversion), and removes an unnecessary frequency component. The RF unit 12 outputs a processed analog signal to the baseband unit.

The baseband unit 13 converts the analog signal input from the RF unit 12 into a digital signal. The baseband unit 13 removes a part corresponding to a CP from the converted digital signal, performs fast Fourier transform (FFT) on the signal from which the CP has been removed, and extracts a signal of the frequency domain.

The baseband unit 13 performs inverse fast Fourier transform (IFFT) on data to generate an OFDM symbol, adds a CP to the generated OFDM symbol, generates a baseband digital signal, and converts the baseband digital signal into an analog signal. The baseband unit 13 outputs the converted analog signal to the RF unit 12.

The RF unit 12 removes an unnecessary frequency component from the analog signal input from the baseband unit 13 by using a low-pass filter, up-converts the analog signal into a signal of a carrier frequency, and transmits the up-converted signal through the antenna unit 11. The RF unit 12 amplifies power. The RF unit 12 may have a function of controlling transmission power. The RF unit 12 is also referred to as a transmission power control unit.

In the following, a configuration example of the base station apparatus 3 according to an aspect of the present embodiment will be described.

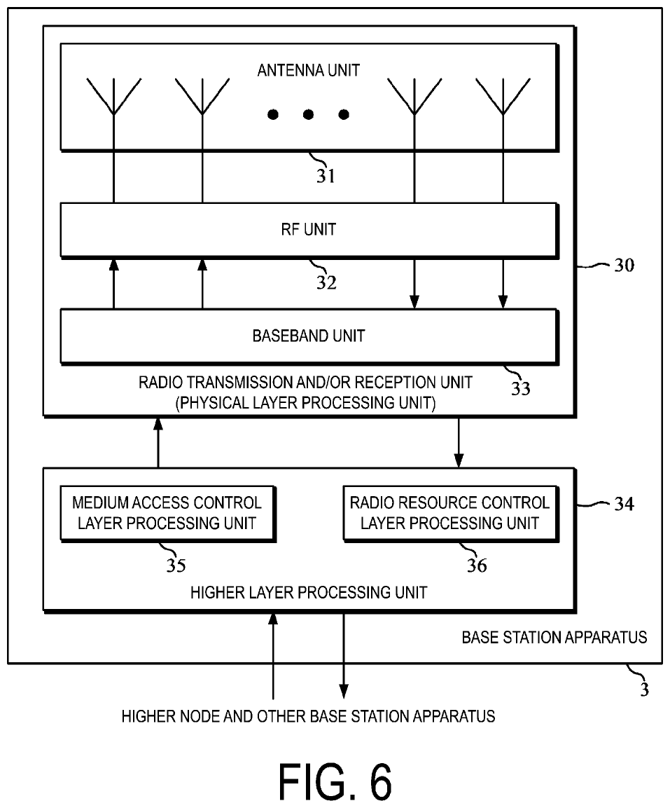

FIG. 6 is a schematic block diagram illustrating a configuration of the base station apparatus 3 according to an aspect of the present embodiment. As illustrated in the figure, the base station apparatus 3 includes a radio transmission and/or reception unit 30 and a higher layer processing unit 34. The radio transmission and/or reception unit 30 includes an antenna unit 31, an RF unit 32, and a baseband unit 33. The higher layer processing unit 34 includes a medium access control layer processing unit 35 and a radio resource control layer processing unit 36. The radio transmission and/or reception unit 30 is also referred to as a transmitter, a receiver, or a physical layer processing unit.

The higher layer processing unit 34 performs processing of an MAC layer, a PDCP layer, an RLC layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 generates, or acquires from a higher node, downlink data (TB, DL-SCH), system information, an RRC message, a MAC CE, and the like to be mapped to the PDSCH, and outputs them to the radio transmission and/or reception unit 30. The radio resource control layer processing unit 36 performs management of various pieces of configuration information/parameters of each of the terminal apparatuses 1. The radio resource control layer processing unit 36 may set various pieces of configuration information/parameters for each of the terminal apparatuses 1 through a higher layer signaling. Specifically, the radio resource control layer processing unit 36 transmits or broadcasts information indicating the various pieces of configuration information/parameters.

The basic function of the radio transmission and/or reception unit 30 is similar to that of the radio transmission and/or reception unit 10, and thus description thereof will be omitted. A physical signal generated in the radio transmission and/or reception unit 30 is transmitted to the terminal apparatus 1 (in other words, transmission processing is performed). The radio transmission and/or reception unit 30 performs reception processing of the received physical signal.

The medium access control layer processing unit 15 and/or 35 may be referred to as a MAC entity.

Each of the units denoted by the reference sign 10 to the reference sign 16 included in the terminal apparatus 1 may be configured as a circuit. Each of the units denoted by the reference sign 30 to the reference sign 36 included in the base station apparatus 3 may be configured as a circuit. A part or all of the units denoted by the reference sign 10 to the reference sign 16 included in the terminal apparatus 1 may be configured as a memory and a processor connected to the memory. A part or all of the units denoted by the reference sign 30 to the reference sign 36 included in the base station apparatus 3 may be configured as a memory and a processor connected to the memory. Various aspects (operation, processing) according to the present embodiment may be implemented (performed) in the memory and the processor connected to the memory included in the terminal apparatus 1 and/or the base station apparatus 3.

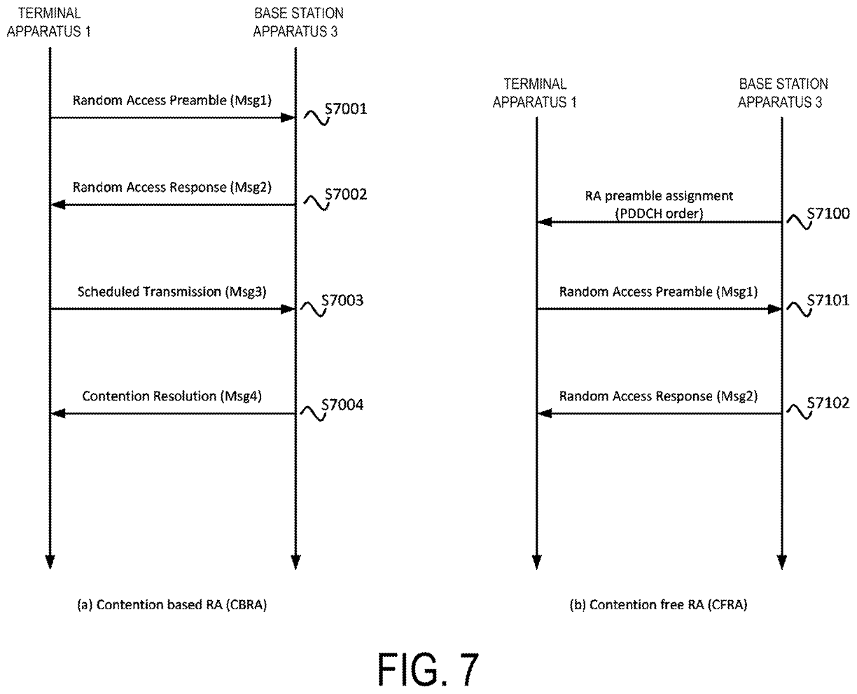

FIG. 7 is a diagram illustrating an example of a random access procedure according to an aspect of the present embodiment. FIG. 7(a) is an example of RA based on contention (Contention based Random Access (CBRA)). FIG. 7(b) is an example of Contention free RA (CFRA, non-contention based RA (NCBRA)).

The random access procedure is performed for initial access from RRC idle, RRC connection (re-)establishment, recovery of a beam failure, handover, downlink data arrival, uplink data arrival, positioning, and/or Timing Advance or Timing Alignment (TA). CBRA may be performed for all of the cases, whereas CFRA is performed for handover, downlink data arrival, positioning, and/or TA.

CBRA is voluntarily (independently) performed by the terminal apparatus 1, and thus a contention may occur due to multiple terminal apparatuses 1 simultaneously performing the random access procedure (in other words, starting the random access procedure at the same timing). In contrast, in CFRA, the base station apparatus 3 performs indication for the connected terminal apparatus 1, and can thereby cause the connected terminal apparatus 1 to perform the random access procedure so that a contention does not occur between multiple terminal apparatuses 1.

The CBRA procedure of FIG. 7(a) will be described.

S7001 is a step in which the terminal apparatus 1 requests a response for initial access from a target cell through the PRACH. In S7001, a message transmitted by the terminal apparatus 1 through the PRACH may be referred to as Msg1. Msg1 may be a random access preamble that is configured by a higher layer parameter.

Before performing the processing of S7001, the terminal apparatus 1 may receive the SSB to perform time frequency synchronization, frame synchronization, and/or acquisition of system information (acquisition/configuration of one or multiple higher layer parameters related to the cell).

S7002 is a step in which the base station apparatus 3 performs a response for the Msg1 to the terminal apparatus 1. A message used for the response may be referred to as Msg2. The Msg2 may be transmitted through the PDSCH. The PDSCH including the Msg2 may be scheduled by the PDCCH mapped to a type 1 PDCCH CSS. In other words, after transmitting the Msg1, the terminal apparatus 1 may monitor the PDCCH used for scheduling of the PDSCH including the Msg2. Cyclic Redundancy Check (CRC) bits included in the PDCCH may be scrambled with a Random Access—Radio Network Temporary Identifier (Identity) (RA-RNTI). In the Msg2, an uplink grant (RAR grant) used for scheduling of the PUSCH including Msg3 may be included. In the RAR grant, a Temporary Cell—RNTI (TC-RNTI) may be at least included. In the RAR grant, a TPC command indicating a correction value for a power control adjustment value used for transmission power of the PUSCH including the Msg3 may be included.

S7003 is a step in which the terminal apparatus 1 transmits at least a request of RRC connection or RRC connection re-establishment and a C-RNTI of the terminal apparatus 1 to the target cell (the base station apparatus 3 as a target). For example, a message transmitted by the terminal apparatus 1 may be referred to as Msg3. The Msg3 may include an ID (Identifier, Identity) for identifying the terminal apparatus 1. The ID may be an ID managed by a higher layer. The ID may be a SAE Temporary Mobile Subscriber Identity (S-TMSI). The ID may be mapped to the CCCH of a logical channel.

S7004 is a step in which the base station apparatus 3 transmits a contention resolution message (Msg4) to the terminal apparatus 1. After transmitting the Msg3, the terminal apparatus 1 may monitor the PDCCH used for scheduling of the PDSCH including the Msg4. In the Msg4, a contention resolution ID (UE contention resolution ID) may be included. The contention resolution ID may be used for resolution of the contention, in which multiple terminal apparatuses 1 transmit a signal by using the same radio resources.

In S7004, in a case that the contention resolution ID included in the Msg4 received by the terminal apparatus 1 is the same value as the ID for identifying the terminal apparatus 1, the terminal apparatus 1 may consider that the contention resolution has successfully completed, and set a value of the TC-RNTI to the C-RNTI field. The terminal apparatus 1 in which the value of the TC-RNTI has been set to the C-RNTI field may consider that RRC connection has completed. Note that, in order to notify the completion of the RRC connection to the base station apparatus 3, the terminal apparatus 1 that has completed the RRC connection may set (map) an Ack (Msg5) to the PUCCH (PUCCH resource) indicated by the PUCCH resource indication field included in the PDCCH used for scheduling the Msg4 and transmit the Ack. The Ack may correspond to a HARQ process ID (HPID, HARQ process number) included in the PDCCH used for scheduling the Msg4.

Note that the CORESET for monitoring the PDCCH used for scheduling of the Msg4 may be either the same as or different from the CORESET for monitoring the PDCCH that is used for scheduling of the Msg2, or may be individually configured.

In a case that carrier aggregation or Dual Connectivity (DC) is configured, S7001, S7002, and S7003 may be performed in the SpCell, and S7004 may be performed in a cell (the SpCell or the SCell) that is indicated by cross carrier scheduling.

The CFRA procedure of FIG. 7(b) will be described.

S7100 is a step in which a request is made from the base station apparatus 3 to the terminal apparatus 1 so that a random access preamble (Msg1) is transmitted for the sake of handover or the like. S7100 is a random access procedure performed in a state in which the base station apparatus 3 and the terminal apparatus 1 establish RRC connection. The base station apparatus 3 may perform allocation (resource allocation) of the random access preamble (Msg1) through dedicated signaling. The PDCCH for the dedicated signaling as described above may be referred to as a PDCCH order. The Msg1 may be allocated by using a set different from the Msg1 used in CBRA. In S7100, the terminal apparatus 1 monitors the PDCCH (PDCCH order) for performing resource allocation of the Msg1. Note that the PDCCH order may be a DCI format in which the CRC of DCI format 1_0 is scrambled with a C-RNTI and all of the values of 3B above are “1”.

In DCI format 1_0 used for the random access procedure started with the PDCCH order, at least one or all of the following 5A to 5E may be included as field(s).

5A) Random access preamble index field

5B) UL/SUL indicator field

5C) SS/PBCH index field

5D) PRACH mask index field

5E) Reserved bit (R bit) field

5A above corresponds to a higher layer parameter ra-PreambleIndex. In a case that none of the values of 5A above is 0, 5B above is used for indicating a carrier on which the PRACH is transmitted, otherwise the field is reserved. In a case that none of the values of 5A above is 0, 5C above indicates an index of the SSB used for determination of transmission timing (PRACH occasion) of the PRACH, otherwise the field is reserved. In a case that none of the values of 5A above is 0, 5D above is used for indicating transmission timing of the RACH related to the SSB corresponding to 5C above, otherwise the field is reserved. Here, 0 may be a zero padding bit.

S7101 is a step in which the terminal apparatus 1 in a case of having received the PDCCH including resource allocation of the Msg1 transmits the allocated Msg1. After transmitting the Msg1, the terminal apparatus 1 may monitor the PDCCH (PDCCH search space) used for scheduling of the PDSCH including the Msg2.

S7102 is a step in which the base station apparatus 3 performs a response for the Msg1 to the terminal apparatus 1. The basic processing is the same as S7002, and thus description thereof will be omitted.

In a case that CFRA is performed in the SpCell, S7100, S7101, and S7102 may occur in the SpCell.

A higher layer parameter for the random access procedure may be configured.

For the random access procedure, the following 6A to 6I may be used in the MAC entity of the terminal apparatus 1 as variables of the terminal apparatus 1.

6A) PREAMBLE_INDEX

6B) PREAMBLE_TRANSMISSION_COUNTER

6C) PREAMBLE_POWER_RAMPING_COUNTER

6D) PREAMBLE_POWER_RAMPING_STEP

6E) PREAMBLE_RECEIVED_TARGET_POWER

6F) PREAMBLE_BACKOFF

6G) PCMAX

6H) SCALING_FACTOR_BI

6I) TEMPORARY_C-RNTI

In a case that the random access procedure is started in a certain serving cell (in other words, in S7001 or S7100 of FIG. 7), the MAC entity of the terminal apparatus 1 may flush an Msg3 buffer, set a value of 6B above to 1, set a value of 6C above to 1, set a value of 6F above to 0 ms, set a value of 6H above to 1, set values of 6D above, 6E above, and 6G above based on respectively corresponding one or multiple higher layer parameters, and perform a random access resource selection procedure.

Here, in the present embodiment, the higher layer parameter may be a parameter given by a MAC CE, may be a parameter given by RRC signaling, may be based on a parameter given by an MIB, or may be a parameter given by an SIB (system information).

In S7001 or S7101 of FIG. 7, the value of 6A above may be set to a value of ra-PreambleIndex corresponding to the selected SSB or CSI-RS or ra-PreambleIndex explicitly indicated by the PDCCH or the RRC. The terminal apparatus 1 may configure PRACH resources (resources of the random access preamble) corresponding to the set index, and perform a random access preamble transmission procedure.

In S7001 or S7101 of FIG. 7, in a case that the value of 6B above is larger than 1 for the random access preamble, a stop notification of a power ramping counter is not received from a lower layer, and a selected SSB is not changed, the MAC entity of the terminal apparatus 1 may increment the value of 6C above by 1. The MAC entity of the terminal apparatus 1 may set the value of 6E above to a value of transmission power based at least on a higher layer parameter preambleReceivedTargetPower, the value of 6C above, and the value of 6D above, and may indicate, for a physical layer, transmission of a random access preamble using a selected PRACH, a corresponding RA-RNTI, 6A above, and 6E above. Note that the higher layer parameter preambleReceivedTargetPower corresponds to an initial value of transmission power of the random access preamble.

In a case that the random access preamble is transmitted, in S7101, the MAC entity of the terminal apparatus 1 starts ra-ResponseWindow that is configured by a higher layer parameter BeamFailureRecoveryConfig at reception timing (first PDCCH occasion) of the first PDCCH after the end of random access preamble transmission, regardless of a possible occurrence of a measurement gap. While ra-ResponseWindow is running, the MAC entity of the terminal apparatus 1 may monitor the PDCCH of the SpCell for a response for a beam failure recovery request identified with the C-RNTI.

Similarly, in S7001, the MAC entity of the terminal apparatus 1 starts ra-ResponseWindow configured by a higher layer parameter RACH-ConfigCommon at reception timing of the first PDCCH after the end of random access preamble transmission. While ra-ResponseWindow is running, the MAC entity of the terminal apparatus 1 may monitor the PDCCH of the SpCell for an RAR identified with the RA-RNTI.

In S7001 to S7002 or S7101 to S7102, in a case that ra-ResponseWindow expires and a corresponding Msg2 is not received, the MAC entity of the terminal apparatus 1 may increment the value of 6B above by 1. In a case that the incremented value of 6B is a higher layer parameter preambleTransMax+1, a random access problem is indicated to a higher layer (RRC layer).

In S7003, in a case that the Msg3 is transmitted, the MAC entity of the terminal apparatus 1 may start or restart a higher layer parameter ra-ContentionResolutionTimer in the first symbol after the end of Msg3 transmission, and monitor the PDCCH while ra-ContentionResolutionTimer is running.

In S7003 to S7004, in a case that ra-ContentionResolutionTimer expires, the MAC entity of the terminal apparatus 1 discards the value of 6I above, and considers that the contention resolution has failed to succeed. In a case of considering that the contention resolution has failed to succeed, the MAC entity of the terminal apparatus 1 may flush a HARQ buffer used for transmission of the MAC PDU of the Msg3 buffer, and increment the value of 6B above by 1. In a case that the incremented value of 6B is the higher layer parameter preambleTransMax+1, a random access problem is indicated to a higher layer (RRC layer). In other words, in a case that the value of 6B above exceeds a maximum number of preamble transmission, the MAC entity of the terminal apparatus 1 indicates a random access problem to a higher layer (RRC layer). In a case that the random access procedure does not complete, the MAC entity of the terminal apparatus 1 may select random back-off time among 0 to 6F above, delay transmission of the random access preamble by the back-off time, and perform the random access resource selection procedure. Note that a value of a higher layer parameter preambleTransMax may be a maximum value of 6B above.

Based on completion of the random access procedure, the MAC entity of the terminal apparatus 1 discards CFRA resources except for CFRA resources for the beam failure recovery request, and flushes the HARQ buffer used for transmission of the MAC PDU of the Msg3.

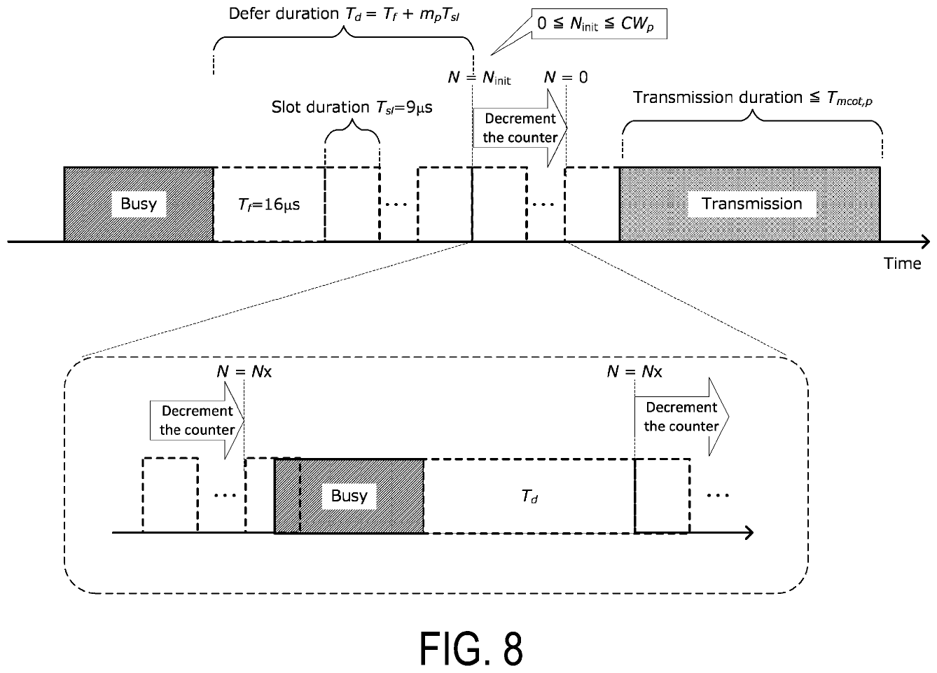

FIG. 8 is a diagram illustrating an example of a channel access procedure (CAP) according to an aspect of the present embodiment. In a case that the terminal apparatus 1 or the base station apparatus 3 determines idle (clear, free, communication is not performed, a specific physical signal is not transmitted, power (energy) of a specific physical signal is not detected, detected (measured) power (energy) or total power does not exceed a prescribed threshold) for a prescribed period in a carrier (in other words, an NR-U carrier), a BWP (in other words, an NR-U BWP), or a channel (in other words, an NR-U channel) in which energy detection is performed before a prescribed physical signal is transmitted and in which NR-U cell transmission is performed, the terminal apparatus 1 or the base station apparatus 3 may transmit a physical signal in the carrier, the BWP, or the channel. In other words, in a case that the terminal apparatus 1 or the base station apparatus 3 performs communication in the NR-U cell, the terminal apparatus 1 or the base station apparatus 3 performs Clear Channel Assessment (CCA) or channel measurement for confirming that the NR-U cell is idle for the prescribed period. The prescribed period may be determined based on a delay period T_{d}, a counter N, and a CCA slot period Ti. Note that to be “not idle” in a case that CCA is performed may be referred to as “busy”. Note that CCA may be performed in the radio transmission and/or reception unit 10 of the terminal apparatus 1 and/or the radio transmission and/or reception unit 30 of the base station apparatus 3. Note that the channel access procedure may include performing CCA for the prescribed period before the terminal apparatus 1 or the base station apparatus 3 transmits a physical signal in a certain channel. A procedure in which energy detection is performed in order to determine whether or not a channel is idle before a physical signal is transmitted as described above, or a procedure in which whether or not a channel is idle is determined and a physical signal is transmitted in a case that the channel is idle may be referred to as a channel access procedure, and/or a CCA procedure, and/or a Listen Before Talk (LBT) procedure. Here, the NR-U cell may be an NR-U carrier and/or an NR-U BWP and/or an NR-U channel, and may at least include a frequency band that can be used for transmission of a physical signal of NR-U. In other words, the NR-U cell, the NR-U carrier, the NR-U BWP, and the NR-U channel may mean the same. In the present embodiment, the NR-U cell may be interpreted as the NR-U carrier, the NR-U BWP, and/or the NR-U channel. The NR-U cell may include at least one of the NR-U carrier, the NR-U BWP, and the NR-U channel. The NR cell may include at least one of the NR carrier, the NR BWP, and the NR channel.

Here, in one NR-U operating band, in a case that the base station apparatus 3 and/or the terminal apparatus 1 can perform (have capability of performing) a multi-carrier access procedure (CAP for each of the multi-carriers), multiple carriers (NR-U carriers) and/or multiple BWPs (NR-U BWPs) may be configured for one NR-U cell.

The prescribed period is a period in which the counter N is 0 in a channel in which the state of being idle is first sensed in a delay period after detection of a signal other than its apparatus. The terminal apparatus 1 or the base station apparatus 3 can transmit a signal after the value of the counter N reaches 0. Note that, in a case that it is determined to be busy in a CCA slot period, decrement of the counter N may be deferred. An initial value Nᵢₙₜ of the counter N may be determined based on a value of a channel access priority class and a value (Contention Window size (CWS)) of its corresponding CWₚ. For example, the value of Nᵢₙₜ may be determined based on a random function that is uniformly distributed among values of 0 to CWₚ. With the value of CWₚ being updated, a possible value (a range of the value) of Nᵢₙₜ may be increased.

In a case that the terminal apparatus 1 or the base station apparatus 3 transmits one or multiple physical signals in the NR-U cell, the terminal apparatus 1 or the base station apparatus 3 sets the value of the counter N to Nᵢₙₜ.

In a case that the value of N is larger than 0 and the terminal apparatus 1 or the base station apparatus 3 determines clear in one CCA slot period, the terminal apparatus 1 or the base station apparatus 3 sets the value of N to N−1. In other words, in a case that the terminal apparatus 1 or the base station apparatus 3 determines clear in one CCA slot period, the terminal apparatus 1 or the base station apparatus 3 may decrement the value of the counter N by 1.

In a case that the decremented value of N reaches 0, the terminal apparatus 1 or the base station apparatus 3 may stop CCA in the CCA slot period. Otherwise, that is, in a case that the value of N is larger than 0, the terminal apparatus 1 or the base station apparatus 3 may continuously perform CCA of the CCA slot period until the value of N reaches 0.

In a case that the terminal apparatus 1 or the base station apparatus 3 performs CCA, determines idle, and the value of N is 0 in an added CCA slot period, the terminal apparatus 1 or the base station apparatus 3 can transmit a physical signal.

In a case that the terminal apparatus 1 or the base station apparatus 3 may perform CCA until the terminal apparatus 1 or the base station apparatus 3 determines busy in an added delay period, or determines idle in all of the slots in the added delay period. In a case that the terminal apparatus 1 or the base station apparatus 3 determines idle and the value of N is 0 in the added delay period, the terminal apparatus 1 or the base station apparatus 3 can transmit a physical signal. In a case that the terminal apparatus 1 or the base station apparatus 3 determines busy in the added delay period, the terminal apparatus 1 or the base station apparatus 3 may continuously perform CCA.

The channel access procedure that is variable based on information in which a value p of CAPC and a value of CWₚ are configured and a condition may be referred to as a type 1 channel access procedure (type 1 CAP), and a channel access procedure in which the value of CWₚ is constantly 0, the counter N corresponding to the value of CWₚ is not used, or CCA is performed only once before transmission may be referred to as a type 2 channel access procedure (type 2 CAP). In other words, the type 1 channel access procedure refers to a channel access procedure in which the period of CCA changes depending on the value of CWₚ updated based on a configured value p of CA PC and a condition. The type 2 channel access procedure refers to a channel access procedure in which transmission can be performed in a case that CCA is performed only once before transmission of a physical signal and it is determined that a channel (frequency band) on which a physical signal is transmitted is idle. Here, “before transmission” may include “immediately before transmission”. In a case that the channel access procedure has not completed before transmission of a physical signal, the terminal apparatus 1 and/or the base station apparatus 3 may perform or defer transmission of the physical signal at the transmission timing.

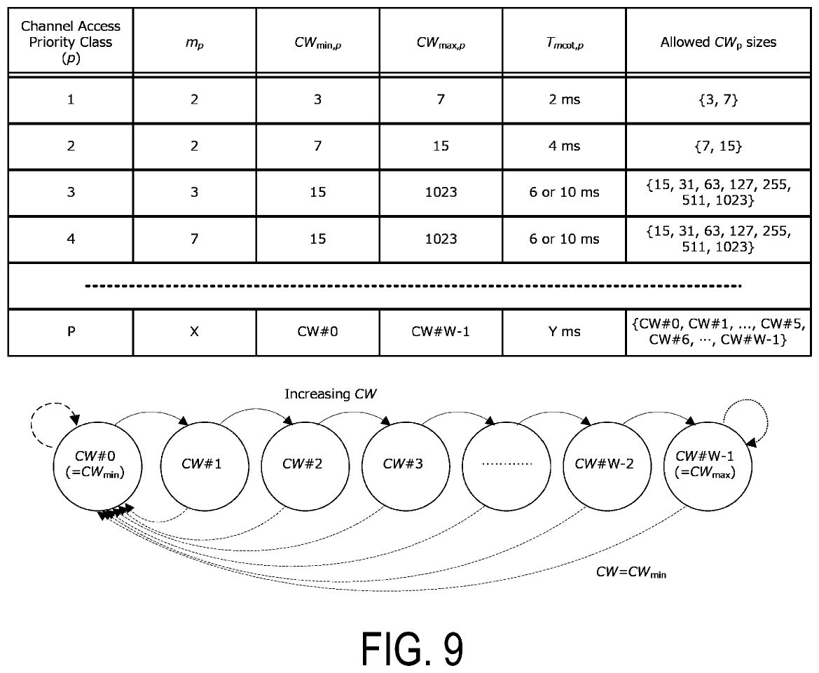

FIG. 9 is a diagram illustrating an example of the channel access priority class (CAPC) and a CW adjustment procedure according to an aspect of the present embodiment.

The value p of CAPC is used for indicating the number mₚ of CCA slot periods Tₛₗ included in the delay period T_{d}, a minimum value and a maximum value of the CW, maximum channel occupancy time, and an allowed value of CWₚ (CWS). The value p of CAPC may be configured according to priority of the physical signal. The value p of CAPC may be indicated by being included in the DCI format.

The terminal apparatus 1 may adjust the value of the CW for determining the value of Nᵢₙᵢₜ before setting the value of the counter N to Nᵢₙᵢₜ. Note that, in a case that the random access procedure successfully completes, the terminal apparatus 1 may maintain an updated value of the CW for the random access procedure. In a case that the random access procedure successfully completes, the terminal apparatus 1 may set an updated value of the CW to CWₘᵢₙ for the random access procedure. Here, in the present embodiment, CWₘᵢₙ may be, for example, CW #0 illustrated in FIG. 9, that is, an initial value of CWₚ corresponding to the value p of CAPC. Here, to set the updated value of the CW to CWₘᵢₙ may mean to update the value of the CW that is updated in a case that one or multiple prescribed conditions are satisfied to CWₘᵢₙ. To set the updated value of the CW to CWₘᵢₙ may mean to set the value of the CW to CWₘᵢₙ again.

The terminal apparatus 1 may adjust the value of the CW for determining the value of Nᵢₙᵢₜ before setting Nᵢₙᵢₜ to the value of the counter N corresponding to CCA performed before Msg1 transmission. Note that, in a case that the terminal apparatus 1 considers that the terminal apparatus 1 has succeeded in reception of the Msg2, and/or considers that the terminal apparatus 1 has succeeded in reception of the Msg4, the terminal apparatus 1 may maintain the updated value of the CW. In a case that the terminal apparatus 1 considers that the terminal apparatus 1 has succeeded in reception of the Msg2 and/or considers that the terminal apparatus 1 has succeeded in reception of the Msg4, the terminal apparatus 1 may set the updated value of the CW to CWₘᵢₙ.

Here, to adjust the value of the CW may mean that the value is incremented by one stage at a time until the value reaches CWₘₐₓ from CWₘᵢₙ in a case that the value of CWₚ satisfies a prescribed condition. In a case that the value reaches CWₘₐₓ, the value is further incremented by one stage at a time from CWₘᵢₙ. In other words, to adjust the value of the CW may mean to update the value of CWₚ. To update the value of CWₚ may mean to increment the value of CWₚ to a value larger by one stage. For example, this may mean to increment the value from CW #3 to CW #4, or from CW #n−1 to CW #n. The terminal apparatus 1 and/or the base station apparatus 3 may determine the value of Nᵢₙᵢₜ, based on a random function that is uniformly distributed between 0 and the updated value of CWₚ every time the value of the CW is adjusted.

The value p of the channel access priority class (CAPC) applied to transmission of the Msg1 may be determined based on system information, may be determined based on a higher layer parameter, or may be associated with the SSB. For example, in a case that the value p of CAPC corresponding to the Msg1 is P, the value of Nᵢₙᵢₜ is determined based on a random function that is uniformly distributed between 0 and CW #0.

For example, in a case that the terminal apparatus 1 considers that the terminal apparatus 1 fails in (fails to succeed in) reception of the Msg2 or the Msg4 in S7002, S7004, and S7102 of FIG. 7, the terminal apparatus 1 increments the value of 6B above by 1. Subsequently, in a case that the terminal apparatus 1 transmits the Msg1, the value of CWₚ used for the value of Nᵢₙᵢₜ is updated from CW #0 to CW #1. The terminal apparatus 1 may adjust (update) the value of CWₚ used for the value of Nᵢₙᵢₜ, according to the value of 6B above. In a case that the sum of CWₚ corresponding to the value P of CAPC is smaller than the higher layer parameter preambleTransMax, before the value of 6B above becomes the higher layer parameter preambleTransMax+1, the value of CWₚ may return to CWₘᵢₙ (in other words, CW #0), and the value of CWₚ may be updated again. Note that the value of CWₚ (allowable value) may correspond to the value that is obtained by mod(value of 6B above, sum of CWₚ (for example, W from CW #0 to CW #W−1)). Here, mod(A, B) may be a function of outputting a remainder obtained by dividing A by B (divisor). For example, in a case that the value of 6B above is 10 and the sum of CWₚ is 7, the value of CWₚ may be CW #3.

In S7002 and S7003 of FIG. 7, in a case that a prescribed time period elapses or a timer expires after the base station apparatus 3 transmits the Msg2 and the base station apparatus 3 considers that the base station apparatus 3 has failed in (failed to succeed in) reception of the Msg3 corresponding to the Msg2, the base station apparatus 3 may adjust the value of the CW for determining the value of Nᵢₙᵢₜ before performing transmission or retransmission of the Msg2 and before setting Nᵢₙᵢₜ to the value of the counter N corresponding to CCA for the Msg2. Note that, in a case that the base station apparatus 3 considers that the base station apparatus 3 has succeeded in reception of the Msg3 corresponding to the Msg2, the base station apparatus 3 need not adjust the updated value of the CW. In other words, the base station apparatus 3 may maintain the updated value of the CW. In a case that the base station apparatus 3 considers that the base station apparatus 3 has succeeded in reception of the Msg3 corresponding to the Msg2, the base station apparatus 3 may set the updated value of the CW to CWₘᵢₙ.

In S7004 of FIG. 7, in a case that the base station apparatus 3 considers that the base station apparatus 3 fails in (fails to succeed in) reception of the Ack (Msg5) corresponding to the Msg4 after the base station apparatus 3 transmits the Msg4, the base station apparatus 3 may adjust the value of the CW for determining the value of Nᵢₙᵢₜ before performing transmission or retransmission of the Msg4 and before setting Nᵢₙᵢₜ to the value of the counter N corresponding to the channel access procedure for performing transmission of the Msg4. In a case of transmitting the Msg4 to multiple terminal apparatuses 1 in a prescribed period, the base station apparatus 3 may determine whether or not to adjust the value of the CW, based on a success rate of reception of the Msg5. In a case of transmitting the Msg4 to multiple terminal apparatuses 1 in a prescribed period, the base station apparatus 3 may determine whether or not to adjust the value of the CW, based on the success rate of reception of the Msg5. In other words, in a case that the success rate of reception of the Msg5 exceeds a prescribed threshold, the base station apparatus 3 need not adjust (may maintain) the updated value of the CW. In a case that the success rate of reception of the Msg5 exceeds the prescribed threshold, the base station apparatus 3 may set the updated value of the CW to CWₘᵢₙ.

In a case that the terminal apparatus 1 considers that the terminal apparatus 1 fails in (fails to succeed in) reception of the Msg2, the terminal apparatus 1 may configure the length (value) of ra-ResponseWindow to a value longer by one stage. In a case that the terminal apparatus 1 considers that the terminal apparatus 1 fails in reception of the Msg4, the terminal apparatus 1 may configure the length (value) of ra-ContentionResolutionTimer to a value longer by one stage. The terminal apparatus 1 may determine the length of ra-ResponseWindow and/or the length of ra-ContentionResolutionTimer, based on the value based on the higher layer parameter, and the value of CWₚ and the CCA slot period. For example, in a case that the value based on the higher layer parameter is 10 slots (for example, 10 ms), the value p of CAPC is 4, and the value of CWₚ is 63, the length of ra-ResponseWindow and/or the length of ra-ContentionResolutionTimer may be obtained based on 10 ms+63×9 μs+T_{d} (for example, 25 μs). Note that the value based on the higher layer parameter may be configured for each of ra-ResponseWindow and ra-ContentionResolutionTimer. Note that, in a case that the terminal apparatus 1 considers that the terminal apparatus 1 has succeeded in reception of the Msg2, the terminal apparatus 1 may maintain the length (value) of ra-ResponseWindow. Similarly, in a case that the terminal apparatus 1 considers that the terminal apparatus 1 has succeeded in reception of the Msg4, the terminal apparatus 1 may maintain the length (value) of ra-ContentionResolutionTimer. In a case that the terminal apparatus 1 considers that the terminal apparatus 1 has succeeded in reception of the Msg2, the terminal apparatus 1 may set (return) the length (value) of ra-ResponseWindow to a value (in other words, an initial value) that is configured using the higher layer parameter. Similarly, in a case that the terminal apparatus 1 considers that the terminal apparatus 1 has succeeded in reception of the Msg4, the terminal apparatus 1 may set (return) the length (value) of ra-ContentionResolutionTimer to a value (in other words, an initial value) that is configured as the higher layer parameter.

In S7004 of FIG. 7, in a case that the base station apparatus 3 again receives the Msg1 that is received in S7001 after the base station apparatus 3 transmits the Msg4, the base station apparatus 3 may adjust the value of the CW for determining the value of Nᵢₙᵢₜ before performing transmission of the Msg2 corresponding to the retransmitted Msg1 and before setting Nᵢₙᵢₜ to the value of the counter N corresponding to CCA for the Msg2. Note that, in a case that the base station apparatus 3 receives the Ack (Msg5) for the Msg4 after the base station apparatus 3 transmits the Msg4, that is, in a case that the random access procedure successfully completes, the base station apparatus 3 may maintain the updated value of the CW. In a case that the random access procedure successfully completes, the base station apparatus 3 may set the updated value of the CW to CWₘᵢₙ being the initial value of CWₚ.

In S7101 of FIG. 7, in a case that a prescribed time period elapses or a timer expires, and the base station apparatus 3 considers that the base station apparatus 3 fails in (fails to succeed in) reception of the Msg1 corresponding to the PDCCH order, the base station apparatus 3 may adjust the value of the CW for determining the value of Nᵢₙᵢₜ before performing transmission or retransmission of the PDCCH order and before setting Nᵢₙᵢₜ to the value of the counter N corresponding to CCA for the PDCCH order. Note that, in a case that the base station apparatus 3 considers that the base station apparatus 3 has succeeded in reception of the Msg1 corresponding to the PDCCH order, the base station apparatus 3 may maintain the updated value of the CW. In a case that the base station apparatus 3 considers that the base station apparatus 3 has succeeded in reception of the Msg1 corresponding to the PDCCH order, the base station apparatus 3 may set the updated value of the CW to CWₘᵢₙ.

In S7101 of FIG. 7, in a case that a prescribed time period elapses or a timer expires, and the base station apparatus 3 considers that the base station apparatus 3 fails in (fails to succeed in) reception of the Msg1 corresponding to the PDCCH order, whether or not to adjust the value of the CW for determining the value of Nᵢₙᵢₜ may be based on a case that the base station apparatus 3 considers having failed (having failed to succeed), at a prescribed ratio, in reception of the Msg1 corresponding to the PDCCH order transmitted to multiple terminal apparatuses 1 in a prescribed period. For example, in a case that the base station apparatus 3 transmits the PDCCH order to each of terminal apparatuses A to E in a first prescribed period and the base station apparatus 3 receives a corresponding Msg1 from each of the terminal apparatuses A to E, the base station apparatus 3 considers that the base station apparatus 3 has succeeded in transmission of the PDCCH order, and need not adjust the value of the CW. In a case that the base station apparatus 3 transmits the PDCCH order to each of the terminal apparatuses A to E in the first prescribed period, and the base station apparatus 3 considers that the base station apparatus 3 receives a corresponding Msg1 from the terminal apparatus A and the terminal apparatus E while having failed to succeed in reception of the Msg1 for the rest of the terminal apparatuses (for example, the success rate of reception of the Msg1 is 40%), the base station apparatus 3 considers that the base station apparatus 3 has failed to succeed in transmission of the PDCCH order, and the base station apparatus 3 may adjust the value of the CW for the PDCCH order. Note that, in a case that the success rate of reception of the Msg1 exceeds a prescribed threshold, the base station apparatus 3 considers that the base station apparatus 3 has succeeded in transmission of the PDCCH order, and may maintain the updated value of the CW. In a case that the success rate of reception of the Msg1 exceeds a prescribed threshold, the base station apparatus 3 may set the updated value of the CW to CWₘᵢₙ.

Next, the procedure of the SR according to the present embodiment will be described.

For the MAC entity of the terminal apparatus 1, zero, one, or more than one SR configuration may be configured. One SR configuration configures a set of PUCCH resources for the SR across different BWPs and/or different cells. For the logical channel, PUCCH resources for at most one SR may be configured for each BWP. In the set of PUCCH resources, one or multiple PUCCH resources may be included.

Each SR configuration may correspond to one or multiple logical channels. Each logical channel may be mapped to zero or one SR configuration. It may be configured by RRC (in other words, a higher layer parameter, RRC information). The SR configuration of the logical channel in which a Buffer Status Report (BSR) is triggered may be considered as an SR configuration corresponding to a triggered SR.

Higher layer parameters (RRC parameters) of the following 7A to 7C may be configured for the SR procedure. Note that 7A and 7B may be configured for each SR configuration. In a case that 7A is not configured, the terminal apparatus 1 may apply 0 as the value of 7A.

7A) sr-ProhibitTimer

7B) sr-TransMax

7C) sr-ConfigIndex

As a variable of the terminal apparatus 1, SR_COUNTER that is configured for each SR configuration may be used for the SR procedure.

In a case that the SR is triggered, and there are no other suspended SRs corresponding to the same SR configuration, the MAC entity of the terminal apparatus 1 sets SR_COUNTER of a corresponding SR configuration to 0.

In a case that an SR is triggered, it is considered that the SR is suspended until the SR is cancelled. All of the suspended SRs that are triggered before MAC PDU assembly are cancelled, each sr-ProhibitTimer is stopped in a case of transmission of the MAC PDU, and the MAC PDU includes a BSR MAC CE including buffer statuses of up to the last event in which the BSR before the MAC PDU assembly is triggered. In a case that the uplink grant (resources allocated by the uplink grant) can correspond to all of transmittable suspended pieces of data, all of the suspended SRs are cancelled.

In the terminal apparatus 1, it is considered that only the PUCCH resources are valid in the BWP being active in a case that there is an SR transmission occasion (SR transmission timing).

In a case that at least one SR is suspended and valid PUCCH resources are not configured for each of the suspended SRs, the MAC entity of the terminal apparatus 1 starts the random access procedure in the SpCell and cancels the suspended SRs. Otherwise, in a case that the MAC entity of the terminal apparatus 1 has the SR transmission occasion in the valid PUCCH resources for the configured SR for the SR configuration corresponding to the suspended SR, sr-ProhibitTimer is not running in the SR transmission occasion, the PUCCH resources for the SR transmission occasion do not overlap with the measurement gap, the PUCCH resources for the SR transmission occasion do not overlap with the UL-SCH resources, and further the value of SR_COUNTER is a value smaller than the value of sr-TransMax, the MAC entity of the terminal apparatus 1 increments the value of SR_COUNTER by 1, indicates to the physical layer that SR is signaled in one valid PUCCH resource for the SR, and starts sr-ProhibitTimer. Otherwise (for example, in a case that the value of SR_COUNTER is the same as the value of sr-TransMax), release of the PUCCH may be notified to the RRC (RRC layer, RRC layer processing unit) for all of the serving cells, release of the SRS may be notified to the RRC for all of the serving cells, both of the configured downlink assignment (downlink grant) and uplink grant may be cleared, the random access procedure may be started in the SpCell, and all of the suspended SRs may be cancelled. Here, to release the physical signal may include to release the resources secured for the physical signal (here, the PUCCH and the SRS) as a target, and to release the configuration related to the physical signal as a target.

The MAC entity of the terminal apparatus 1 may stop the ongoing random access procedure that is started by the MAC entity before the MAC PDU assembly for the suspended SRs without configured valid PUCCH resources. In a case that the MAC PDU is transmitted by using an uplink grant other than an uplink grant that is provided by the RAR, the random access procedure may be stopped. The MAC PDU includes the BSR MAC CE including buffer statuses of up to the last event in which the BSR is triggered before the MAC PDU assembly or in a case that the uplink grant (resources allocated by the uplink grant) can correspond to all of transmittable suspended pieces of data.

In a case that the terminal apparatus 1 (the MAC entity of the terminal apparatus 1) transmits the SR by using PUCCH resources (indicates triggering of transmission of the SR to the physical layer of the terminal apparatus 1) in the NR-U cell (NR-U carrier, NR-U BWP, NR-U channel), the terminal apparatus 1 may determine whether or not to perform the channel access procedure before transmission of the SR, based on configured information. The SR may be PUCCH resources that are used for the PUCCH (PUCCH resource) at least including the SR and/or SR transmission.

In a case that the terminal apparatus 1 performs the type 1 channel access procedure before transmission of the SR (or the PUCCH including the SR), the terminal apparatus 1 sets the value of the CW that is used for determining the value of Nᵢₙᵢₜ used for the type 1 channel access procedure performed before transmission of the SR corresponding to SR_COUNTER configured for each SR configuration to CW #0, and performs CCA until the value of the counter N becomes 0 before transmission of the SR, and in a case that the terminal apparatus 1 determines that the NR-U channel is idle, the terminal apparatus 1 can transmit the SR, whereas in a case that the terminal apparatus 1 determines that the NR-U channel is busy, the terminal apparatus 1 suspends (defers) transmission of the SR until the next transmission occasion. Note that, in a case that the value of SR_COUNTER is incremented by 1, the value of the CW used for the value of Nᵢₙᵢₜ corresponding to SR_COUNTER may be set from CW #0 (CWₘᵢₙ) to CW #1 again (in other words, the value of the CW may be updated). Note that, in a case that the value of the CW used for the value of Nᵢₙᵢₜ corresponding to SR_COUNTER is CWₘₐₓ, and the value of the CW is adjusted, the value of CWₚ may be set to CW #0 (CWₘᵢₙ) being the initial value again.

In a case that the terminal apparatus 1 and/or the physical layer of the terminal apparatus 1 sets SR_COUNTER to 0 in the MAC entity, the terminal apparatus 1 and/or the physical layer of the terminal apparatus 1 may set the value of the CW used for the type 1 channel access procedure to the initial value CWₘᵢₙ. In a case that the terminal apparatus 1 and/or the physical layer of the terminal apparatus 1 determines that there are no other suspended SRs in the MAC entity, the terminal apparatus 1 and/or the physical layer of the terminal apparatus 1 may set the value of the CW used for the type 1 channel access procedure to the initial value CWₘᵢₙ.

In a case that the terminal apparatus 1 performs the type 2 channel access procedure before transmission of the SR (or the PUCCH including the SR), the terminal apparatus 1 performs CCA only once before transmission of the SR, and in a case that the terminal apparatus 1 determines that the NR-U channel is idle, the terminal apparatus 1 can transmit the SR, whereas in a case that the terminal apparatus 1 determines that the NR-U channel used for SR transmission is busy, the terminal apparatus 1 suspends (or defers) transmission of the SR until the next transmission occasion. In a case that the terminal apparatus 1 suspends transmission of the SR and performs the type 1 CAP before transmission of the SR in the next SR transmission occasion, the terminal apparatus 1 may update the value of the CW used for the type 1 CAP to one higher allowable value. In a case that the terminal apparatus 1 suspends transmission of the SR and notifies that the transmission of the SR is suspended from the physical layer to the MAC layer (MAC entity), the terminal apparatus 1 may increment SR_COUNTER used for transmission of the SR by 1. In a case that the terminal apparatus 1 suspends transmission of the SR, based on the fact that the terminal apparatus 1 has determined that the NR-U channel is busy, the terminal apparatus need not increment the value of SR_COUNTER used for transmission of the SR.

In a case that the MAC entity of the terminal apparatus 1 cancels all of the suspended SRs and starts the random access procedure in the SpCell, and the channel access procedure before transmission of the SR is the type 1 channel access procedure, the value of the CW used for the value of Nᵢₙᵢₜ for the Msg1 of the random access procedure may be configured based on a higher layer parameter, or may be the minimum value (CWₘᵢₙ) of the value of the CW used for the value of Nᵢₙᵢₜ for the SR configuration. Note that, in a case that the channel access procedure before transmission of the SR is the type 2 channel access procedure, CCA may be performed only once before transmission of the Msg1 so as to determine whether or not the NR-U channel is idle.

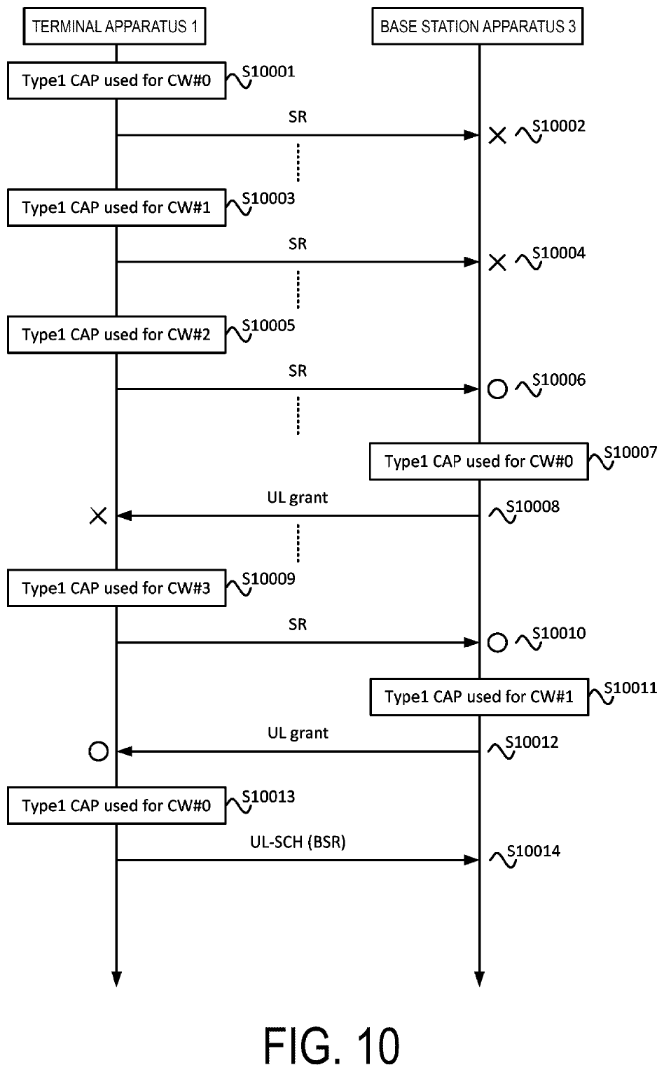

FIG. 10 is a diagram illustrating an example of the channel access procedure (CAP) and the CW adjustment procedure (CWAP) in a case of SR transmission according to the present embodiment.

In S10001, in a case that the condition described above is satisfied, and the MAC entity indicates, to the physical layer, signaling of the SR on the PUCCH resources in a case that the valid PUCCH resources are configured for the suspended SR in the NR-U cell, the terminal apparatus 1 or the MAC entity of the terminal apparatus 1 performs the channel access procedure (CAP) configured for the PUCCH resource and/or the SR in the physical layer. In a case that the CAP is the type 1 CAP, the value of Nᵢₙᵢₜ may be set from the value of the CW (for example, CW #0) used for Ni it set as the initial value for the counter N of the type 1 CAP and a random function. In a case that the values of Nᵢₙᵢₜ and N are determined, the terminal apparatus 1 performs CCA until the value of the counter N becomes 0 and performs CCA once immediately before transmission of the SR, and in a case that all of those are idle, the terminal apparatus 1 transmits the SR in the SR transmission occasion.

In S10002, a prescribed timer may be caused running (started) after the terminal apparatus 1 transmits the SR. In a case that the terminal apparatus 1 fails to successfully receive the uplink grant for the SR by the time the prescribed timer expires, the terminal apparatus 1 considers that the base station apparatus 3 has failed in detection of the SR. In this case, the physical layer of the terminal apparatus 1 may notify the failure to the MAC entity of the terminal apparatus 1. Note that, in a case that the prescribed timer has not expired and there is an SR transmission occasion, the terminal apparatus 1 may perform the type 2 CAP, and in a case that it is idle, the terminal apparatus 1 may transmit the SR. Here, the prescribed timer is used. However, channel occupancy time (COT) of the terminal apparatus 1 may be used, or a prescribed period may be used.

In S10003, in a case that the terminal apparatus 1 or the MAC entity of the terminal apparatus 1 performs retransmission of the same SR (SR of the same SR configuration) in the same NR-U cell, the terminal apparatus 1 or the MAC entity of the terminal apparatus 1 increments the value of SR_COUNTER corresponding to the SR configuration by 1, and in a case that the condition described above is satisfied, the MAC entity indicates, to the physical layer, signaling of the SR on the PUCCH resources. Based on the indication, the physical layer may update the value of the CW from CW #0 to CW #1, and set the value of Nᵢₙᵢₜ. The terminal apparatus 1 performs the CCA until the value of the counter N becomes 0, and performs CCA once immediately before transmission of the SR, and in a case that it is determined to be idle in all of the CCA slot periods, the terminal apparatus 1 transmits the SR in the SR transmission occasion.

In S10004, a prescribed timer may be caused running (started) after the terminal apparatus 1 transmits the SR. In a case that the terminal apparatus 1 fails to successfully receive the uplink grant for the SR by the time the prescribed timer expires, the terminal apparatus 1 considers that the base station apparatus 3 has failed in detection of the SR. In this case, the physical layer of the terminal apparatus 1 may notify the failure to the MAC entity of the terminal apparatus 1.

In S10005, in a case that the terminal apparatus 1 or the MAC entity of the terminal apparatus 1 performs retransmission of the same SR (SR of the same SR configuration) in the same NR-U cell, the terminal apparatus 1 or the MAC entity of the terminal apparatus 1 increments the value of SR_COUNTER corresponding to the SR configuration by 1, and in a case that the condition described above is satisfied, the MAC entity indicates, to the physical layer, signaling of the SR on the PUCCH resources. Based on the indication, the physical layer may update the value of the CW from CW #1 to CW #2, and set the value of Nᵢₙᵢₜ. The terminal apparatus 1 performs CCA until the value of the counter N becomes 0 and performs CCA once immediately before transmission of the SR, and in a case that all of those are idle, the terminal apparatus 1 transmits the SR in the SR transmission occasion. Note that, in a case that there are only CW #0 and CW #1 for configurable allowable values of the CW (in other words, in a case that there are only two configurable allowable values of the CW), the value of the CW may return from CW #1 to CW #0. In a case that there is only one configurable allowable value of the CW (for example, only CW #0), the terminal apparatus 1 may set the value of the CW used for Nᵢₙₜ, based on a random function among 0 to the value of CW #0 every time the value of SR_COUNTER is incremented.

In S10006, in a case that the base station apparatus 3 has succeeded in reception of the SR, the base station apparatus 3 may transmit the PDCCH including the DCI format (uplink grant) used for scheduling the UL-SCH (PUSCH) for new transmission.

In S10007, in a case that the base station apparatus 3 transmits the uplink grant in the NR-U cell, the base station apparatus 3 performs the CAP before transmission of the uplink grant. In a case that the type 1 CAP is configured for the uplink grant or the PDCCH including the uplink grant, the base station apparatus 3 sets the value of the counter N for the CAP before transmission of the PDCCH to the value of N t based on a random function of CW #0, and performs the CCA based on the type 1 CAP, and in a case that all of those are idle, the base station apparatus 3 may transmit the uplink grant.

In S10008, a prescribed timer may be started in a case that the base station apparatus 3 transmits the uplink grant. In a case that the UL-SCH corresponding to the uplink grant fails to be successfully received for a prescribed period since the uplink grant is transmitted, and the prescribed timer has not expired, the type 2 CAP may be performed, and the uplink grant may be transmitted. Note that the prescribed timer is herein used. However, COT of the base station apparatus 3 may be used, or a prescribed period may be used. In a case that the prescribed timer expires, the base station apparatus 3 need not transmit the uplink grant.

In S10008, in a case that the terminal apparatus 1 fails to successfully receive the uplink grant, and the prescribed timer expires (a prescribed period elapses), the type 1 CAP may be performed for the next SR transmission occasion.

In S10009, in a case that the terminal apparatus 1 or the MAC entity of the terminal apparatus 1 performs retransmission of the same SR (SR of the same SR configuration) in the same NR-U cell, the terminal apparatus 1 or the MAC entity of the terminal apparatus 1 increments the value of SR_COUNTER corresponding to the SR configuration by 1, and in a case that the condition described above is satisfied, the MAC entity indicates, to the physical layer, signaling of the SR on the PUCCH resources. Based on the indication, the physical layer may update the value of the CW from CW #2 to CW #3, and set the value of Nᵢₙᵢₜ. The terminal apparatus 1 performs CCA until the value of the counter N becomes 0 and performs CCA once immediately before transmission of the SR, and in a case that all of those are idle, the terminal apparatus 1 transmits the SR in the SR transmission occasion. Note that CW #3 is herein used in the description. However, CW #3 may be CW #0, or may be CW #1, according to the number of configurable values of the CW.

In S10010, the terminal apparatus 1 performs transmission of the SR, and in a case that the base station apparatus 3 succeeds in reception of the SR, the base station apparatus 3 may transmit the uplink grant corresponding to the SR.

In S10011, in a case that the base station apparatus 3 transmits the uplink grant in the NR-U cell, the base station apparatus 3 performs the CAP before transmission of the uplink grant. In a case that the type 1 CAP is configured for the uplink grant or the PDCCH including the uplink grant, the base station apparatus 3 updates the value of the CW from CW #0 to CW #1. The base station apparatus 3 may set the value of the counter N for the CAP before transmission of the PDCCH to the value of Nᵢₙᵢₜ based on a random function of CW #1, and perform CCA based on the type 1 CAP, and in a case that all of those are idle, the base station apparatus 3 may transmit the uplink grant.

In S10012, in a case that the terminal apparatus 1 successfully receives the uplink grant, the terminal apparatus 1 may transmit the UL-SCH by using the PUSCH resources scheduled by the uplink grant. In this case, in a case that a CAPC field and a field indicating the type of the CAP are included in the uplink grant, the terminal apparatus 1 may determine the type of the CAP before transmission of the PUSCH including the UL-SCH and the value of the CW used for the CAP, based on the two fields.

In S10013, in a case that the terminal apparatus 1 successfully receives the uplink grant in the NR-U cell, the terminal apparatus 1 performs the CAP before transmission of the PUSCH including a corresponding UL-SCH. In a case that it is determined to be idle in the CAP, the terminal apparatus 1 may transmit the PUSCH. In a case that the type 1 CAP is set to the field indicating the type of the CAP included in the uplink grant, the terminal apparatus 1 transmits the PUSCH after performing the type 1 CAP, whereas in a case that the type 2 CAP is set to the field indicating the type of the CAP, the terminal apparatus 1 transmits the PUSCH after performing the type 2 CAP. S10013 illustrates an example of a case that the type 1 CAP is set to the field indicating the type of the CAP. In a case of the type 1 CAP, the terminal apparatus 1 may determine the value of the CW, based on the value p of CAPC set in the CAPC field. In a case that transmission of the PUSCH is initial transmission for the terminal apparatus 1, the value of the CW may be CW #0. The terminal apparatus 1 may set the value of the counter N for the CAP before transmission of the PUSCH to the value of Nᵢₙᵢₜ based on a random function of CW #0, and perform the CCA based on the type 1 CAP, and in a case that all of those are idle, the terminal apparatus 1 may transmit the PUSCH (S10014). Note that, in a case that the terminal apparatus 1 successfully receives the uplink grant, the terminal apparatus 1 may set the updated value of the CW that has been used for SR transmission to CWₘᵢₙ. In other words, in a case that the terminal apparatus 1 considers that SR transmission has succeeded, the terminal apparatus 1 may set the value of the CW to CWₘᵢₙ.

In a case that the value of SR_COUNTER is set to 0 in the MAC entity, the terminal apparatus 1 may set the updated value of the CW to CWₘᵢₙ. In a case that the terminal apparatus 1 determines that there are no other suspended SRs in the MAC entity, the terminal apparatus 1 may set the updated value of the CW to CWₘᵢₙ. In a case that the terminal apparatus 1 determines that the UL-SCH including the BSR has been successfully transmitted, the terminal apparatus 1 may set the updated value of the CW to CWₘᵢₙ.

In S10014, in a case that the base station apparatus 3 successfully receives the UL-SCH, and the BSR is included in the UL-SCH, one or multiple uplink grants may be transmitted in order to allocate a necessary PUSCH in consideration of the BSR. Note that, in a case that the base station apparatus 3 successfully receives the UL-SCH, the base station apparatus 3 may set the updated value of the CW to CWₘᵢₙ. In other words, in a case that the base station apparatus 3 considers that the uplink grant corresponding to the SR has been successfully received by the terminal apparatus 1, the base station apparatus 3 may set the updated value of the CW to CWₘᵢₙ.

In a case that the terminal apparatus 1 starts the random access procedure in the NR-U cell (NR-U cell as the SpCell) in order to perform transmission of the SR, the terminal apparatus 1 may set the updated value of the CW to CWₘᵢₙ. In a case that the terminal apparatus 1 cancels all of the suspended SRs in the MAC entity, the terminal apparatus 1 may set the updated value of the CW to CWₘᵢₙ. In a case that the terminal apparatus 1 clears one or multiple configured downlink assignments and/or uplink grants, the terminal apparatus 1 may set the updated value of the CW to CWₘᵢₙ. In a case that the terminal apparatus 1 notifies release of the PUCCH to the RRC for all of the serving cells, the terminal apparatus 1 may set the updated value of the CW to CWₘᵢₙ.

The value p of CAPC may be individually configured for each of the PUSCH, the PUCCH, and the PRACH. For the value p of CAPC, a common value may be configured as a cell-specific higher layer parameter for the PUSCH, the PUCCH, and the PRACH. The value p of CAPC may be configured as an individual higher layer parameter for each of the PUSCH, the PUCCH, and the PRACH. The value p of CAPC for the PUSCH may be indicated by being included in the DCI format used for scheduling of the PUSCH. The value p of CAPC for the PUCCH may be indicated by being included in the DCI format including the PUCCH resource indication field. The value p of CAPC for the PRACH may be indicated by being included in the DC format for the PDCCH order. The value p of CAPC for the PRACH may be determined according to the type of the random access procedure. For example, the value p of CAPC for CBRA may be determined based on system information and/or a higher layer parameter. The value p of CAPC for CFRA may be determined based on a higher layer parameter, or may be configured by being included in the DCI format corresponding to the PDCCH order. In CFRA, whether the value p of CAPC is based on a higher layer parameter or based on a field of the DCI format may be determined based on configuration of the system information and/or the higher layer parameter.

In a case that the terminal apparatus 1 transmits a HARQ-ACK for the PDSCH on the PUCCH resources, the type of the channel access procedure for the PUCCH and/or the value p of CAPC may be configured with one or multiple dedicated fields being included in the DC format used for scheduling of the PDSCH. Note that, in the DCI format, the PUCCH resource indication field may be included. In other words, the type of the channel access procedure for the PUCCH and/or the value of CAPC may be used for the PUCCH resources indicated by the PUCCH resource indication field. In a case that the terminal apparatus 1 transmits the SR on the PUCCH resources, the type of the channel access procedure for the PUCCH and/or the value p of CAPC may be configured based on one or multiple higher layer parameters included in PUCCH configuration or SR configuration.

The value p of CAPC may be determined by being associated with transmitted information for the PUSCH and the PUCCH. For example, in a case that transmission is performed including the UCI in the PUSCH or the PUCCH, the value p of CAPC may be individually configured according to the type (the HARQ-ACK, the SR, the CSI, or the like) and a combination of information included in the UCI.

The present embodiment provides description of the value p of CAPC. However, the type of the channel access procedure (CAP) (the type 1 CAP, the type 2 CAP, that is, a Channel Access Type (CAT)), the value of the CW, and/or the value of T_{mcot} may be configured similarly as well.

For example, in the DCI format (DCI formats 0_0, 0_1, 1_0, and 1_1) used for scheduling of the PDSCH and the PUSCH and resource allocation of the PRACH in the NR-U cell, in order to perform the channel access procedure, a part or all of the following 8A to 8E may each be included as the field.

8A) Type of the channel access procedure (CAP) (channel access type (CAT))

8B) Value p of the channel access priority class (CAPC)

8C) Maximum channel occupancy time T_{mcot}

8D) Value of the CW

8E) Maximum number m of CCA slot periods

In a case that the PUCCH resource indication field is included in the DCI format (1_0, 1_1) used for scheduling of the PDSCH in addition to the part or all of the 8A to 8E above, the channel access procedure before transmission of the PUCCH for the HARQ-ACK of the PDSCH may be performed based on at least one of 8A to 8E above included in the DCI format.

In a case that the received DCI format indicates resource allocation of the random access preamble, that is, in a case that the PDCCH order is received, and a part or all of 8A to 8E above is included in the PDCCH order, the channel access procedure before transmission of the random access preamble may be performed based on the part or all of 8A to 8E above included in the PDCCH order.

In a case that the SR is transmitted on the PUCCH in the NR-U carrier, a part or all of 8A to 8E above may be included in the PUCCH configuration or the SR configuration. In other words, in a case that the channel access procedure is performed for the PUCCH including the SR, a parameter for the channel access procedure may be configured based on a higher layer parameter. In a case that the channel access procedure is performed for the PUCCH including the SR, the parameter for the channel access procedure may be transmitted and configured from the base station apparatus 3 to the terminal apparatus 1 through an RRC layer signal.

Next, HARQ operation according to the present embodiment will be described.

The MAC entity of the terminal apparatus 1 may include at least one HARQ entity for each serving cell. At least one HARQ entity can maintain a large number of HARQ processes in parallel. Each of the HARQ processes may be associated with one HPID. The HARQ entity guides the HARQ information and a related TB received in the DL-SCH to one or multiple corresponding HARQ processes.

The number (maximum number) of the DL HARQ processes that can be performed in parallel for each HARQ entity may be configured based on a higher layer parameter (for example, an RRC parameter), or may be a default value in a case that the higher layer parameter is not received. A dedicated broadcast HARQ process may be used for the BCCH. Note that a broadcast HARQ process may be referred to as a broadcast process.

In a case that downlink spatial multiplexing is not configured for the physical layer, the HARQ process supports one TB. In a case that downlink spatial multiplexing is configured for the physical layer, the HARQ process supports one or two TBs.

Regarding the MAC entity of the terminal apparatus 1, in a case that a higher layer parameter pdsch-AggregationFactor having a value of greater than 1 is configured, pdsch-AggregationFactor may provide the number of transmissions of the TB in a bundle of dynamic downlink assignments. Bundling operation (HARQ-ACK bundling operation) depends on the HARQ entity for calling (starting) the same HARQ process for each transmission being a part of the same bundle. After initial transmission, retransmission of the HARQ having a value less than the value configured by pdsch-AggregationFactor by 1 (in other words, pdsch-AggregationFactor−1) may be continued in the bundle.

In a case that downlink assignment is indicated, the MAC entity of the terminal apparatus 1 may allocate one or multiple TBs and related HARQ information received from the physical layer to the HARQ process indicated by the related HARQ information. In a case that downlink assignment is indicated for the broadcast HARQ process, the MAC entity of the terminal apparatus 1 may allocate the received TB to the broadcast HARQ process.

In a case that transmission is performed for the HARQ process, the HARQ information related to one or (case of downlink spatial multiplexing) two TBs may be received from the HARQ entity.

For each of the received TBs and the related HARQ information, in a case that the NDI is provided, and the NDI is toggled in comparison to a value of previously received transmission corresponding to the TB (value of the NDI related to the HPID included in the PDCCH), or the HARQ process corresponds to the broadcast process, and this is the first received transmission for the TB according to system information scheduling indicated by the RRC, or this is genuinely the first received transmission for the TB (in other words, new transmission, with no preceding NDIs (being present) for the TB), the HARQ process (HARQ process related to a certain HPID) considers that the transmission is new transmission. Otherwise, the HARQ process considers that the transmission is retransmission. Note that the previously received transmission may refer to transmission received in the past. Here, the transmission may refer to the TB transmitted from the base station apparatus 3.

In a case that this (received TB) is new transmission, the MAC entity attempts to decode received data (data for the received TB). In a case that this is retransmission and the data for the TB has not yet been successfully decoded, the MAC entity indicates, to the physical layer, concatenation of the latest data in a soft buffer for the TB and the received data and decoding of the concatenated data. In a case that the data that the MAC entity has attempted to decode is successfully decoded for the TB, or the data for the TB has been successfully decoded before, and the HARQ process is the same as the broadcast process, the MAC entity transfers the decoded MAC PDU to a higher layer (the RLC layer, the PDCP layer, and/or the RRC layer). In a case that this is the first successful decoding of the data for the TB, the MAC entity transfers the decoded MAC PDU to a deassembly and demultiplexing entity. Otherwise, the MAC entity indicates, to the physical layer, switching between the data that the MAC entity has attempted to decode and the data in the soft buffer for the TB. In a case that the HARQ process is related to transmission indicated with a TC-RNTI, and contention resolution has not yet succeeded, the HARQ process corresponds to the broadcast process, or timeAlignmentTimer that is related to the TAG including the serving cell in which the HARQ feedback is transmitted stops or expires, the MAC entity indicates, to the physical layer, generation of acknowledgement(s) of the data in the TB. Note that the acknowledgement(s) may be ACK(s) or NACK(s).

In the NR-U cell, in a case that the transmission is considered to be retransmission in the HARQ process, and the physical layer of the terminal apparatus 1 indicated to generate acknowledgement(s) of the data in the TB performs the type 1 channel access procedure before transmission of the PUCCH or the PUSCH including the HARQ-ACK, the terminal apparatus 1 and/or the MAC entity of the terminal apparatus 1 may update the value of the CW used for Nᵢₙᵢₜ. In the NR-U cell, in a case that the transmission is considered to be new transmission in the HARQ process, and the physical layer of the terminal apparatus 1 indicated to generate acknowledgement(s) of the data in the TB performs the type 1 channel access procedure before transmission of the PUCCH or the PUSCH including the HARQ-ACK, the terminal apparatus 1 and/or the MAC entity of the terminal apparatus 1 may set the value of the CW used for Nᵢₙᵢₜ to the initial values of CWₚ, or need not update the value of the CW (in other words, may maintain the value of the CW). Note that, in a case that the physical layer of the terminal apparatus 1 performs the type 2 channel access procedure before transmission of the PUCCH or the PUSCH including the HARQ-ACK, the physical layer of the terminal apparatus 1 performs CCA only once before transmission of the PUCCH or the PUSCH including the HARQ-ACK regardless of whether the transmission is new transmission or retransmission, and in a case that the physical layer of the terminal apparatus 1 determines that the NR-U channel is idle, the physical layer of the terminal apparatus 1 may transmit the PUCCH or the PUSCH including the HARQ-ACK.

Here, in a case that there are three types for the configurable allowable values of the CW, namely CW #0, CW #1, and CW #2 (CW #0<CW #1<CW #2), and the value of the CW is CW #0, to update the value of the CW may mean, for example, to update the value of the CW to CW #1 being one higher value. In a case that the value of the CW is CW #1, to update the value of the CW may mean to update the value of the CW to CW #2 being one higher value. In a case that the value of the CW is CW #2 (CWₘₐₓ) and there is no value that is one value higher than the value of the CW, to update the value of the CW may include to set to CW #0 (CWₘᵢₙ) again.

Here, the physical layer may include at least one of a transmitter, a receiver, a radio transmission and/or reception unit, and/or a measuring unit, or may be a physical layer processing unit. The MAC entity may be a MAC layer, or may be a MAC layer processing unit.

In a case that the MAC entity determines that the NDI in the PDCCH for the C-RNTI is toggled in comparison to a value in previous transmission, the MAC entity ignores the NDI received in all of the downlink assignments in the PDCCH for the TC-RNTI.

In a case that the terminal apparatus 1 detects the DCI format used for scheduling of the PDSCH in the NR-U cell in the PDCCH, and the HARQ process ID (HPID) and the NDI are included in the DCI format, the terminal apparatus 1 can determine whether transmission of the PDSCH is new transmission or retransmission, based on whether or not the NDI is toggled for the HPID. In addition, in a case that a field indicating the PUCCH resource is included in the DCI format, whether or not to adjust the value of the CW may be determined based on whether or not the NDI is toggled. For example, in a case that the value of the NDI for the HARQ process related to the first HPID is toggled, the terminal apparatus 1 may set the value of CW, corresponding to each value p of CAPC to CWₘᵢₙ, otherwise (in other words, in a case that the value of the NDI is not toggled), the terminal apparatus 1 may increment the value of CWₚ to one higher allowable value (value of the CW) (in other words, the terminal apparatus 1 may update the value of CWₚ (value of the CW)).

In a case that the terminal apparatus 1 generates a HARQ-ACK codebook for the HARQ process related to one or multiple HPIDs, and the value of the NDI is not toggled for at least one of the HPIDs, the terminal apparatus 1 may update the value of the CW for the type 1 channel access procedure performed before transmission of the PUCCH or the PUSCH including the HARQ-ACK codebook.

In a case that the base station apparatus 3 transmits the PDCCH and the PDSCH including the DCI format used for scheduling of the PDSCH in the NR-U cell, the base station apparatus 3 performs the type 1 channel access procedure before transmission of the PDCCH and the PDSCH, and in a case that the base station apparatus 3 determines that the NR-U channel is idle in all of the CCA slot periods, the base station apparatus 3 may transmit the PDCCH and the PDSCH, whereas in a case that the base station apparatus 3 determines that the NR-U channel is not idle, the base station apparatus 3 may defer transmission of the PDCCH and the PDSCH until the base station apparatus 3 can determine that the NR-U channel is idle in all of the CCA slot periods.

In a case that the base station apparatus 3 fails to successfully receive the PUCCH or the PUSCH including the HARQ-ACK for the PDSCH even after a prescribed period has elapsed after transmitting the PDCCH and the PDSCH, the base station apparatus 3 may retransmit the PDCCH and the PDSCH. In a case that the base station apparatus 3 retransmits the PDCCH and the PDSCH, the base station apparatus 3 transmits the value of the NDI for the HPID without toggling. In other words, by not toggling the value of the NDI for the HPID, the base station apparatus 3 may indicate that the PDSCH is retransmission. In this case, in a case that the base station apparatus 3 performs the type 1 channel access procedure, the base station apparatus 3 may update the value of the CW.

Note that, in a case that the base station apparatus 3 successfully receives the PUCCH or the PUSCH including the HARQ-ACK for the PDSCH corresponding to the HARQ process related to the HPID within a prescribed period after transmitting the PDCCH and the PDSCH, the base station apparatus 3 may reset the value of the CW corresponding to the HARQ process for the HPID to CWₘᵢₙ. In other words, in a case that the base station apparatus 3 performs the channel access procedure before transmission of the PDCCH and the PDSCH in order to toggle the value of the NDI for the HARQ process related to the HPID, the base station apparatus 3 may set the value of the CW to CWₘᵢₙ. Here, in a case that the base station apparatus 3 can manage the HARQ process related to multiple HPIDs, the base station apparatus 3 may perform the channel access procedure and/or the CW adjustment procedure for each of the HPIDs.

In a case that the base station apparatus 3 transmits the PDSCH scheduled by the PDCCH and the PDCCH, and fails to successfully receive the PUCCH or the PUSCH including the HARQ-ACK (in other words, the HARQ-ACK for the HPID corresponding to the PDSCH) corresponding to the PDSCH within a prescribed period (for example, before a prescribed timer expires), the base station apparatus 3 may update the value of the CW for the PDCCH and the PDSCH. Note that, in a case that the base station apparatus 3 successfully receives the PUSCH including the HARQ-ACK for the HPID corresponding to the PDSCH instead of the PUCCH, the base station apparatus 3 need not update the value of the CW for the PDCCH and the PDSCH.

In a case that the base station apparatus 3 and/or the terminal apparatus 1 considers that the HARQ operation of the HARQ process of a certain HPID has succeeded, the base station apparatus 3 and/or the terminal apparatus 1 may set the updated value of the CW to CWₘᵢₙ in relation to the operation.

In a case that the terminal apparatus 1 receives the PDSCH having the same HPID and indicating retransmission after transmitting the HARQ-ACK for the received PDSCH through the PUCCH or the PUSCH or is requested to perform retransmission of the HARQ-ACK for the PDSCH, and performs the type 1 channel access procedure before transmission of the PUCCH including the HARQ-ACK for the PDSCH, the terminal apparatus 1 may update the value of the CW used for Nᵢₙₜ. In other words, in a case that the terminal apparatus 1 performs the type 1 channel access procedure before transmission of the PUCCH including the HARQ-ACK for the PDSCH every time retransmission is indicated for the PDSCH of the same HPID, the terminal apparatus 1 may update the value of the CW used for corresponding Nᵢₙᵢₜ.

The SSB and/or the CSI-RS in the NR-U cell may be collectively referred to as an NR-U Discovery Reference Signal (DRS). The NR-U DRS may be detected for the terminal apparatus 1 to confirm whether the NR-U cell is activation or deactivation.

Next, the procedure for reporting the CSI according to the present embodiment will be described.

The time frequency resource that can be used by the terminal apparatus 1 for reporting the CSI may be controlled (configured) by the base station apparatus 3. The CSI may include at least one of a Channel Quality Indicator (CQI), a Precoding Matrix Indicator (PMI), a CSI-RS resource Indicator (CRI), an SS/PBCH Block Resource Indicator (SSBRI), a Layer Indicator (LI), a Rank Indicator (RI), and/or Layer 1—Reference Signal Received Power (L1-RSRP).

For the CQI, the PMI, the CRI, the SSBRI, the LI, the RI, and the LI-RSRP, the terminal apparatus 1 may be configured with N CSI-ReportConfig report settings (N is a value equal to or greater than 1), M CSI-ResourceConfig resource settings (M is a value equal to or greater than 1) and one or two lists of the trigger state by a higher layer (higher layer processing unit) and/or as higher layer parameters. The trigger state may be given by AperiodicTriggerStateList, and/or CSI-SemiPersistentOnPUSCH-TriggerStateList each being a higher layer parameter. Each trigger state in AperiodicTriggerStateList may include a list of one or multiple related CSI-ReportConfigs indicating a resource set ID for a channel and optional interference. Each trigger state in CSI-SemiPersistentOnPUSCH-TriggerStateList may be included in one related CSI-ReportConfig.

In CSI-ResourceConfig, at least one or all of CSI-ResourceConfigId, csi-RS-ResourceSetList, bwp-Id, and/or resourceType may be included. csi-RS-ResourceSetList may be used for selecting either of nzp-CSI-RS-SSB or csi-IM-ResourceSetList. nzp-CSI-RS-SSB may include nzp-CSI-RS-ResourceSetList and/or csi-SSB-ResourceSetList.

Each report setting CSI-ReportConfig is related to one downlink BWP given by CSI-ResourceConfig related to channel measurement, and may include one or multiple parameters for a CSI-related amount reported by the terminal apparatus 1, such as one CSI report band, codebook configuration including codebook subset limitation, behaviors of the time domain, frequency granularity for the CQI and the PMI, measurement limitation configuration, the LI, the LI-RSRP, the CRI, and the SSBRI. Here, the frequency granularity may be the size (for example, the bandwidth or the number of PRBs) of the frequency domain.

The behaviors of CSI-ReportConfig in the time domain is indicated by a higher layer parameter (RRC parameter) reportConfigType, and can be set to ‘aperiodic’, ‘semiPcrsistentOnPUCCH’, ‘semiPcrsistentOnPUSCH’, or ‘periodic’. Periodicity and slot offset (offset of the time domain) configured for the CSI report of periodic, semiPcrsistentOnPUCCH, and semiPersistentOnPUSCH are applied to numerology of an uplink BWP in which transmission of the CSI report is configured. In a case that the PMI/CQI report is a wideband or a subband, reportFreqConfiguration indicates report granularity of the frequency domain including the CSI report band. A timeRestrictionForChannelMeasurements parameter in CSI-ReportConfig may be configured so as to enable limitation of the time domain for one or multiple channel measurements, or timeRestrictionForInterferenceMeasurements may be configured to enable limitation of the time domain for one or multiple interference measurements. CSI-ReportConfig may further include one or multiple configuration parameters for type I CSI or type II CSI and CodebookConfig including one or multiple configurations of group-based report including codebook subset limitation.

Each CSI resource setting CSI-ResourceConfig may include configuration of a list of S CSI resource sets (S is a value equal to or greater than 1) given by the higher layer parameter csi-RS-ResourceSetList. The list may be configured with reference to either one or both of one or multiple NZP CSI-RS resource sets and one or multiple SS/PBCH block sets, or the list may be configured with reference to one or multiple CSI-IM resource sets. Each resource setting is mapped to the DL BWP identified by the higher layer parameter bwp-Id, and all of the CSI resource settings linked to one CSI report setting are located in the same DL BWP.

The behavior of one or multiple CSI-RS resources in the CSI resource setting in the time domain is indicated by the higher layer parameter resourceType, and may be set to aperiodic, periodic, or semi-persistent. For the periodic resource setting and the semi-persistent CSI resource setting, the number of configured CSI-RS resource sets may be limited to S=1. For the periodic resource setting and the semi-persistent CSI resource setting, the configured periodicity and slot offset may be given in numerology of the related DL BWP given by bwp-Id. In a case that the terminal apparatus 1 is configured with multiple CSI-ResourceConfigs that are configured based on the same NZP CSI-RS resource ID, the same behavior in the time domain may be configured for the multiple CSI-ResourceConfigs. All of the CSI resource settings linked to one CSI report setting may have the same behavior in the time domain, the same configuration in the time domain may be performed, or the same parameter in the time domain may be configured.

One or multiple CSI-IM resources for interference measurement, one or multiple NZP CSI-RS resources for interference measurement, and one or multiple NZP CSI-RS resources for channel measurement may be configured by higher layer signaling for one or multiple CSI resource settings for channel measurement and interference measurement.

The terminal apparatus 1 may assume that the one or multiple NZP CSI-RS resources for channel measurement and the one or multiple CSI-IM resources for interference measurement configured for one CSI report are Quasi-CoLocated (QCL) resource-wise in relation to ‘QCL-TypeD’. In a case that one or multiple NZP CSI-RS resources are used for interference measurement, the terminal apparatus 1 may assume that the one or multiple NZP CSI-RS resources for channel measurement, the one or multiple CSI-IM resources for interference measurement, and/or the one or multiple NZP CSI-RS resources for interference measurement configured for one CSI report are Quasi-CoLocated (QCL) in relation to ‘QCL-TypeD’.

The terminal apparatus 1 may calculate one or multiple CSI parameters by assuming a dependency relationship between CSI parameters. LI may be calculated based on a reported CQI, PMI, RI, and CRI. The CQI may be calculated based on a reported PMI. RI, and CRI. The PMI may be calculated based on a reported RI and CRI. The RI may be calculated based on a reported CRI.

Report configuration for the CSI may be configured to aperiodic by using the PUSCH, periodic by using the PUCCH, or semi-persistent by using the PUCCH or a DCI activate PUSCH. The CSI-RS resource may be configured to periodic, semi-persistent, or aperiodic.

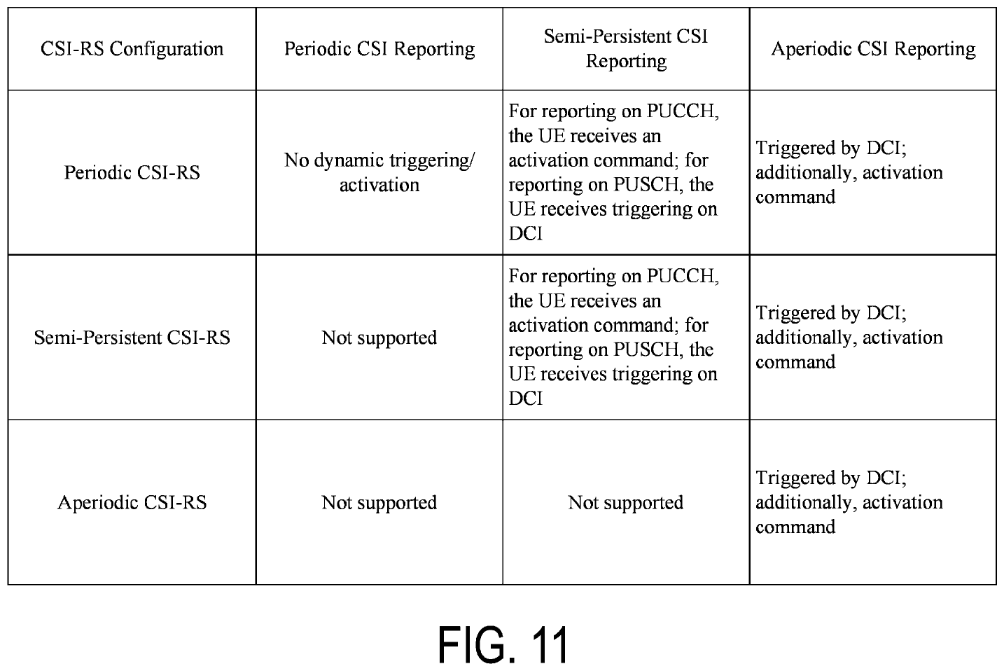

FIG. 11 is a diagram illustrating an example of triggering/activation of the CSI report for possible CSI-RS configurations according to an aspect of the present embodiment. FIG. 11 illustrates supported combinations of one or multiple CSI report configurations and one or multiple CSI-RS resource configurations, and how the CSI report is triggered for each CSI-RS resource configuration. The periodic CSI-RS is configured by a higher layer. The semi-persistent CSI-RS is activated/deactivated by an activation command. The aperiodic CSI-RS is configured by a higher layer, and is triggered/activated by DCI or an activation command.

In a case that the terminal apparatus 1 is configured with a higher layer parameter NZP-CSI-RS-ResourceSet and a higher layer parameter repetition is set to ‘off’, the terminal apparatus 1 may determine one CRI from a supported set of one or multiple CRI values, or may report the number (number, value) in each CRI report. In a case that the higher layer parameter repetition is set to ‘on’, the CRI report need not be supported. In a case that a higher layer parameter codebookType is set to type II′ or ‘type II-PortSelection’, the CRI report need not be supported.

The periodicity measured in one or multiple slots for the periodic CSI report or the semi-persistent CSI report in the PUCCH may be configured by a higher layer parameter reportSlotConfig. Note that the periodic CSI may be referred to as P-CSI. The semi-persistent CSI may be referred to as SP-CSI.

An allowed slot offset for the aperiodic CSI report or the semi-persistent CSI report in the PUSCH may be configured by a higher layer parameter reportSlotOffsetList. The offset may be selected in activating/triggering DCI. Note that the aperiodic CSI may be referred to as A-CSI.

For the CSI report, one of two possible subband sizes may be configured for the terminal apparatus 1 by higher layer signaling. The subband may be defined as N^{SB}_{PRB} PRBs, or may depend on a total number of the PRBs of the BWP.

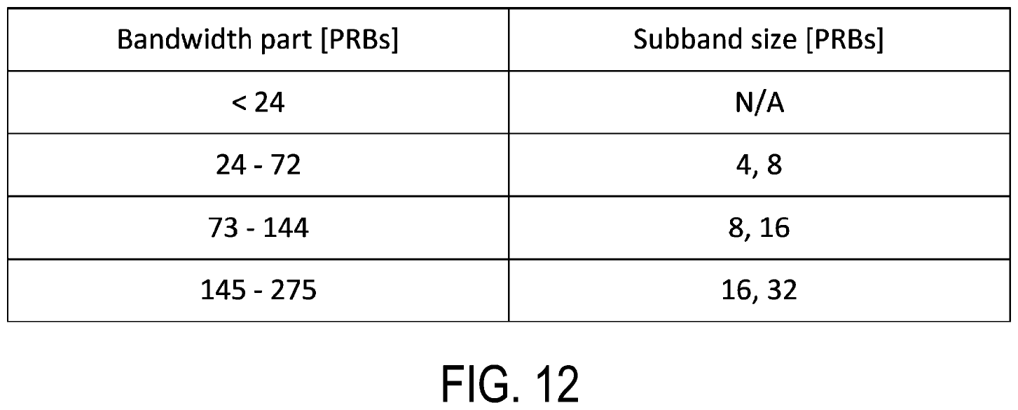

FIG. 12 is a diagram illustrating an example of a configurable subband size according to an aspect of the present embodiment. The subband size may be given to correspond to the bandwidth (the number of PRBs) of the BWP. Either one of two possible subband sizes may be configured by a higher layer parameter subbandSize.

reportFreqConfiguration included in CSI-ReportConfig indicates frequency granularity of the CSI report. CSI report setting configuration may define the CSI report band as a subset of one or multiple subbands of the BWP. reportFreqConfiguration indicates csi-ReportingBand as a contiguous or non-contiguous subset of one or multiple subbands of the BWP in which the CSI is reported. The terminal apparatus 1 need not be expected to be configured with csi-ReportingBand including a subband subband having frequency density of each CSI-RS port for each PRB in the subband smaller than configured density of the CSI-RS resource for the CSI-RS resource linked to the CSI report setting. In a case that the CSI-IM resource is linked to the CSI report setting, the terminal apparatus 1 need not be expected to be configured with csi-ReportingBand including the subband in which no CSI-IM resource element (RE) is present in all of the PRBs in the subband. In other words, in a case that csi-ReportingBand is configured, at least one CSI-IM RE may be present in each subband.

Whether wideband CQI report or subband CQI report is configured is configured by a higher layer parameter eqi-FormatIndicator. In a case that the wideband CQI report is configured, the wideband CQI may be reported to each codeword for the entire CSI report band. In a case that the subband CQI report is configured, one CQI for each codeword may be reported to each subband in the CSI report band.

Whether wideband PMI report or subband PMI report is configured is configured by a higher layer parameter pmi-FormatIndicator. In a case that the wideband PMI report is configured, the wideband PMI may be reported to each codeword for the entire CSI report band. In a case that the subband PMI report is configured, one wideband indication may be reported to the entire CSI report band, and one subband indication may be reported to each subband of the CSI report band, except for two antenna ports. In a case that the two antenna ports are configured for the subband PMI, the PMI may be reported to each subband in the CSI report band.

In a case that any one condition of the following 9A to 9D is satisfied, the CSI report setting may have wideband frequency granularity. In other words, in a case that at least one condition of the following conditions is satisfied, the terminal apparatus 1 may consider that the frequency granularity for the CSI report setting is the wideband.

9A) reportQuantity is set to ‘cri-RI-PMI-CQI’ or ‘cri-RI-LI-PMI-CQI’, eqi-FormatIndicator indicates one CQI report, and pmi-FormatIndicator indicates one PMI report

9B) reportQuantity is set to ‘cri-RI-i1’

9C) reportQuantity is set to ‘cri-RI-CQI’ or ‘cri-RI-i1-CQI’, and cqi-FormatIndicator indicates one CQI report

9D) reportQuantity is set to ‘cri-RSRP’ or ‘ssb-Index-RSRP’ In a case that none of the conditions of 9A to 9D above is satisfied, the CSI report setting may have subband frequency granularity. In other words, the terminal apparatus 1 may consider that the frequency granularity for the CSI report setting is the subband.

In a case that the subband is configured in the CSI report setting, the first subband size may be given based on the subband size corresponding to the bandwidth (the number of PRBs) of the BWP and a start index of the BWP. The last subband size and the first subband size may be given based on the subband size corresponding to the bandwidth (the number of PRBs) of the BWP, a start PRB index of the BWP, and the bandwidth of the BWP.

In a case that the terminal apparatus 1 is configured with the semi-persistent CSI report, and both of the CSI-IM resource and the NZP CSI-RS resource are configured as periodic or semi-persistent, the terminal apparatus 1 may report the CSI. In a case that the terminal apparatus 1 is configured with the aperiodic CSI report, and both of the CSI-IM resource and the NZP CSI-RS resource are configured as periodic, semi-persistent, or aperiodic, the terminal apparatus 1 may report the CSI. One or multiple resources may be configured for each of the CSI-IM resource and the NZP CSI-RS resource.

The terminal apparatus 1 for which DCI format 1_0 is configured need not be expected to be triggered with multiple CSI reports with the same CSI-ReportConfigId.

For the aperiodic CSI, each trigger state configured by using a higher layer parameter CSI-AperiodicTriggerState may be associated with one or multiple CSI-ReportConfigs in which each CSI-ReportConfig is linked to the periodic resource setting, the semi-persistent resource setting, or the aperiodic resource setting. In a case that one resource setting is configured, the resource setting given by a higher layer parameter resourceForChannelMeasurement may be used for the channel measurement for L1-RSRP calculation. In a case that two resource settings are configured, the first resource setting given by the higher layer parameter resourceForChannelMeasurement may be used for channel measurement, and the second resource setting given by a higher layer parameter csi-IM-ResourcesForInterference or a higher layer parameter nzp-CSI-RS-ResourcesForInterference may be used for interference measurement performed in the CSI-IM (one or multiple CSI-IM resources) or the NZP CSI-RS (one or multiple Non Zero Power CSI-RSs). In a case that three resource settings are configured, the first resource setting given by the higher layer parameter resourceForChannelMeasurement may be used for channel measurement, the second resource setting given by the higher layer parameter csi-IM-ResourcesForInterference may be used for CSI-IM-based interference measurement, and the third resource setting given by the higher layer parameter nzp-CSI-RS-ResourcesForInterference may be used for NZP CSI-RS-based interference measurement.

For the semi-persistent CSI or the periodic CSI, each CSI-ReportConfig may be linked to one or multiple periodic resource settings or semi-persistent resource settings. In a case that one resource setting is configured, the resource setting given by the higher layer parameter resourceForChannelMeasurement may be used for the channel measurement for L1-RSRP calculation. In a case that two resource settings are configured, the first resource setting given by the higher layer parameter resourceForChannelMeasurement may be used for channel measurement, and the second resource setting given by the higher layer parameter csi-IM-ResourcesForInterference may be used for interference measurement performed in the CSI-IM (one or multiple CSI-IM resources).

The terminal apparatus 1 is not expected to be configured with more than one CSI-RS resource in the resource set for channel measurement for one CSI-ReportConfig including the higher layer parameter codebookType set to ‘type II’ or ‘type II-PortSelection’.

The terminal apparatus 1 is not expected to be configured with more than 64 NZP CSI-RS resources in the resource set for channel measurement for one CSI-ReportConfig including the higher layer parameter codebookType set to ‘none’, ‘eri-RI-CQI’, ‘cri-RSRP’, or ‘ssb-Index-RSRP’.

In a case that interference measurement is performed in the CSI-IM, each CSI-RS resource for channel measurement may be related resource-wise to the CSI-IM resource according to numbering of the CSI-RS resources and the CSI-IM resources in one or multiple corresponding resource sets. The number of the CSI-RS resources for channel measurement may be the same as the number of CSI-IM resources.

In a case that interference measurement is performed in the NZP CSI-RS, the terminal apparatus 1 need not expect that more than one NZP CSI-RS resource is configured in the related resource set in the resource setting for channel measurement. The terminal apparatus 1 for which the higher layer parameter nzp-CSI-RS-ResourcesForInterference is configured may expect that not more than 18 CSI-RS ports are configured in the NZP CSI-RS resource set.

For CSI measurement, regarding the terminal apparatus 1, each NZP CSI-RS port configured for interference measurement corresponds to an interference transmission layer, and all of the interference transmission layers in one or multiple NZP CSI-RS ports for interference measurement may assume other interference signals in one or multiple REs of the NZP CSI-RS resources for channel measurement, the NZP CSI-RS resources for interference measurement, or the CSI-IM resources for interference measurement in consideration of related Energy Per Resource Element (EPRE) ratio.

Here, the CSI measurement may be measurement of the CSI-RS resources to calculate CSI. The CSI measurement includes channel measurement and interference measurement. The channel measurement may be performed by using NZP CSI-RS resources. The interference measurement may be performed by using CSI-IM resources and/or NZP CSI-RS resources and/or ZP CSI-RS resources.

The terminal apparatus 1 may be configured with one or multiple NZP CSI-RS resource set configurations, as indicated by the higher layer parameters CSI-ResourceConfig and NZP-CSI-RS-ResourceSet. Each NZP CSI-RS resource set may include K (K is a value equal to or greater than 1) NZP CSI-RS resources.

In a case that a part or all of the parameters of the following 10A to 10M are configured, the terminal apparatus 1 assumes non-zero transmission power (in other words, NZP CSI-RS resources) for the CSI-RS resources. The NZP CSI-RS resources may be configured by the higher layer parameters NZP-CSI-RS-Resource, CSI-ResourceConfig, and NZP-CSI-RS-ResourceSet for each CSI-RS resource configuration.

10A) nzp-CSI-RS-ResourceId

10B) periodicityAndOffset

10C) resourceMapping

10D) nrofPorts

10E) density

10F) cdm-Type

10G) powerControlOffset

10H) powerControlOffsetSS

10I) scramblingID

10J) bwp-Id

10K) repetition

10L) qcl-InfoPeriodicCSI-RS

10M) trs-Info

For all of the CSI-RS resources in one set, the same value of 10E and the same value of 10D may be configured, except for a case that the NZP CSI-RS resources are used for interference measurement.

10A above may be used for determining the ID of CSI-RS resource configuration.

10B above may be used for defining periodicity of the CSI-RS and the slot offset for the P-CSI and/or the SP-CSI.

10C above may be used for defining the number of ports of the CSI-RS resources in the slot, a CDM type, an OFDM symbol, and a subcarrier occupancy rate.

10D above is a parameter included in 10C above, and may be used for defining the number of CSI-RS ports.

10E above is a parameter included in 10C above, and may be used for defining CSI-RS frequency density of each CSI-RS port for each PRB. In a case that the value of 10E is ½, this may be used for defining a PRB offset as well. Odd-number/even-number PRB mapping indicated by 10E may be related to a common resource block grid.

10F above is a parameter included in 10C above, and may be used for defining a CDM value and a pattern.

10G above may be an assumed ratio between a PDSCH EPRE and an NZP CSI-RS EPRE in a case that the terminal apparatus 1 derives the CSI report (CSI feedback).

10H above may be an assumed ratio between an SS/PBCH block EPRE and an NZP CSI-RS EPRE.

10I above is used for defining a scrambling ID of the CSI-RS, and may have a length of 10 bits.

10J above is a parameter included in CSI-ResourceConfig, and may be used for defining the BWP in which the configured CSI-RS is mapped.

10K above is a parameter included in NZP-CSI-RS-ResourceSet, and may be associated with one CSI-RS resource set. 10K above may be used for defining whether the terminal apparatus 1 can assume that one or multiple CSI-RS resources in the NZP CSI-RS resource set are transmitted by using the same downlink spatial domain transmission filter. 10K above may be configured only in a case that the higher layer parameter reportQuantity related to all of the report settings linked to the CSI-RS resource set is set to ‘cri-RSRP’ or ‘none’.

10L above may include reference to TCI-State indicating one or multiple QCL source RSs and QCL types. In a case that reference to the RS with ‘QCL-TypeD’ relation is configured for TCI-State, the RS may be the SS/PBCH block mapped to the same or different CC/DL BWP, or may be the CSI-RS resource mapped to the same or different CC/DL BWP and configured as periodic.

10M above is a parameter included in NZP-CSI-RS-ResourceSet, and may be associated with the CSI-RS resource set. In 10M above, the terminal apparatus 1 may assume that the antenna ports with the same port index of one or multiple configured CSI-RS resources in NZP-CSI-RS-ResourceSet are the same. In a case that the report setting is not configured, or reportQuantity related to all of the report settings linked to the CSI-RS resource set is set to ‘none’, 10M above may be configured.

The bandwidth (the number of PRBs) and an initial Common Resource Block (CRB) index of the CSI-RS resources in one BWP may be determined in a CSI-FrequencyOccupation IE that is configured by a higher layer parameter freqBand in a CSI-ResourceMapping IE, based respectively on higher layer parameters nrofRBs and startingRB.

nrofRBs and startingRB may include integer multiples of 4 RBs. A reference point of startingRB may be CRB0 of the common resource block grid. In a case that startingRB is a value smaller than N^{start}_{RB}, the terminal apparatus 1 may assume that an initial CRB index N_{initialRB} of the CSI-RS resources is a value the same as N^{start}_{RB}. Otherwise, N_{initialRB} may be a value the same as startingRB.

The value of nrofRBs need not match the bandwidth of the carrier or the bandwidth of the BWP, or may be configured to be the same value. StartingRB may be configured to be a value the same as the PRB index 0 (start PRB index) of the carrier, may be configured to be a value the same as PRB index 0 of a certain BWP, or may be configured independently of those. Note that the value of nrofRBs may be indicated as a bandwidth of the CSI report band. The value of startingRB may indicate a start position of the CSI report band in the frequency domain. Based on nrofRBs and startingRB, mapping of the CSI-RS in the frequency domain may be indicated.

In a case that nrofRBs is a value larger than N^{size}_{BWP}+N^{start}_{RB}-N_{initialRB}, the terminal apparatus 1 may assume that a bandwidth N^{BW}_{CSI-RS} of the CSI-RS resources is a value the same as N^{size}_{BWP}+N^{start}_{RB}-N_{initialRB}. Otherwise, N^{BW}_{CSI-RS} may be the same value as nrofRBs. Note that, in all of the cases, the terminal apparatus 1 may expect that N^{BW}_{CSI-RS} reaches a value the same as or a value larger than the smaller value of 24 PRBs and N^{size}_{BWP} PRBs.

The terminal apparatus 1 may be configured with one or multiple CSI-IM resource set configurations indicated by the higher layer parameter csi-IM-ResourceSet. Each CSI-RS resource set may include K (K is a value equal to or greater than 1) CSI-IM resources.

The following parameters may be configured for each CSI-IM resource configuration by using the higher layer parameter csi-IM-Resource.

11A) csi-IM-ResourceId

11B) subcarrierLocation-p0

11C) subcarrierLocation-p1

11D) symbolLocation-p0

11E) symbolLocation-p1

11F) periodicityAndOffset

11G) freqBand

In each of one or multiple PRBs configured by 11G above, the terminal apparatus 1 may assume that at least one CSI-IM resource is mapped. Note that 11G may be CSI-FrequencyOccupation.

11A above may be used for determining the ID of CSI-IM resource configuration.

11B above or 11C above may be used for defining the subcarrier occupancy rate of the CSI-IM resources in the slot for csi-IM-ResourceElementPattern set to ‘pattern0’ or ‘pattern1’.

11D above or 11E above may be used for defining OFDM symbol mapping of the CSI-IM resources in the slot for csi-IM-ResourceElementPattern set to ‘pattern0’ or ‘pattern1’.

11F above may be used for defining the periodicity of the CSI-IM and the slot offset for periodic and/or semi-persistent CSI-IM.

11G above may include a parameter for performing configuration of the frequency occupancy rate of the CSI-IM.

For each activated serving cell in which the BWP is configured, in a case that the BWP (the DL BWP and/or the UL BWP) is activated, the MAC entity of the terminal apparatus 1 may perform at least a part or all of the following 12A to 12H.

12A) Transmission on the UL-SCH in the BWP

12B) Transmission on the RACH in the BWP in a case that a PRACH occasion is configured

12C) Monitoring of the PDCCH in the BWP

12D) Transmission of the PUCCH in the BWP in a case of being configured

12E) Report of the CSI for the BWP

12F) Transmission of the SRS in the BWP in a case of being configured

12G) Reception of the DL-SCH in the BWP

12H) Start or restart of a deferred and configured uplink grant of configured grant type I in an active BWP according to retained configuration, and start in a symbol based on a prescribed rule

In a case that the BWP (the DL BWP and/or the UL BWP) is deactivated, the MAC entity of the terminal apparatus 1 need not perform at least a part or all of 12A to 12H above, or may perform either one or both of the following 12I and 12J.

12I) Clearing of any one of a configured downlink assignment and a configured uplink grant of configured grant type 2 in the BWP

12J) Deferring of any one configured uplink grant of configured grant type 1 in an inactive BWP

The terminal apparatus 1 may be configured with CSI-ReportConfig with the higher layer parameter reportQuantity set to at least one of ‘none’, ‘cri-RI-PMI-CQI’, ‘cri-RI-ia’, ‘cri-RI-i1-CQI’, ‘cri-RI-CQI’, ‘cri-RSRP’, ‘ssb-Index-RSRP’, and/or ‘cri-RI-LI-RMI-CQI’.

In a case that the terminal apparatus 1 is configured with CSI-ReportConfig with the higher layer parameter reportQuantity set to ‘none’, the terminal apparatus 1 need not report any quantity for CSI-ReportConfig.

In a case that the terminal apparatus 1 is configured with CSI-ReportConfig with the higher layer parameter reportQuantity set to ‘cri-RI-PMI-CQI’ or ‘cri-RI-LI-RMI-CQI’, the terminal apparatus 1 may report a desirable precoding matrix for the entire report band and/or a desirable precoding matrix for each subband.

In a case that the terminal apparatus 1 is configured with CSI-ReportConfig with the higher layer parameter reportQuantity set to ‘cri-RI-i1’, the terminal apparatus 1 may expect that codebookType set to ‘TypeI-SinglePanel’ and pmi-FormatIndicator configured for the wideband PMI report are configured for the CSI-ReportConfig, or the terminal apparatus 1 may report one PMI constituting one wideband indication (for example, i₁) for the entire CSI report band.

In a case that the terminal apparatus 1 is configured with CSI-ReportConfig with the higher layer parameter reportQuantity set to ‘cri-RI-i1-CQI’, the terminal apparatus 1 may expect that codebookType set to ‘TypeI-SinglePanel’ and pmi-FormatIndicator configured for the wideband PMI report are configured for the CSI-ReportConfig, or the terminal apparatus 1 may report one PMI constituting one wideband indication (for example, it) for the entire CSI report band. In this case, the CQI may be calculated based on reported i₁ assuming PDSCH transmission with Nₚ (Nₚ is a value equal to or greater than 1) precoders. For the terminal apparatus 1, one precoder may be selected at random out of Nₚ precoders for each Precoding Resource block Group (PRG) of the PDSCH. The PRG size for CQI calculation may be configured by a higher layer parameter pdsch-BundleSizeForCSI.

In a case that the terminal apparatus 1 is configured with CSI-ReportConfig with the higher layer parameter reportQuantity set to ‘cri-RI-CQI’, and the terminal apparatus 1 is configured with a higher layer parameter non-PMI-PortIndication included in one CSI-ReportConfig, r ports (r is a value equal to or greater than 1) may be indicated in the order of layer ordering for a rank r, and each CSI-RS resource in the CSI resource setting may be linked to CSI-ReportConfig, based on the order of related nzp-CSI-RS-ResourceId in the linked CSI resource setting for channel measurement given by a higher layer parameter resourcesForChannelMeasurement. The configured higher layer parameter non-PMI-PortIndication may include a sequence p⁽¹⁾₀, p⁽²⁾₀, p⁽²⁾₁, p⁽³⁾₀, p⁽³⁾₁, p⁽³⁾₂, . . . , p^{(R)}₀, p^{(R)}₁, . . . p^{(R)}_{R-1}, of one or multiple port indexes. p^{(v)}₀, . . . , p^{(v)}ᵥ₋₁ may be one or multiple CSI-RS port indexes related to a rank v, and R∈{1, 2, . . . , P} may be satisfied. P∈{1, 2, 4, 8} may be the number of ports of the CSI-RS resources. The terminal apparatus 1 may only report the RI corresponding to one or multiple configured fields of PortIndexFor8Ranks. In a case that the terminal apparatus 1 is not configured with the higher layer parameter non-PMI-PortIndication, for each CSI-RS resource in the CSI resource setting linked to CSI-ReportConfig, regarding the terminal apparatus 1, one or multiple CSI-RS port indexes p^{(v)}₀, . . . , p^{(v)}ᵥ₋₁ being {0, . . . , v−1} may be related to one or multiple ranks v=1, 2, . . . , P. In calculation of the CQI for the rank, the terminal apparatus 1 may use one or multiple ports indicated for the rank for the selected CSI-RS resource. It may be assumed that the precoder for one or multiple indicated ports is an identifier matrix scaled by a value (for example, 1/√(v)) obtained by v.

In a case that the terminal apparatus 1 is configured with CSI-ReportConfig with the higher layer parameter reportQuantity set to ‘cri-RSRP’ or ‘ssb-Index-RSRP’, and the terminal apparatus 1 is further configured with a higher layer parameter groupBasedBeamReporting set to ‘disabled’, the terminal apparatus 1 need not update measurement for more than 64 CSI-RS resources and/or SSB resources. In one report, for each report setting, the terminal apparatus 1 may report nrofRcportedRS different CRIs or SSBRIs. In this case, in a case that the terminal apparatus 1 is further configured with the higher layer parameter groupBasedBeamReporting set to ‘enabled’, the terminal apparatus 1 need not update measurement for more than 64 CSI-RS resources and/or SSB resources. In one report period, for each report setting, the terminal apparatus 1 may report two different CRIs or SSBRIs. One or multiple CSI-RS resources and/or one or multiple SSB resources may be simultaneously received by the terminal apparatus 1 by using one spatial domain reception filter or multiple simultaneous spatial domain filters.

Here, “different” may include meaning of “independent”, “individually configured/calculated”, or “that can be identified”.

In a case that the terminal apparatus 1 is configured with CSI-ReportConfig with the higher layer parameter reportQuantity set to ‘cri-RSRP’, ‘cri-RI-PMI-CQI’, ‘eri-RI-i1’, ‘cri-RI-i1-CQI’, ‘cri-RI-CQI’, and/or ‘cri-RI-LI-RMI-CQI’, and K_{S} resources (K_{S} is a value greater than 1) include nzp-CSI-RS-ResourceSet corresponding to channel measurement, the terminal apparatus 1 may derive the CSI parameters other than the CRI, based on the reported CRI. In a case that CRIk (k is a value equal to or greater than 1) is configured as the configured (k+1)-th entry of related nzp-CSI-RS-Resource of nzp-CSI-RS-ResourceSet corresponding to channel measurement and/or a higher layer parameter, CRIk may correspond to the (k+1)-th entry of related csi-IM-Resource in corresponding csi-IM-ResourceSet. In a case that the CSI-RS resources with K_{S} being 2 are configured, each resource may include at most 16 CSI-RS ports. In a case that the CSI-RS resources with K_{S} being larger than 2 and up to 8 are configured, each resource may include at most 8 CSI-RS ports.

In a case that the terminal apparatus 1 is configured with CSI-ReportConfig with the higher layer parameter reportQuantity set to ‘cri-RI-PMI-CQI’, ‘cri-RI-i1’, ‘cri-R_I-i1-CQI’, ‘cri-RI-CQI’, and/or ‘cri-RI-LI-RMI-CQI’, the terminal apparatus 1 need not be expected to be configured with more than 8 CSI-RS resources in one CSI-RS resource set included in the resource setting linked to CSI-ReportConfig.

In a case that the terminal apparatus 1 is configured with CSI-ReportConfig with the higher layer parameter reportQuantity set to ‘cri-RSRP’ or ‘none’, and CSI-ReportConfig is linked to the resource setting configured for the higher layer parameter resourceType set to ‘aperiodic’, the terminal apparatus 1 need not be expected to be configured with more than 16 CSI-RS resources in one CSI-RS resource set included in the resource setting.

LI indicates correspondence to the strongest layer of the codeword corresponding to the reported wideband CQI having the largest colon of the precoder matrix of the reported PMI. In a case that two wideband CQIs are reported and they have the same value, LI may correspond to the strongest layer of the first codeword.

In a case that ‘QCL-TypeC’ and ‘QCL-TypeD’ are QCL resource-wise for L1-RSRP calculation, the terminal apparatus 1 may be configured with both of one or multiple CSI-RS resources, one or multiple SS/PBCH block resources, or one or multiple CSI-RS resources, and one or multiple SS/PBCH block resources. The CSI-RS resource setting of up to 16 CSI-RS resource sets having up to 64 resources in each set may be configured. In other words, the base station apparatus 3 does not perform such configuration. A total number of CSI-RS resources different in all the resource sets need not be configured to be more than 128. In other words, the terminal apparatus 1 need not be expected to be configured with more than 128 regarding the CSI-RS resources. In other words, the base station apparatus 3 does not configure more than 128 regarding the CSI-RS resources.

The configurable number (upper limit value) of CSI-RS resources may change according to one or multiple prescribed conditions.

CSI-ReportConfig may include at least a part or all of parameters of the following 13A to 13P.

13A) reportConfigId

13B) carrier

13C) resourcesForChannelMeasurement

13D) csi-IM-ResourcesForInterference

13E) nzp-CSI-RS-ResourceForInterference

13F) reportConfigType

13G) reportQuantity

13H) reportFreqConfiguration

13I) timeRestrictionForChannelMeasurements

13J) timeRestrictionForInterferenceMeasurements

13K) codebookConfig

13L) groupBasedBeamReporting

13M) eqi-Table

13N) subbandSize

13O) non-PMI-PortIndication

13P) semiPersistentOnPUSCH

In 13B, a serving cell index may be configured. In 13H, cqi-FormatIndicator, pmi-FormatIndicator, and/or csi-ReportingBand described above may be included.

A CSI reference resource for a certain serving cell may be defined based on at least a part or all of the following 14A to 14B.

14A) In the frequency domain, the CSI reference resource may be defined by a group of one or multiple downlink PRBs corresponding to a band to which a derived CSI is related.

14B) In the time domain, the CSI reference resource for the CSI report in uplink slot n′ may be defined by one downlink slot n-n_{CSI_ref}.

The downlink slot n may be determined based on the uplink slot n′ and a floor function of μ_{DL} and ρ_{UL}. μ_{DL} may be downlink SCS configuration, and μ_{UL} may be uplink SCS configuration.

For P-CSI report and/or SP-CSI report, in a case that one CSI reference resource is configured for channel measurement and n_{CSI_ref} corresponds to a valid downlink slot, n_{CSI_ref} may be 4*2\hat{ }μ_{DL} or a value equal to or greater than a value of 4*2\hat{ }μ_{UL}. In a case that multiple CSI reference resources are configured for channel measurement and n_{CSI_ref} corresponds to a valid downlink slot, n_{CSI_ref} may be a value equal to or greater than a value of 5*2\hat{ }μ_{DL}.

For A-CSI report, in a case that the terminal apparatus 1 is indicated by DCI (CSI request field) for reporting the CSI in the same slot as the CSI request, n_{CSI_ref} may be within the same valid downlink slot as the CSI request to which the reference resource corresponds, otherwise, in a case that slot n-n_{CSI_ref} corresponds to the valid downlink slot, n_{CSI_ref} may be a value equal to or greater than a prescribed value. The prescribed value may satisfy a delay request condition.

In a case that periodic and/or semi-persistent CSI-RS and/or CSI-IM or SSB is used for channel measurement and/or interference measurement, the terminal apparatus 1 need not be expected to measure a channel and/or interference in the CSI-RS/CSI-IM/SSB whose last OFDM symbol is received up to symbols in consideration of the delay request condition before transmission time of the first OFDM symbol of the A-CSI report.

A slot in the serving cell may be a valid downlink slot in a case that it configures a downlink or flexible symbol including at least one higher layer, and it does not fall within a measurement gap for the terminal apparatus 1.

In a case that there is no valid downlink slot for the CSI reference resource corresponding to CSI report setting in a certain serving cell, the CSI report may be omitted for the serving cell in the uplink slot n′ (need not be transmitted, need not be included in the CSI report).

The terminal apparatus 1 may transmit (report) the CSI report only after reception of the CSI-RS/CSI-IM in at least one of one or multiple CSI-RS transmission occasions for channel measurement and/or one or multiple CSI-IM occasions for interference measurement at or after the CSI reference resource after serving cell activation, BWP change, or activation of the SP-CSI for CSI report (re-)configuration (for which CSI-ReportConfig is configured). Otherwise, the report may be dropped.

In a case that DRX is configured, the terminal apparatus may transmit (report) the CSI report only after reception of the CSI-RS/CSI-IM in at least one of one or multiple CSI-RS transmission occasions for channel measurement and/or one or multiple CSI-IM occasions for interference measurement in DRX active time at or after the CSI reference resource. Otherwise, the report may be dropped.

In a case that the CSI feedbank is derived, the terminal apparatus 1 need not be described that at least one CSI-RS resource for channel measurement overlaps with the CSI-IM resource for interference measurement or the NZP CSI-RS resource for interference measurement.

In a case of being configured for reporting a CQI index, and further in a case of being configured, for deriving the CQI index, for deriving the PMI and the RI, in the CSI reference resource, the terminal apparatus 1 may assume at least a part or all of the following 15A to 15N.

15A) The first two OFDM symbols are occupied by control signaling (PDCCH, CORESET).

15B) The number of the PDSCH and DMRS symbols is 12.

15C) The same BWP SCS as the PDSCH reception is configured.

15D) The bandwidth is configured for a corresponding CQI report.

15E) In the reference resource, the CP length and SCS configured for PDSCH reception are used.

15F) There are no REs used for the PSS, the SSS, and the PBCH.

15G) The value of RV is 0.

15H) The ratio between the PDSCH EPRE and the CSI-RS EPRE is given based on a prescribed rule.

15I) There are no REs mapped for the NZP CSI-RS and the ZP CSI-RS.

15J) The same number of front loaded DM-RS symbols as the maximum front loaded symbol configured by a higher layer parameter maxLength in DMRS-DownlinkConfig is assumed.

15K) The same number of additional DM-RS symbols as the additional symbols configured by a higher layer parameter dmrs-AdditionalPosition.

15L) The PDSCH symbol does not include the DM-RS.

15M) The PRB bundling size is two PRBs.

15N) For CQI calculation, regarding the terminal apparatus 1, the antenna port of the PDSCH signal and the antenna port of the CSI-RS correspond to each other.

The terminal apparatus 1 may perform the aperiodic CSI report by using the PUSCH of a serving cell c based on successful decoding of DCI format 0_1 for triggering an aperiodic CSI trigger state.

The aperiodic CSI report carried on the PUSCH may support wideband and subband frequency granularity. The aperiodic CSI report carried on the PUSCH may support type I and type II CSI.

The terminal apparatus 1 may perform the semi-persistent CSI report on the PUSCH based on successful decoding of DCI format 0_1 for activating a semi-persistent CSI trigger state. DCI format 0_1 may include the CSI field indicating the semi-persistent CSI trigger state to be activate or deactivate. The semi-persistent CSI report on the PUSCH may support type I and type II CSI with wideband and subband frequency granularity. The PUSCH resource and the MCS may be mapped semi-persistently by the uplink DCI.

The CSI report on the PUSCH may be multiplexed on uplink data on the PUSCH. The CSI report on the PUSCH may further be performed without multiplexing on uplink data from the terminal apparatus 1.

The type I CSI feedback (type I CSI report) may be supported for the CSI report on the PUSCH. The type I wideband and subband CSI may be supported for the CSI report on the PUSCH. The type II CSI may be supported for the CSI report on the PUSCH.

For the type I and type II CSI feedback (type I and type II CSI report) on the PUSCH, the CSI report may include two parts. Part 1 (CSI part 1, part 1 CSI) may have a fixed payload size, and may be used for identifying the number of information bits of part 2 (CSI part 2, part 2 CSI). Part 1 may be completely transmitted before part 2.

For the type I CSI feedback, part 1 may include the RI, the CRI, and/or the CQI for the first codeword. Part 2 may include the PMI, and may include the CQI for the second codeword in a case that the RI is a value larger than 4.

For the type II CSI feedback, part 1 may include the RI, the CQI, and/or indication of the number of non-zero wideband amplitude coefficients for each layer of the type II CSI. Each field of part 1 may be individually encoded. Part 2 may include the PMI of the type II CSI. Part 1 and part 2 may be individually encoded.

The type II CSI report carried on the PUSCH may be calculated independently of any one of the type II CSI reports carried on PUCCH format 3 or 4.

In a case that the higher layer parameter reportQuantity is configured to one of ‘cri-RSRP’ and ‘ssb-Index-RSRP’, the CSI feedback may include one part.

For both of the type I and type II reports that are configured for the PUCCH but are transmitted on the PUSCH, a method of the PUCCH may be used for a method of encoding.

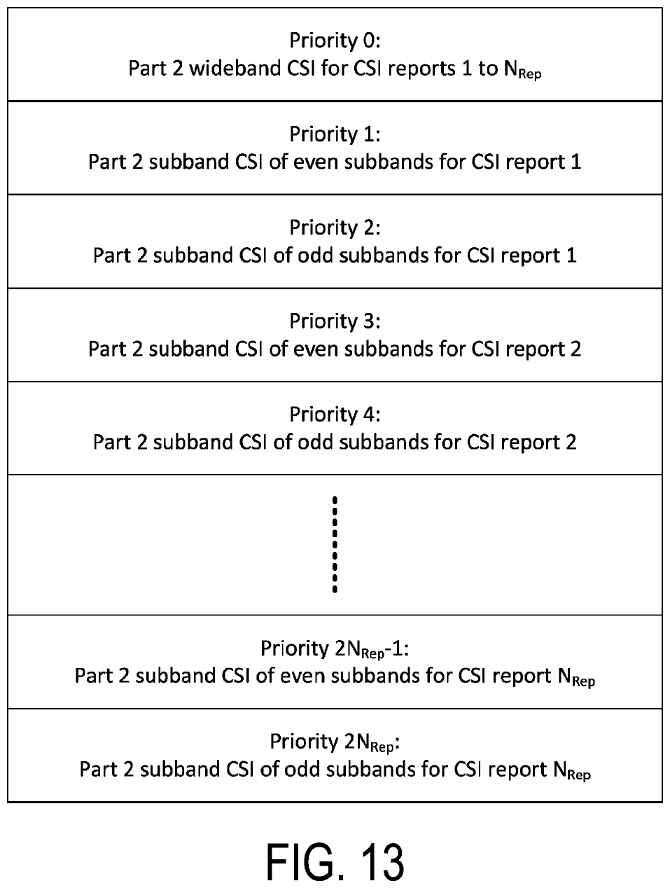

FIG. 13 is a diagram illustrating an example of priority report levels for the part 2 CSI according to an aspect of the present embodiment. In a case that the CSI report on the PUSCH includes two parts, the terminal apparatus 1 may omit a part of the part 2 CSI. The omission of the part 2 CSI may be determined based on FIG. 13. N_{Rep} may be the number of CSI reports configured to be carried on the PUSCH. Priority 0 is the highest priority, and Priority N_{Rep} is the lowest priority. A CSI report n may correspond to the CSI report with the n-th lowest priority (high priority) among the N_{Rep} CSI reports. One or multiple subbands for a certain CSI report n indicated by the higher layer parameter csi-ReportingBand may be ly numbered in ascending order of the subband having the lowest csi-ReportingBand as subband 0. In a case that part 2 CSI information is omitted for a specific priority level, the terminal apparatus 1 may omit all information in the priority level.

In a case that the terminal apparatus 1 is scheduled to transmit the TB on the PUSCH with one or multiple CSI reports, the part 2 CSI may be omitted only in a case that the number of bits that can be mapped to the PUSCH exceeds a prescribed value. The part 2 CSI may be omitted level by level in the order from the part 2 CSI having a low priority level until the number of bits that can be mapped to the PUSCH reaches a value that is the same as or smaller than the prescribed value. In a case of being transmitted on the PUSCH with the part 2 CSI not carrying the TB, omission may be performed in the order from one or multiple bits having a low priority level until the code rate of the part 2 CSI becomes lower than a threshold code rate.

In a case that the terminal apparatus is configured with active semi-persistent CSI report configuration on the PUSCH, CSI direction may be deactivated in a case that the downlink BWP or the uplink BWP is changed. Other activation commands may be required in order to make the semi-persistent CSI report valid.

The terminal apparatus 1 may be semi-statically configured with performing the periodic CSI report on the PUCCH by a higher layer. The terminal apparatus 1 may be configured, by a higher layer, for one or multiple periodic CSI reports corresponding to one or multiple related CSI report settings configured by the higher layer. The periodic CSI report on PUCCH format 2, 3, or 4 may support the type I CSI with the wideband frequency granularity.

The terminal apparatus 1 may perform the semi-persistent CSI report on the PUCCH to which start with slot n+3N^{subframeμ}ₛₗₒₜ+1 is applied after the HARQ-ACK corresponding to the PDSCH carrying a selection command is transmitted on the slot n. The selection command may include one or multiple CSI report settings in which related CSI resource setting is configured. The semi-persistent CSI report on the PUCCH may support the type I CSI. The semi-persistent CSI report on PUCCH format 2 may support the type I CSI with the wideband frequency granularity. The semi-persistent CSI report on PUCCH format 3 or 4 may support the type I CSI and type II CSI part 1 with the wideband and subband frequency granularity.

In a case that the PUCCH carries the type I CSI with the wideband frequency granularity, regardless of the RI and the CRI, the CSI payload carried on PUCCH format 2 and PUCCH format 3 or 4 may be identified and may be the same. For a type I CSI subband report on PUCCH format 3 or 4, the payload may be separated into two parts. The first part may include the RI, the CRI, and/or the CQI for the first codeword. The second part may include the PMI, and may include the CQI for the second codeword in a case that the value of the RI is larger than 4.

Although a semi-persistent report carried on PUCCH format 3 or 4 supports the type II CSI feedback, only part 1 of the type II CSI feedback may be supported. Supporting the type II CSI report on PUCCH format 3 or 4 may be determined based on capability information of the terminal apparatus 1. The type II CSI report carried on PUCCH format 3 or 4 may be calculated independently of any of one or multiple type II CSI reports carried on the PUSCH.

In a case that the terminal apparatus 1 is configured with the CSI report on PUCCH format 2, 3, or 4, each PUCCH resource may be configured for each candidate UL BWP.

In a case that the terminal apparatus 1 is configured with active semi-persistent CSI report configuration on the PUCCH, and does not receive a deactivation command, the CSI report may be executed in a case that the BWP that is configured so that the report is executed is an active BWP, otherwise, the CSI report may be deferred.

In a case that the terminal apparatus 1 is configured with PUCCH format 4, the terminal apparatus 1 need not be expected to report the CSI with the payload size larger than 115 bits. In a case that all of the CSI reports include one part for one or multiple CSI reports transmitted on the PUCCH, the terminal apparatus 1 may omit a part of the one or multiple CSI reports. The omission of the CSI may be determined based on a prescribed priority rule. Regarding the CSI report, the CSI having low priority may be continued to be omitted until a CSI report code rate reaches a value the same as or a value lower than a threshold configured by a higher layer parameter maxCodeRate.

In a case that any one of the one or multiple CSI reports includes two parts, the terminal apparatus 1 may omit a part of the part 2 CSI. The omission of the part 2 CSI may be performed similarly to FIG. 13. Regarding the part 2 CSI, the CSI having low priority may be continued to be omitted until a part 2 CSI code rate reaches a value the same as or a value lower than a threshold configured by the higher layer parameter maxCodeRate.

In a case that the semi-persistent CSI report carried on the PUSCH simultaneously overlaps with PUSCH data transmission in one or multiple symbols, and the earliest symbol of these PUSCH channels is not earlier than N₂+d₂ (in other words, prescribed timing, prescribed time interval) after the last symbol of the DCI for scheduling the PUSCH, the CSI report need not be transmitted. Otherwise, a timeline request condition is not satisfied, and thus it may be determined as an error case.

In a case that the terminal apparatus 1 transmits the first PUSCH including one or multiple semi-persistent CSI reports and the second PUSCH including the UL-SCH, and the first PUSCH transmission overlaps with the second PUSCH transmission, the terminal apparatus 1 may transmit the second PUSCH without transmitting the first PUSCH. In a case that at least one of the first PUSCH transmission and the second PUSCH transmission is related to DCI format detection performed by the terminal apparatus 1, the terminal apparatus 1 may expect that the first PUSCH transmission and the second PUSCH transmission satisfy the time condition for the overlapping PUSCH transmissions.

The CSI report procedure described above may be applied in a case that the size of an LBT subband and the size of the BWP are the same in the NR-U cell.

In a case that the size of one LBT subband has a value (number of PRBs, bandwidth) the same as or larger than the BWP size in the serving cell, and the BWP is included in the LBT subband in the frequency domain, that is, in a case that the BWP is present in the LBT subband, and the CSI-RS is indicated as being punctured in the LBT subband, the terminal apparatus 1 need not update the CSI in the BWP, or need not transmit the CSI for subband that has not been updated and/or that has failed to measure (or that has not measured) the CSI-RS as the CSI report.

Here, in the LBT subband, “the CSI-RS is punctured” may mean that the CSI-RS is not transmitted in the frequency domain of a certain LBT subband. For example, it may mean the following: the base station apparatus 3 performs the CAP in each LBT subband before transmitting the SSB and/or the PDCCH, and/or the PDSCH, and/or the CSI-RS, and the base station apparatus 3 does not transmit any downlink signal including the CSI-RS in the LBT subband in which it is not evaluated that the channel is clear in each LBT subband. In other words, the base station apparatus 3 may transmit any downlink signal including the CSI-RS in the LBT subband in which it is determined that the channel is clear. Similarly, the terminal apparatus 1 may transmit any uplink signal in the LBT subband in which it is determined that the channel is clear. The terminal apparatus 1 need not transmit any uplink signal in the LBT subband in which it is determined that the channel is not clear.

The base station apparatus 3 need not expect that a corresponding CSI report is transmitted from the terminal apparatus 1 in the LBT subband indicating that the CSI-RS is punctured.

In a case that a part of the frequency domain of the BWP is included in the LBT subband in the frequency domain, that is, the frequency domain of the BWP and a part of the frequency domain of the LBT subband overlap with each other, and/or one BWP overlaps with multiple LBT subbands, and eqi-FormatIndicator of CSI-ReportConfig for the BWP indicates a wideband CQI, and it is indicated that the CSI-RS is punctured in at least one LBT subband out of the multiple LBT subbands, the terminal apparatus 1 need not update the CQI for the BWP, and need not transmit the CSI including the wideband CQI that has not been updated as the CSI report. In this case, in a case that the cqi-FormatIndicator indicates a subband CQI, the terminal apparatus 1 need not update the subband CQI for each of one or multiple subbands overlapping with one or multiple LBT subbands in which the CSI-RS is punctured, or may transmit the CSI except for one or multiple subband CQIs that have not been updated and/or that have failed to measure the CSI-RS as the CSI report. In other words, the terminal apparatus 1 may calculate and update the subband CQI for each of one or multiple subbands overlapping with one or multiple LBT subbands in which the CSI-RS is not punctured, may transmit the CSI including one or multiple updated subband CQIs as the CSI report, or need not transmit one or multiple subband CQIs that have not been updated and/or that have failed to measure (or that have not measured) the CSI-RS.

In a case that a part of the frequency domain of the BWP is included in the LBT subband in the frequency domain, that is, the frequency domain of the BWP and a part of the frequency domain of the LBT subband overlap with each other, and/or one BWP overlaps with multiple LBT subbands, and pmi-FormatIndicator of CSI-ReportConfig for the BWP indicates a wideband PMI, and it is indicated that the CSI-RS is punctured in at least one LBT subband out of the multiple LBT subbands, the terminal apparatus 1 need not update the PMI for the BWP, and need not transmit the CSI including the wideband PMI that has not been updated as the CSI report. In this case, in a case that the pmi-FormatIndicator indicates a subband PMI, the terminal apparatus 1 need not update the subband PMI for each of one or multiple subbands overlapping with the LBT subband in which the CSI-RS is punctured, or may transmit the CSI except for the subband PMI that has not been updated as the CSI report. In other words, the terminal apparatus 1 may calculate and update the subband PMI for each of one or multiple subbands overlapping with one or multiple LBT subbands in which the CSI-RS is not punctured, may transmit the CSI including one or multiple updated subband PMIs as the CSI report, or need not transmit one or multiple subband PM Is that have not been updated and/or that have failed to measure (or that have not measured) the CSI-RS.

The LBT subband may be configured such that the terminal apparatus 1 and/or the base station apparatus 3 performs LBT (in other words, CCA and/or CAP), and indicates the frequency domain (in other words, a channel, an NR-U carrier, or an NR-U BWP) for determining whether the channel is clear. For example, the size of the LBT subband in the frequency domain may be 20 MHz (in other words, a prescribed value), may be the number of PRBs corresponding to 20 MHz (in other words, the prescribed value), or may be configured as a higher layer parameter. The start RB indicating the start position of the frequency domain used for defining the LBT subband and the bandwidth (the number of PRBs) may be configured as a higher layer parameter. In a case that at least one LBT subband is configured, and uplink transmission and downlink transmission are performed in the same operating band, the frequency domain and the time domain of the LBT subband may be common, and/or common configuration, and/or common recognition between the terminal apparatus 1 and the base station apparatus 3. Note that the LBT subband may be referred to as an LBT carrier (CCA carrier, CAP carrier), an LBT band (CCA band, CAP band), or an LBT-BWP (CCA-BWP, CAP-BWP). In a case that capability of performing LBT by using one or multiple LBT subbands is supported for the base station apparatus 3 and/or the terminal apparatus 1, one or multiple LBT subbands may be configured for one NR-U cell (or one NR-U operating band), based on capability information.

The subband and the wideband used for CSI measurement including CQI measurement and/or PMI measurement (in other words, CSI measurement for performing CQI calculation and/or PMI calculation) may be referred to as a CSI subband and a CSI wideband, respectively. Similarly, the subband and the wideband used for CQI measurement may be referred to as a CQI subband and a CQI wideband, respectively. The subband and the wideband used for PMI measurement may be referred to as a PMI subband and a PMI wideband, respectively. The CSI subband/wideband may be a general term in a case of including either one or both of the CQI subband/wideband and the PMI subband/wideband. Note that the bandwidth (the number of PRBs) of the CSI wideband may be a value the same as the bandwidth configured for the CSI report band. Alternatively, the CSI report band may include one or multiple CSI subbands.

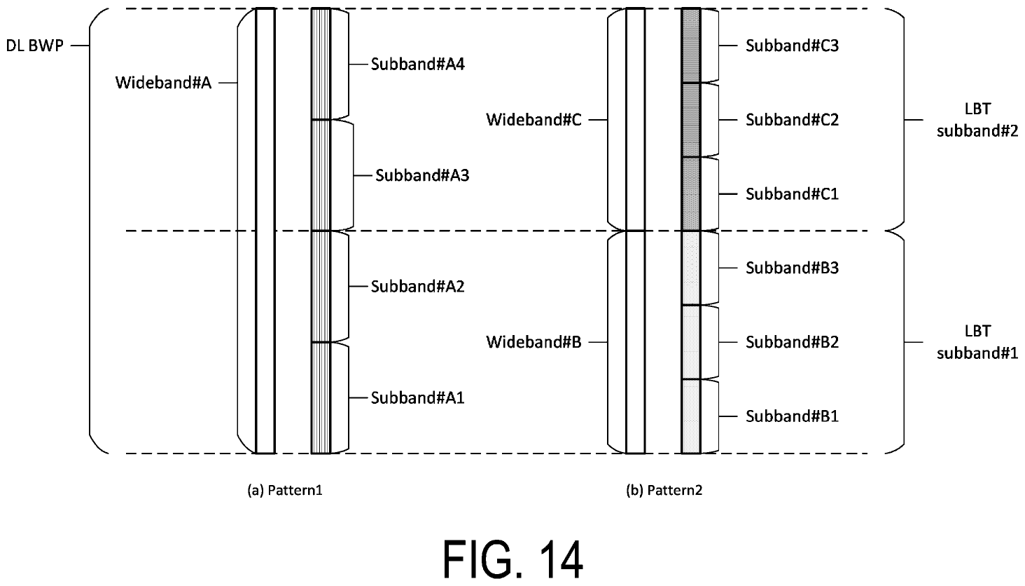

FIG. 14 is a diagram illustrating an example of mapping patterns of the CSI wideband and the CSI subband according to an aspect of the present embodiment. FIG. 14(a) illustrates an example in which the start RB and the bandwidth of the DL BWP and the CSI wideband overlap with each other. FIG. 14(b) illustrates an example in which the start RB and the bandwidth of each LBT subband and each CSI wideband overlap with each other.

The following will give description of a case that, in the terminal apparatus 1 and the base station apparatus 3, for example, successful acquisition of the COT is indicated in both of LBT subband #1 and LBT subband #2 in a case that successful acquisition of the COT can be indicated for each of LBT subband #1 and LBT subband #2 by using DCI format 2_0 (in other words, a case that such capability is supported). In FIG. 14(a), according to one or multiple CSI-ReportConfigs configured for the terminal apparatus 1, the terminal apparatus 1 can update and report the value of each of the wideband CQI and/or the wideband PMI for wideband #A, and can update and report the value of each of the subband CQI and/or the subband PMI for each of subband #A1 to subband #A4. Note that, in a case that the priority rule of the CSI report is applied, the priority of the wideband CSI (CQILPMI) for wideband #A is the highest, and then the priority may become lower in order from subband #A1. In FIG. 14(b), according to one or multiple CSI-ReportConfigs configured for the terminal apparatus 1, the terminal apparatus 1 can update and report the value of the wideband CQI and/or the wideband PMI for each of wideband #B and/or wideband #C, and can update and report the value of each of the subband CQI and the subband PMI for each of subband #B1 to subband #B3 and subband #C1 to subband #C3. Note that, in a case that the priority rule of the CSI report is applied, the priority of the wideband CSI (CQI/PMI) for wideband #B and/or wideband #C is the highest, and then the priority may become lower in order from subband #B1 to subband #C3, and regarding the subband, the priority may become lower in order of subband #B1, subband #C1, subband #B2, subband #C2, . . . , subband #C3. In this case, eqi-FormatIndicator may be the wideband CQI or the subband CQI, and the terminal apparatus 1 can report the CSI of related CSI-ReportConfig regardless of whether pmi-FormatIndicator is the wideband PMI or the subband PMI. The base station apparatus 3 may assume the number of types of the reported CSI and the number of bits for the CSI, based on DCI format 2_0.

In a case that the base station apparatus 3 and/or the terminal apparatus 1 determines that the channel is clear and considers that the LBT has succeeded in the LBT subband, the base station apparatus 3 and/or the terminal apparatus 1 may transmit the physical signal/physical channel in the LBT subband. Note that, by the fact that LBT has succeeded, the base station apparatus 3 and/or the terminal apparatus 1 may determine that the COT has been successfully acquired.

Next, the following will give description of a case that successful acquisition of the COT is indicated in only one of two LBT subbands by using DCI format 2_0 in FIG. 14, for example, a case that the COT is successfully acquired in LBT subband #1 but the COT is not successfully acquired in LBT subband #2. In FIG. 14(a), according to one or multiple CSI-ReportConfigs configured for the terminal apparatus 1, the terminal apparatus 1 need not update or report the value of each of the wideband CQI and/or the wideband PMI for wideband #A. For each of subband #A1 and/or subband #A2, the terminal apparatus 1 may update and report the value of the subband CQI and/or the subband PMI. For each of subband #A3 and subband #A4, the terminal apparatus 1 need not update or report the value of the subband CQI and the subband PMI. In FIG. 14(a), the wideband CQI may be calculated except for the CSI-RS to which LBT subband #2 is mapped. In FIG. 14(b), according to one or multiple CSI-ReportConfigs configured for the terminal apparatus 1, the terminal apparatus 1 may update and report the value of each of the wideband CQI and the wideband PMI for wideband #B. The terminal apparatus 1 need not update or report the value of each of the wideband CQI and/or the wideband PMI for wideband #C. The terminal apparatus 1 may update and report the value of each of the subband CQI and/or the subband PMI for each of subband #B1 to subband #B3. The terminal apparatus 1 need not update or report the value of each of the subband CQI and/or the subband PMI for each of subband #C1 to subband #C3.

In the case of FIG. 14(b), the CSI report band can be configured for each LBT subband, and thus the maximum number of configurations and/or higher layer parameters related to the CSI report, such as the number of CSI-RS resources (NZP CSI-RS resources, and/or CSI-IM resources), and/or the number of CSI-RS resources for each resource set, and/or the number of CSI-RS resource sets, and/or the number of CSI resource configurations, and the number of CSI-ReportConfigs that can be configured for one BWP may be extended.

In the case of FIG. 14(a) and/or FIG. 14(b), an ID for identifying the LBT subband (for example, an LBT subband ID) may be configured as a higher layer parameter. In particular, in the case of FIG. 14(b), the LBT subband ID may be included in CSI-ReportConfig. The base station apparatus 3 may be able to trigger the report of the wideband CSI and/or the subband CSI for each LBT subband.

In interference measurement, as illustrated in FIG. 14(b), in a case that the CSI-IM resources can be configured individually for each LBT subband, and an acquisition state of the COT is indicated for each LBT subband, the terminal apparatus 1 can perform interference measurement in the LBT subband in which the COT is acquired, and report results thereof.

Although FIG. 14 describes a case that two LBT subbands are configured for one BWP, FIG. 14 can also be similarly applied to a case that the number of LBT subbands configured for one BWP is more than two.

In FIG. 14, the guard band may be configured between LBT subband #1 and LBT subband #2. In such a case, in the CSI report band including the guard band, the wideband CQI and the wideband PMI and the subband CQI and the subband PMI may be calculated in consideration of the fact that the CSI-RS is mapped to the guard band.

Note that, in a case that the wideband CQI and/or the wideband PMI is not updated, a related RI and/or CRI need not be updated, or a related RI and/or CRI need not be reported.

In a case that multiple LBT subbands are configured for one BWP, one or multiple NZP-CSI-RS-Resources and/or one or multiple CSI-IM-Resources may be configured for each LBT subband, or one or multiple CSI-ReportConfigs may be configured. In other words, one or multiple CSI-RS resources may be configured so that the wideband CQI/PMI and the subband CQI/PMI can be calculated for each LBT subband, or one or multiple CSI-ReportConfigs may be configured.

Note that the start RB and the bandwidth of the BWP and/or the carrier and/or the serving cell and the start RB and the bandwidth of each CSI report band need not match each other. In other words, each of the start RB and the bandwidth of the BWP and/or the carrier and/or the serving cell and the start RB and the bandwidth of each CSI report band may be individually configured.

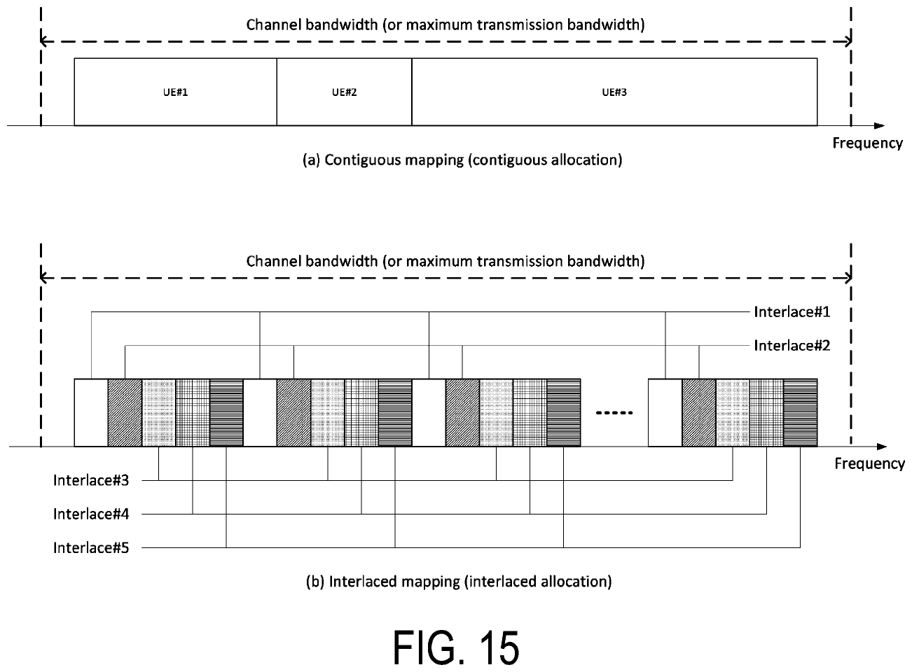

FIG. 15 is a diagram illustrating an example of frequency mapping (resource allocation, mapping to physical resources) according to the present embodiment. FIG. 15(a) is an example (contiguous mapping, localized mapping) in which multiple PRBs are contiguously mapped for one terminal apparatus 1 and/or base station apparatus 3. The frequency mapping of FIG. 15(a) may be used for implementing low Peak to Average Power Ratio (PAPR) characteristics by a single carrier of DFT-s-OFDM signals or the like, for example. FIG. 15(b) is an example (interlaced mapping, distributed mapping) in which multiple PRBs are mapped for one terminal apparatus 1 and/or base station apparatus 3 at regular intervals or at irregular intervals. The frequency mapping of FIG. 15(b) may be used for implementing 80% or more of the transmission bandwidth (maximum transmission bandwidth, channel bandwidth, carrier bandwidth, BWP bandwidth) with a small number of PRBs in the frequency domain. In other words, the frequency mapping of FIG. 15(b) may be performed for satisfying the Occupied Channel Bandwidth (OCB) requirement. The number of interlaces may be determined according to the SCS. For example, in a case that the SCS is 15 kHz, the number of interlaces may be 10 or 11. In a case that the SCS is 30 kHz, the number of interlaces may be 5 or 6. The number of interlaces may be the maximum multiplexing order of the terminal apparatus 1 in the frequency domain. The number of interlaces may be the same number, regardless of the size of the frequency bandwidth. For example, the number of interlaces may be 10 or 11 in a case that the SCS is 15 kHz, regardless of whether the frequency bandwidth is 20 MHz or 40 MHz. Note that the base station apparatus 3 and/or the terminal apparatus 1 can perform transmission of the physical channel and/or the physical signal by using one or multiple interlaces.

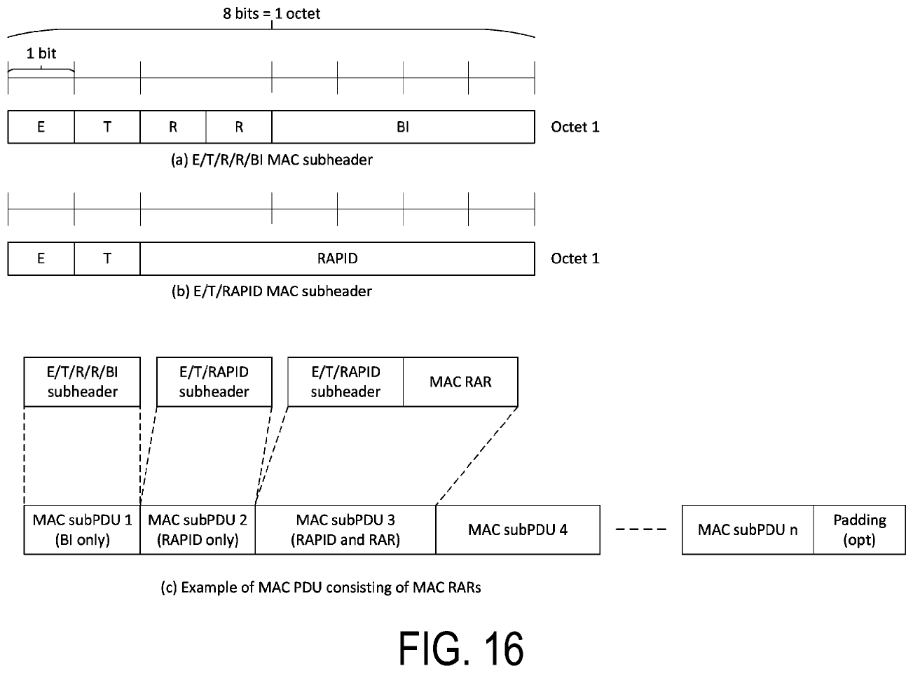

FIG. 16 is a diagram illustrating an example of a configuration of a MAC subheader and the MAC PDU according to the present embodiment. FIG. 16(a) illustrates an example of a configuration of the MAC subheader with a Backoff Indicator (BI). The MAC subheader with the BI may include five header fields, which are E/T/R/R/BI. FIG. 16(b) illustrates an example of a configuration of the MAC subheader with a Random Access Preamble Identifier (RAPID). The MAC subheader with the RAPID may include three header fields, which are E/T/RAPID. FIG. 16(c) illustrates an example of a configuration of the MAC PDU. The MAC PDU may include one or multiple MAC subPDUs, and may include padding optionally. Each MAC subPDU may include one out of the MAC subheader with only the BI, the MAC subheader with only the RAPID, and the MAC subheader with the RAPID and a Random Access Response (MAC RAR). Here, in a case that the MAC subPDU with only the BI is included for the MAC PDU, the MAC subPDU with only the BI may be placed at the beginning of the MAC PDU. In a case that the MAC subPDU and/or padding with only the BI is present in the MAC PDU, each of the MAC subPDU with only the RAPID and the MAC subPDU with the RAPID and the MAC RAR may be placed between the MAC subPDU with only the BI and the padding. In a case that the MAC subPDU and the padding with only the BI are not present in the MAC PDU, each MAC subPDU with the RAPID and the MAC RAR may be freely placed. Note that, in a case that the padding is present in the MAC PDU, the padding may be placed at the end in the MAC PDU. The presence and the length of the padding may be implicitly determined based on the TB size and the size of one or multiple MAC subPDUs.

The Extension (E) field may be a flag indicating whether or not the MAC subPDU including the MAC subheader at least including the E field is the last MAC subPDU in the MAC PDU. For example, the value of the E field may be set to “1” in order to indicate that at least one more MAC subPDU follows. The value of the E field may be set to “0” in order to indicate that the MAC subPDU including the MAC subheader is the last MAC subPDU in the MAC PDU.

The Type (T) field may be a flag indicating whether or not the MAC subheader includes the RAPID or the BI. The value of the T field may be set to “0” in order to indicate the presence of the BI field in the subheader. The value of the T field may be set to “1” in order to indicate the presence of the RAPID field in the subheader. In other words, whether the MAC subPDU is configured by the MAC subheader illustrated in FIG. 16(a) or configured by the MAC subheader illustrated in FIG. 16(b) may be determined based on the value of the T field. Note that MAC subPDU 3 of FIG. 16(c) illustrates an example of including the RAPID and the RAR (MAC RAR). In other words, it illustrates an example of a case that the value of the T field is set to “1”.

The Reserved (R) field is Reserved bits (R bits), and may be set to “0”. Note that, in the present embodiment, the R bits may be set to “0”.

The BI field is used for identifying an overload state in the cell. The size of the BI field may be 4 bits. The value set to the BI field may be used for calculating the back-off time. For example, the back-off time may be calculated by a random number from 0 to the value corresponding to the BI field. In other words, the back-off time may be determined based on the value of the BI field. The BI field may be used for indicating a parameter (Backoff Parameter value (BPV)) related to the back-off time. The BI field may be used for indicating an index corresponding to the BPV (for example, 5 ms, 120 ms, 1920 ms, or the like).

The RAPID field may be used for identifying a transmitted random access preamble (PRACH, Msg1). The RAPID may be 6 bits. In a case that the RAPID in the MAC subheader of the MAC subPDU corresponds to one of the random access preambles configured for the SI request, the MAC RAR need not be included in the MAC subPDU. In other words, in FIG. 16(c), it corresponds to the MAC subPDU with only the RAPID (MAC subPDU 2). In a case that the RAPID in the MAC subheader of the MAC subPDU does not correspond to the random access preamble configured for the SI request, the MAC RAR may be included in the MAC subPDU.

The MAC subheader (the size of the MAC subheader) may be adjusted in an octet unit. One octet may include 8 bits. In other words, the size of the MAC subheader and/or the MAC PDU may be adjusted in an 8-bit unit.

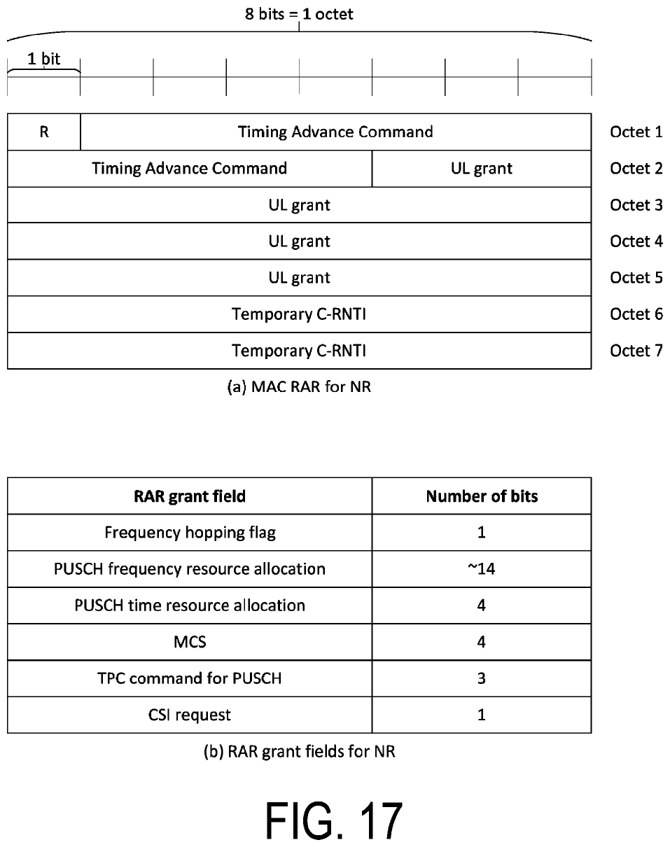

FIG. 17 is a diagram illustrating an example of a configuration of the MAC RAR and RAR grant fields for NR according to the present embodiment. FIG. 17(a) illustrates an example of a configuration of the MAC RAR for NR (NR cell). FIG. 17(b) illustrates an example of a configuration of fields in the RAR grant corresponding to the UL grant in the MAC RAR of FIG. 17(a). The MAC RAR may be referred to as Msg2.

In the present embodiment, “for NR” may mean that it corresponds to at least one of an NR cell (carrier, BWP, channel), an NR terminal apparatus, and an NR base station apparatus. Similarly, “for NR-U” may mean that it corresponds to at least one of an NR-U cell (carrier, BWP, channel), an NR-U terminal apparatus, and an NR-U base station apparatus.

In the MAC RAR of FIG. 17(a), the size of a Timing Advance Command (TAC) field may include 12 bits, the size of an Uplink (UL) grant field may include 27 bits, and the size of a Temporary C-RNTI (TC-RNTI) field may include 16 bits.

The TAC field is used for indicating an index value T_{A} that is used for controlling the amount of timing adjustment applied by the MAC entity. In other words, the TAC field may be used for adjusting transmission timing of the terminal apparatus 1.

The UL grant field is used for indicating resources used in the uplink. The UL grant included in the MAC RAR may be used as the RAR grant illustrated in FIG. 17(b).

In the present embodiment, the UL grant included in the MAC RAR may have meaning similar to the RAR grant.

The TC-RNTI field may be used for indicating a temporary identifier that is used by the MAC entity during random access.

FIG. 17(b) illustrates an example of various fields included in the RAR grant for NR. The RAR grant may be used for scheduling an Msg3 PUSCH in the random access procedure of NR. Note that a total number of bits used in the RAR grant fields in this case may be 27 bits.

A frequency hopping flag (FHF) field of FIG. 17(b) is a field indicating whether or not frequency hopping is applied to the scheduled PUSCH.

A PUSCH frequency resource allocation (PFRA) field of FIG. 17(b) is a field used for indicating the start position of the PUSCH in the frequency domain and the number of resource blocks (or the end position).

Note that the number of bits of the PFRA field may be determined based on the maximum number of PRBs used for uplink transmission (transmission of the PUSCH). For example, in a case that the bandwidth is 20 MHz and the SCS is 15 kHz, the maximum number of PRBs used for uplink transmission may be 106 PRBs, and the number of bits of the PFRA field may be 14 bits. In other words, the number of bits of the PFRA field may be determined based on the maximum number of PRBs that is based on the maximum bandwidth, the SCS, and the maximum bandwidth and the SCS for the uplink. Each of the maximum bandwidth and/or the SCS may be determined based on a higher layer parameter.

A PUSCH time resource allocation (PTRA) field of FIG. 17(b) is a field used for indicating allocation of the scheduled PUSCH in the time domain.

An MCS field of FIG. 17(b) is a field used for indicating the value of the MCS applied to the scheduled PUSCH.

A TPC command for PUSCH field in FIG. 17(b) is a field used for dynamically adjusting transmission power of the scheduled PUSCH.

A CSI request field of FIG. 17(b) is, for example, a field used for requesting transmission of the CSI on the scheduled PUSCH. The CSI request field may be secured as the Reserved bits (R bits) in the CBRA procedure. The CSI request field may be set to the RAR grant in the CFRA procedure.

The configuration of the MAC RAR and the RAR grant illustrated in FIG. 17 may be applied to NR-U as well. Whether or not the MAC RAR and the RAR grant are applied may be determined based on a higher layer parameter.

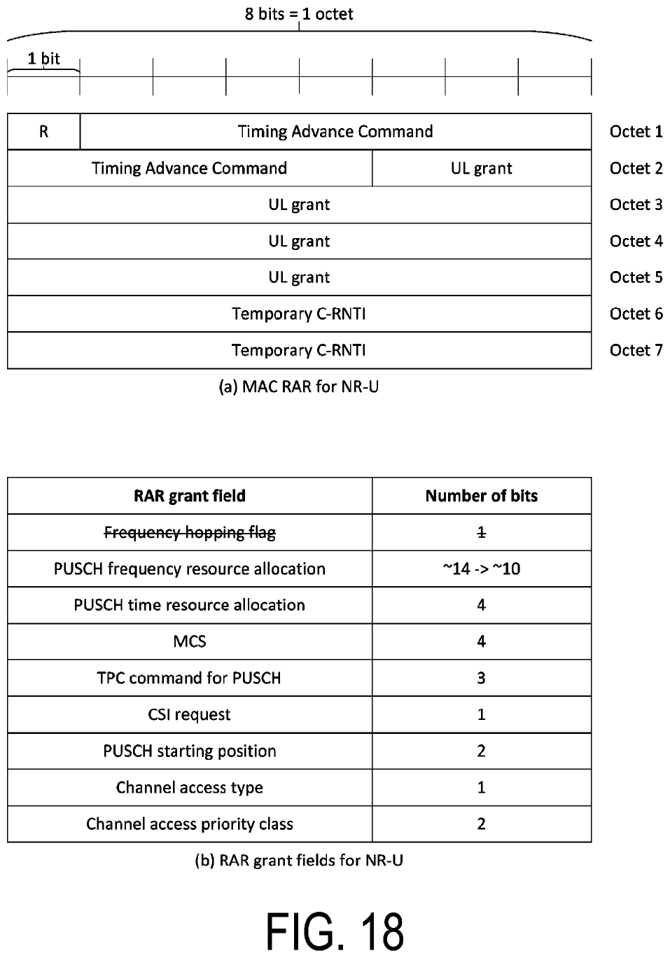

FIG. 18 is a diagram illustrating an example (example 1) of a configuration of the MAC RAR and the RAR grant fields for NR-U according to the present embodiment. FIG. 18(a) illustrates a configuration of the MAC RAR and a MAC payload for NR-U (NR-U cell). FIG. 18(b) illustrates an example of a configuration of fields of the RAR grant corresponding to the UL grant in the MAC RAR of FIG. 18(a).

FIG. 18(a) has the same configuration as FIG. 17(a), and the MAC RAR may include 56 bits (in other words, 7 octets).

FIG. 18(b) illustrates an example of various fields constituting the RAR grant in a case that the number of bits for the UL grant (RAR grant) in the MAC RAR is the same as that of NR. In a case that interlaced allocation is applied to frequency domain resource allocation of the PUSCH scheduled by the RAR grant, frequency characteristics can be sufficiently obtained even in a case that frequency hopping is not performed. Thus, the FHF field need not be set to the RAR grant for NR-U. Here, whether or not the FHF field is set to the RAR grant may be determined based on a higher layer parameter.

In a case that interlaced allocation is applied to frequency domain resource allocation of the PUSCH scheduled by the RAR grant, and the bandwidth is a prescribed value, the number of bits (for example, the maximum of 10 bits) of the PFRA field included in the RAR grant for NR-U may be smaller than the number of bits (for example, the maximum of 14 bits) of the PFRA field included in the RAR grant for NR. In a case that interlaced allocation is applied to frequency domain resource allocation of the PUSCH scheduled by the RAR grant, and the bandwidth is 20 MHz and the SCS is 15 kHz, the number of bits of the PFRA field included in the RAR grant for NR-U may be reduced to 10 bits from 14 bits, which is the number of bits of the PFRA field included in the RAR grant for NR. Specifically, in a case that interlaced allocation is applied to frequency domain resource allocation of the PUSCH scheduled by the RAR grant, and the bandwidth is 20 MHz and the SCS is 15 kHz, the number of bits necessary for the PFRA field may be reduced to the maximum of 10 bits from the maximum of 14 bits. Note that the remaining 4 bits may be secured for the UL grant (RAR grant) as the R bits, or may be used for one or multiple fields for scheduling an Msg3 PUSCH for NR-U.

In NR-U, in order to secure a period for performing LBT before transmitting the Msg3 PUSCH, a field (PUSCH starting position field, PSP field) indicating a transmission start position of the PUSCH may be set to the RAR grant. The details thereof will be described later.

In NR-U, a channel access type field may be set (added) to the RAR grant. Note that the channel access type field is a field indicating type 1 CAP or type 2 CAP, and may include 1 bit.

In NR-U, the CAPC field may be set to the RAR grant. The CAPC field may include 2 bits. Based on the value of CAPC, the terminal apparatus 1 may be configured with priority of the PUSCH (Msg3 PUSCH) scheduled by the RAR grant. The priority of the PUSCH may be used for determining the value of the CWS used for the type 1 CAP. Based on the value of the CAPC field, the value of the CWS used for the type 1 CAP may be determined. Note that, in a case that the value of CAPC applied to the PUSCH scheduled by the RAR grant is a prescribed value, the CAPC field need not be set to the RAR grant. Here, the prescribed value may be determined in advance based on a specification or the like. Here, the prescribed value may be determined based on a higher layer parameter.

Regarding FIG. 18, various fields of the RAR grant corresponding to NR-U may be configured by adjusting the types (number) and the size (number of bits) of various fields constituting the RAR grant (UL grant included in the MAC RAR) without changing the configuration of the MAC RAR.

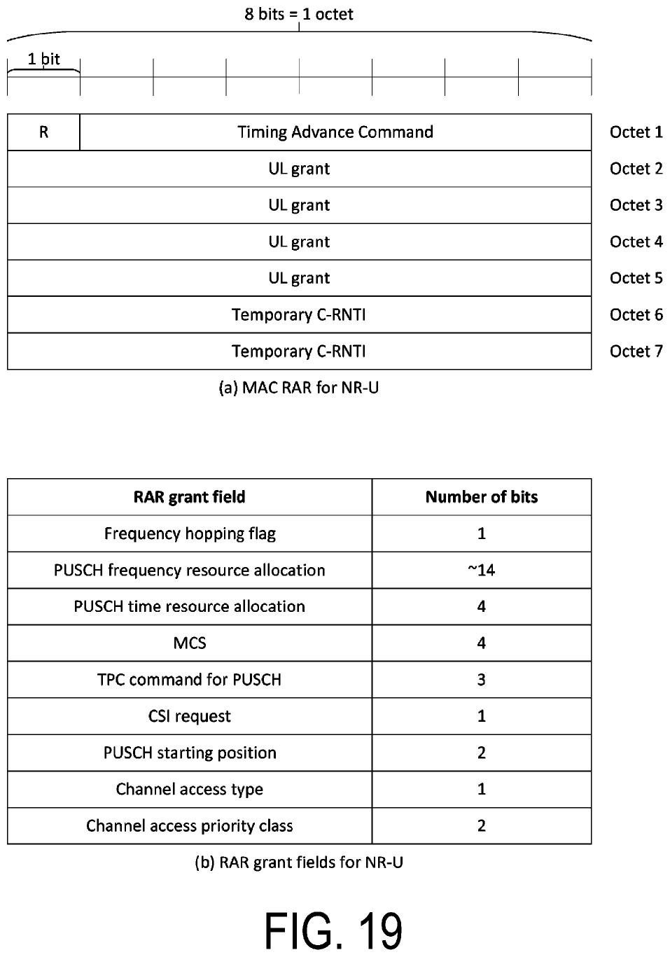

FIG. 19 is a diagram illustrating another example (example 2) of the configuration of the MAC RAR and the RAR grant fields for NR-U according to the present embodiment. FIG. 19(a) illustrates a configuration of the MAC RAR and the MAC payload for NR-U. FIG. 19(b) illustrates an example of a configuration of fields of the RAR grant corresponding to the UL grant in the MAC RAR of FIG. 19(a).

FIG. 19(a) is the MAC RAR applied in a case that it is assumed that cell coverage for NR-U is smaller as compared to that of NR and it is thus assumed that a TA value is also smaller as compared to that of NR. An application range of the TA value is narrower, and thus the number of bits constituting the TAC field may also be smaller as compared to that of NR. The range of the value that can be indicated by the TAC field included in the MAC RAR may also be narrower as compared to that of NR. The TAC field of FIG. 19(a) may include 7 bits, instead of 12 bits, for example. In other words, the number of bits of the TAC field included in the MAC RAR for NR-U may be smaller than the number of bits of the TAC field included in the MAC RAR for NR.

Regarding the UL grant included in the MAC RAR, the size of the UL grant may be extended by being configured using reduced bits of the TAC field.

FIG. 19(b) illustrates an example of the fields constituting the extended UL grant (RAR grant). The size of the FHF field and the PFRA field may be the same as that of NR. In other words, the same allocation as that of NR may be applied to resource allocation of the PUSCH scheduled by the RAR grant in the frequency domain. In this configuration, even in a case that the CAT field, the CAPC field, and the like that are necessary for communication of NR-U are added, the size (a total number of bits and/or number of octets) of the MAC RAR used for NR-U can be arranged to have the same size as that of NR.

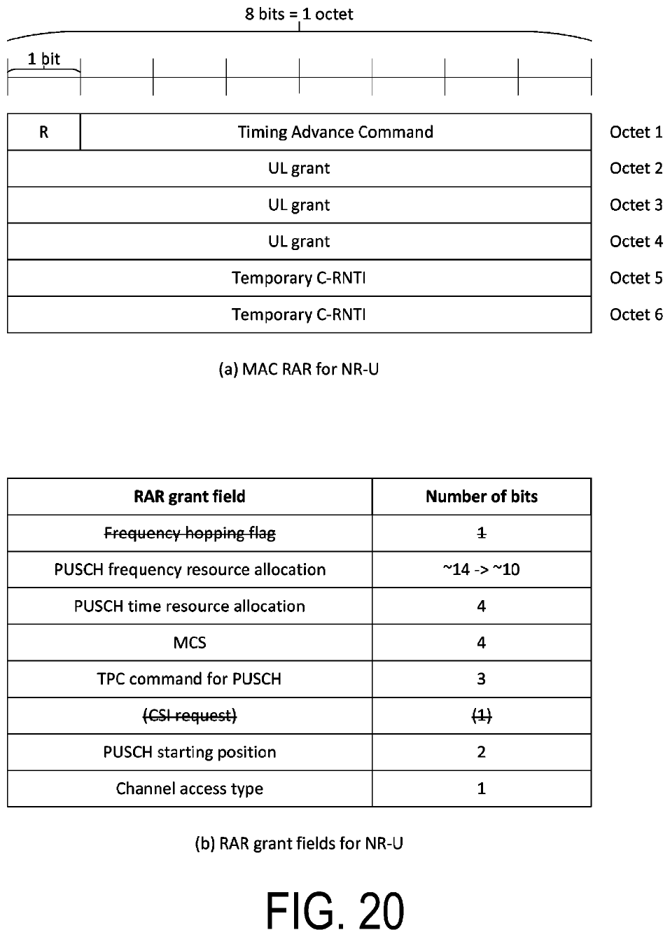

FIG. 20 is a diagram illustrating another example (example 3) of the configuration of the MAC RAR and the RAR grant fields for NR-U according to the present embodiment. FIG. 20(a) illustrates a configuration of the MAC RAR and the MAC payload for NR-U. FIG. 20(b) illustrates an example of a configuration of fields of the RAR grant corresponding to the UL grant in the MAC RAR of FIG. 20(a).

FIG. 20 has a purpose of reducing the size of the MAC RAR. By reducing the size of the MAC RAR, power necessary for transmission of the MAC RAR can be reduced according to cell coverage.

In FIG. 20(a), the size of the TAC field included in the MAC RAR may include 7 bits, and the size of the UL grant may include 3 octets (24 bits), and the TC-RNTI may include 2 octets (16 bits).

FIG. 20(b) illustrates an example of various fields constituting the RAR grant in a case that the size of the UL grant (RAR grant) included in the MAC RAR is 3 octets, and the number of bits thereof. It is assumed that only interlaced allocation is supported for frequency domain resource allocation of the PUSCH. Thus, the FHF field need not be set to the RAR grant. Regarding the size of the PFRA field, in a case that only interlaced allocation is supported, and the bandwidth is 20 MHz and the SCS is 15 kHz, the maximum multiplexing order of the terminal apparatus 1 in the frequency domain can be 10. In a case that the number of bits of the PFRA field includes a bitmap of the maximum multiplexing order, the size of the PFRA field for NR-U may be the size (for example, the maximum of 10 bits) of the bitmap of the maximum multiplexing order in the frequency domain of NR-U, not the number of bits (for example, the maximum of 14 bits) of the PFRA field for NR. In such a case, the size of the PFRA field for NR-U may be smaller than the size (for example, the maximum of 14 bits) of the PFRA field for NR. In other words, the size of the PFRA field included in the RAR grant for NR-U may be determined based on the size of the bitmap necessary for the maximum multiplexing order of the terminal apparatus 1 in a case that interlaced allocation is applied. In a case that the size of the PFRA field is 10 bits, and the maximum multiplexing order of the terminal apparatus 1 is smaller than 10 by a combination of another SCS and bandwidth, that is, the number of bits of the bitmap necessary for the PFRA field is smaller than 10 bits, the remaining bits of the PFRA field may be secured as the R bits. For example, in a case that the maximum multiplexing order of the terminal apparatus 1 is 5, the size of the bitmap constituting the PFRA field being 5 bits is sufficient, and thus other 5 bits of the 10 bits of the PFRA field may be secured as the R bits.

In FIG. 20(b), at least in a case of CBRA, the R bits for the CSI request field may be reduced. In other words, in a case that the size of the RAR grant is smaller than 27 bits, the CSI request field need not be included in the RAR grant.

In FIG. 20(b), that is, in a case that the size of the RAR grant for NR-U is smaller than the size of the RAR grant for NR, it may be assumed that the value of CAPC is invariably a prescribed value (prescribed class, prescribed index) for the PUSCH scheduled by the RAR grant. Here, the prescribed value may be determined in advance based on a specification or the like. Here, the prescribed value may be given by a higher layer parameter. In this manner, the CAPC field need not be included in the RAR grant, and thus the size of the RAR grant for NR-U can be reduced.

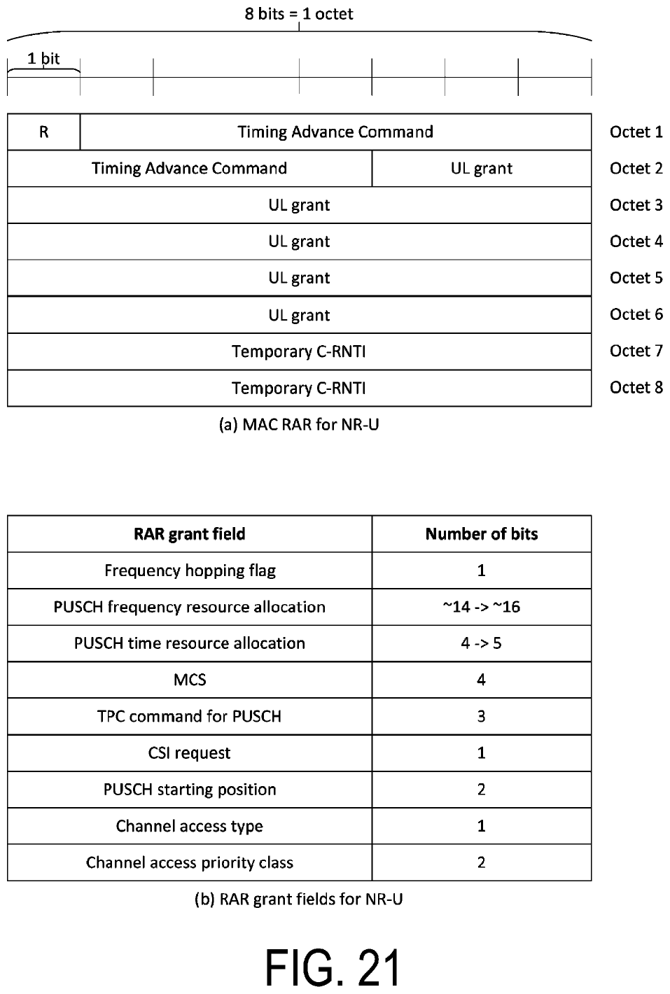

FIG. 21 is a diagram illustrating another example (example 4) of the configuration of the MAC RAR and the RAR grant fields for NR-U according to the present embodiment. FIG. 21(a) illustrates a configuration of the MAC RAR and the MAC payload for NR-U. FIG. 21(b) illustrates an example of a configuration of fields of the RAR grant corresponding to the UL grant in the MAC RAR of FIG. 21(a).

FIG. 21(a) illustrates a configuration of fields in a case that the size of the MAC RAR for NR-U is extended further than the size of the MAC RAR for NR. The size of the TAC field and the size of the TC-RNTI included in the fields of the MAC RAR of FIG. 21(a) may be the same sizes as the fields included in the MAC RAR for NR. The size of the UL grant may be larger than the size of the UL grant for NR. Although FIG. 21(a) illustrates a case of being extended only by 1 octet, the size of the UL grant may be extended by larger than 1 octet as compared to the case of NR.

FIG. 21(b) illustrates an example of various fields constituting the RAR grant corresponding to the UL grant of FIG. 21(a). In this case, regarding PFRA, both of contiguous allocation and interlaced allocation can be supported. In a case that frequency hopping is also possible, the FHF field may be included in the RAR grant. In a case that the bandwidth is wider than 20 MHz, the size of the PFRA field may be extended from the maximum of 14 bits to the maximum of 16 bits according to the maximum transmission bandwidth (for example, 275 PRBs in a case that the SCS is 60 kHz and the bandwidth is 80 MHz). Regarding PTRA, the size of the PTRA field may be extended from 4 bits to 5 bits so that both of the inside of the COT and the outside of the COT can be indicated. In addition, the PSP field, the CAT field, and the CAPC field that are necessary for the RAR grant for NR-U may be set.

In FIG. 21, whether or not the size of the MAC RAR is extended may be determined based on a higher layer parameter related to the size of the MAC RAR.

In FIG. 21, whether or not the size of the PFRA field is extended may be determined based on a higher layer parameter related to PFRA. Note that, in a case that the size of the PFRA field is not extended, the remaining bits may be secured as the R bits.

In FIG. 21, whether or not the size of the PTRA field is extended may be determined based on a higher layer parameter related to PTRA. Note that, in a case that the size of the PTRA field is not extended, the remaining bits may be secured as the R bits.

Whether or not each of the size of the PFRA field and/or the size of the PTRA field is extended may be determined based on a higher layer parameter.

In FIG. 21, in a case that the size of the PFRA field is determined based on the size of the bitmap related to the maximum multiplexing order of the terminal apparatus 1 in the frequency domain, the remaining bits not used for the bitmap may be secured as the R bits.

In FIG. 18 to FIG. 21, in a case that one or multiple R bits are secured for the UL grant, the R bits may be used for extending the TC-RNTI, or may be used for extending the RAPID.

Whether or not the base station apparatus 3 generates the Msg2 by using any one MAC RAR out of the MAC RARs illustrated in FIG. 17 to FIG. 21 for NR-U may be determined based on an index of the random access preamble and/or a value of the RAPID received by the base station apparatus 3.

Whether or not the Msg2 is generated by using any one MAC RAR out of the MAC RARs illustrated in FIG. 17 to FIG. 21 for NR-U may be determined based on a higher layer parameter.

In the present embodiment, in a case that the FHF field is set to the RAR grant, and interlaced allocation is applied, the value of the FHF field is not set to “1”. In other words, in such a case, the terminal apparatus 1 need not be expected that frequency hopping is indicated in the FHF field.

Note that whether or not the FHF field is included in the RAR grant for NR-U may be determined based on whether only contiguous allocation is applied, whether only interlaced allocation is applied, or whether both of contiguous allocation and interlaced allocation are applied to resource allocation (frequency resource allocation) for the PUSCH scheduled by the RAR grant. For example, in a case that only contiguous allocation or contiguous allocation and interlaced allocation are applied to the resource allocation, the FHF field may be included in the RAR grant.

Whether either one or both of contiguous allocation and/or interlaced allocation is applied to frequency resource allocation of the PUSCH (Msg3 PUSCH) scheduled by the RAR grant in NR-U may be determined based on a higher layer parameter. Whether or not the FHF field is included in the RAR grant for NR-U may be determined based on a higher layer parameter.

In the present embodiment, regarding whether or not the CAT field is set to the RAR grant for NR-U, in a case that both of the type 1 CAP and the type 2 CAP can be selected for the CAT for the PUSCH scheduled by the RAR grant, the CAT field may be set to the RAR grant.

In other words, in a case that the CAT applied to the PUSCH scheduled by the RAR grant is either one of the type 1 CAP or the type 2 CAP, the CAT field need not be set to the RAR grant.

In the present embodiment, whether or not the CAPC field is set to the RAR grant for NR-U may be determined based on whether or not the CAPC for the PUSCH scheduled by the RAR grant is a prescribed CAPC. In a case that the CAPC for the PUSCH scheduled by the RAR grant is the prescribed CAPC, the CAPC field need not be set to the RAR grant.

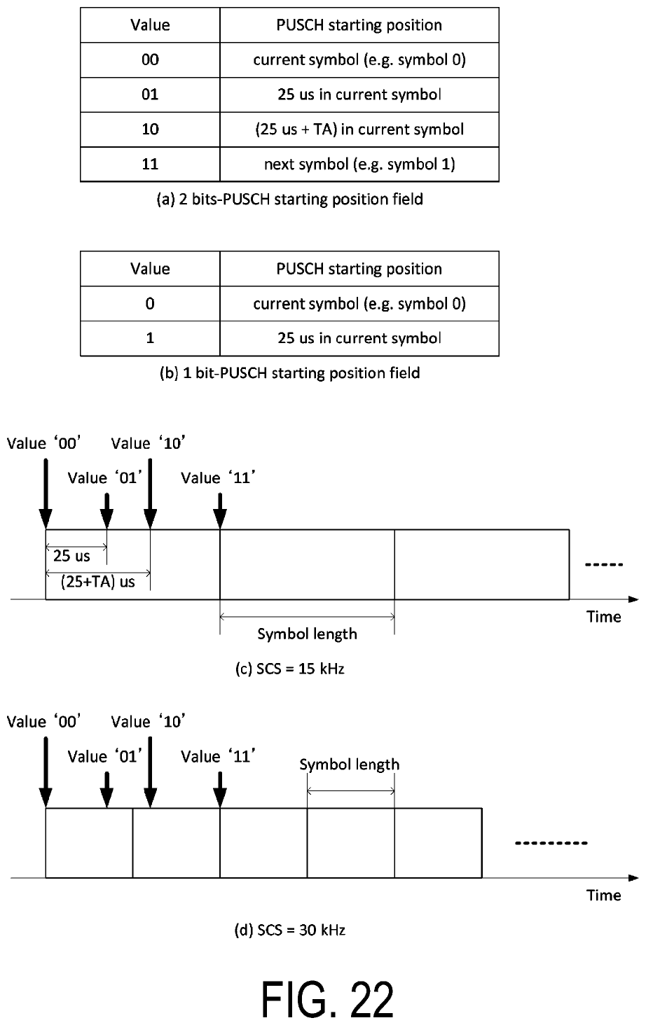

FIG. 22 is a diagram illustrating an example of fields (PUSCH starting position field, PSP field) indicating the transmission start position of the PUSCH in the time domain (start position in the time domain, start position in the slot) and the start position of the PUSCH corresponding to each SCS according to the present embodiment. FIGS. 22(a) and (b) illustrate an example of fields (2-bit field, 1-bit field) indicating the transmission start position of the PUSCH. The fields are fields used for providing a gap (period) for the terminal apparatus 1 to perform LBT by adjusting transmission timing in a time symbol space. For example, in a case that a value “00” or “0” is set to the fields, this indicates that transmission of the physical channel/physical signal can be performed from the start of the first time symbol space. In a case that a value “01”, “10”, or “1” is set to the fields, this indicates that transmission of the physical channel/physical signal can be performed from the middle of the first time symbol space. In a case that a value “01” or “1” is set to the fields, this indicates that transmission can be performed from 25 microseconds (us) in the first time symbol space of the PUSCH. For example, regarding the 25 microseconds, the terminal apparatus 1 can perform transmission after performing LBT of 25 microseconds only once. In a case that a value “10” is set to the fields, this indicates that transmission can be performed from (25+Timing Advance (TA)) microseconds (us) in the first time symbol space of the PUSCH. In a case that a value “11” is set to the fields, this indicates that transmission of the physical channel/physical signal can be performed from the next time symbol space. Depending on the value of the SCS, the length of one time symbol space corresponding to the SCS may be shorter than 25 microseconds and/or (25+TA) microseconds. In such a case, in a case that the value “11” is set to the fields, this may indicate an initial time symbol space after the elapse of 25 microseconds or (25+TA) microseconds after the first time symbol space. FIG. 22(c) illustrates an example of the start position of the PUSCH of each value in a case that the SCS is 15 kHz. FIG. 22(d) illustrates an example of the start position of the PUSCH of each value in a case that the SCS is 30 kHz.

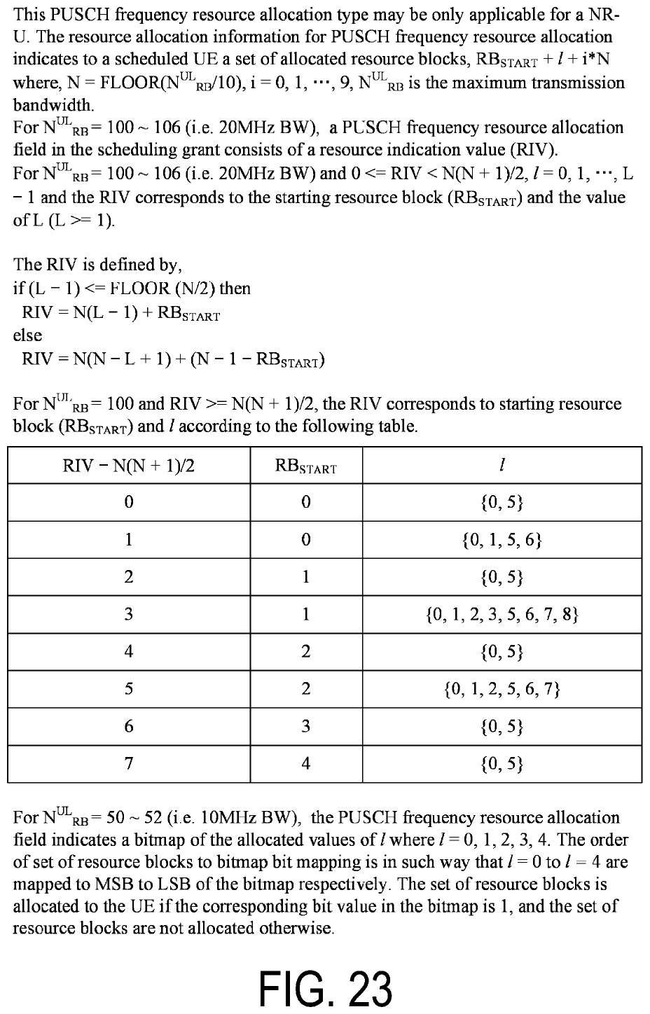

FIG. 23 is a diagram illustrating an example of a frequency resource allocation type of the PUSCH for NR-U according to the present embodiment. In a case that a specific PUSCH frequency resource allocation type is applied to NR-U, the PUSCH frequency resource allocation field included in the UL grant may be indicated by a Resource information Value (RIV). The RIV may be determined based on the start position of resource allocation (RB_{Start}), a maximum transmission bandwidth (N^{UL}_{RB}), and a value of L. The RIV may be expressed as a bitmap, based on whether the maximum transmission bandwidth corresponds to 20 MHz or corresponds to 10 MHz. Note that the maximum transmission bandwidth may be referred to as a maximum uplink transmission bandwidth.

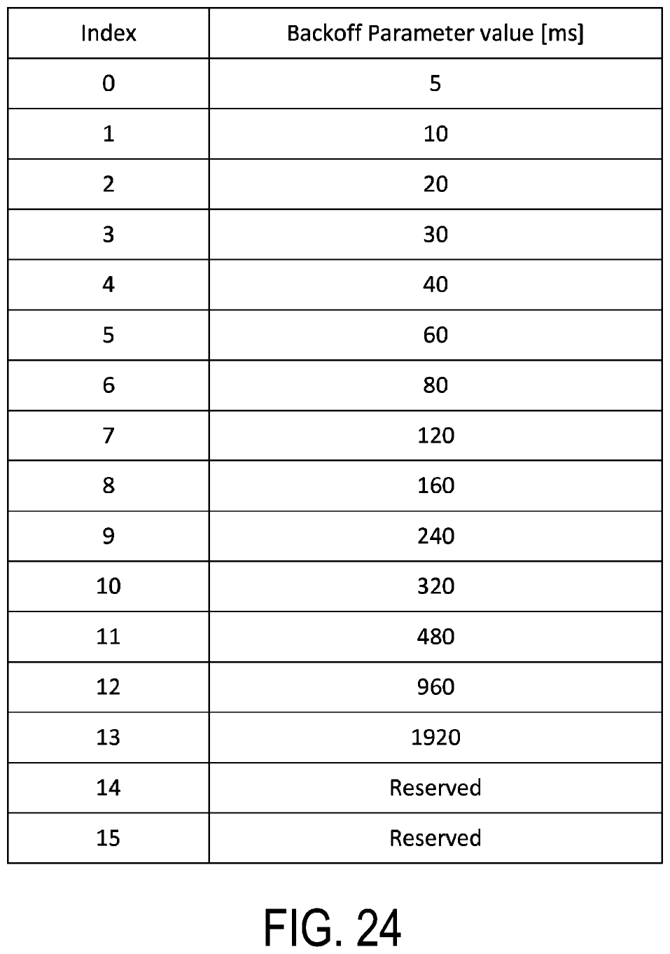

FIG. 24 is a diagram illustrating an example of the Backoff Parameter value (BPV) according to the present embodiment. The BPI corresponds to an index given by the BI. For example, in a case that the value set to the BI field is 0, the back-off time is set based on the BPV (5 ms) corresponding to index 0 of FIG. 24. In a case that the value of the BI is 7, the back-off time is set based on the BPV (120 ms) corresponding to index 7 of FIG. 24. The MAC entity of the terminal apparatus 1 may select the value of the back-off time from 0 to the BPV at random (or based on a random function, or according to uniform distribution).

A Random Access Response (RAR) reception procedure according to the present embodiment will be described.

Regardless of whether or not there is a measurement gap right after a Random Access Preamble (RAP) is transmitted, in a case that a CFRA preamble for a Beam Failure Recovery Request (BFRR) is transmitted by the MAC entity of the terminal apparatus 1, the MAC entity may start ra-ResponseWindow including BeamFailureRecoveryConfig in the first PDCCH occasion since the end of RAP transmission, and monitor PDCCH transmission in the search space indicated by recoverySearchSpaceId of the SpCell identified by the C-RNTI while ra-ResponseWindow is running, otherwise, the MAC entity may start ra-ResponseWindow including RACH-ConfigCommon in the first PDCCH occasion since the end of RAP transmission, and monitor the PDCCH of the SpCell for one or multiple RARs identified by the RA-RNTI while ra-ResponseWindow is running.

In a case that notification of reception of PDCCH transmission in the search space indicated by recoverySearchSpaceId is received from a lower layer (physical layer) in the serving cell in which the RAP is transmitted, the PDCCH transmission is addressed to the C-RNTI, and the CFRA preamble for the BFRR is transmitted by the MAC entity, the MAC entity may consider that the MAC entity has successfully completed the random access procedure.

In a case that downlink assignment is received on the PDCCH for the RA-RNTI, the received TB is successfully decoded, and the RAR includes the MAC subPDU with the BI, the MAC entity may set PREAMBLE_BACKOFF to the value of the BI field of the MAC subPDU by using the table illustrated in FIG. 24 in consideration of SCALING_FACTOR_BI. Otherwise, the MAC entity may set PREAMBLE_BACKOFF to 0 ms.

In a case that the RAR includes the MAC subPDU with the RAPID corresponding to transmitted PREAMBLE_INDEX, the MAC entity may consider that the MAC entity has succeeded in RAR reception.

In a case that ra-ResponseWindow configured for BeamFailureRecoveryConfig expires, and PDCCH transmission in the search space indicated by recoverySearchSpaceId addressed to the C-RNTI is not received in the serving cell in which the RAP is transmitted, or in a case that ra-ResponseWindow configured for RACH-ConfigCommon expires, and the RAR including the RAPID matching the transmitted PREAMBLE_INDEX is not received, the MAC entity may consider that RAR reception has failed to succeed, and increment PREAMBLE_TRANSMISSION_COUNTER by 1, and in a case that PREAMBLE_TRANSMISSION_COUNTER=preambleTransMax+1 is satisfied, and the RAP is transmitted in the SpCell, the MAC entity may indicate the random access problem to a higher layer (for example, the RRC layer), and in a case that the random access procedure is triggered for the SI request, the MAC entity may consider that the MAC entity has failed to succeed in completion of the random access procedure. In a case that the RAP is transmitted in the SCell, the MAC entity may consider that the MAC entity has failed to succeed in completion of the random access procedure.

Next, contention resolution according to the present embodiment will be described.

Right after the Msg3 is transmitted, the MAC entity may start ra-ContentionResolutionTimer, restart ra-ContentionResolutionTimer at each HARQ retransmission in the first symbol after the end of the Msg3 transmission, and monitor the PDCCH while ra-ContentionResolutionTimer is running regardless of whether or not there is a measurement gap, and in a case that notification of reception of the PDCCH transmission of the SpCell is received from the lower layer, and a C-RNTI MAC CE is included in the Msg3, the random access procedure may be started for the beam failure recovery, the random access procedure may be started by the PDCCH order regarding whether or not the PDCCH transmission is addressed to the C-RNTI, and the random access procedure may be started by the MAC sublayer or the RRC sublayer regarding whether or not the PDCCH transmission is addressed to the C-RNTI, and in a case that the PDCCH transmission is addressed to the C-RNTI, and includes the UL grant for new transmission, the MAC entity may consider that the contention resolution has succeeded, stop ra-ContentionResolutionTimer, discard TEMPORARY_C-RNTI, and consider that the MAC entity has successfully completed the random access procedure.

In a case that a CCCH Service Data Unit (SDU) is included in the Msg3, the PDCCH transmission is addressed to TEMPORARY_C-RNTI, and the MAC PDU is successfully decoded, the MAC entity stops ra-ContentionResolutionTimer, in a case that the MAC PDU includes a UE contention resolution identifier MAC CE, and the UE contention resolution identifier in the MAC CE matches the CCCH SDU transmitted in the Msg3, the MAC entity considers that the MAC entity has succeeded in contention resolution, and ends deassembly and demultiplexing of the MAC PDU, and in a case that the random access procedure is started for the SI request, the MAC entity indicates reception of an acknowledgement for the SI request for a higher layer. In addition, the MAC entity may set the value of TEMPORARY_C-RNTI to the C-RNTI. The MAC entity may discard TEMPORARY_C-RNTI, and consider that the random access procedure has successfully completed. In a case that the UE contention resolution identifier in the MAC CE does not match the CCCH SDU transmitted in the Msg3, TEMPORARY_C-RNTI may be discarded, it may be considered that contention resolution has failed to succeed, and the successfully decoded MAC PDU may be discarded.

In a case that ra-ContentionResolutionTimer expires, the MAC entity may discard TEMPORARY_C-RNTI, and consider that the contention resolution has failed to succeed.

In a case that it is considered that contention resolution has failed to succeed, the MAC entity flushes the HARQ buffer used for transmission of the MAC PDU in the Msg3 buffer, and increments PREAMBLE_TRANSMISSION_COUNTER by 1, and in a case that PREAMBLE_TRANSMISSION_COUNTER=preambleTransMax+1 is satisfied, the MAC entity indicates the random access problem to a higher layer. In a case that the random access procedure is triggered for the SI request, the MAC entity may consider that the MAC entity has failed to succeed in completion of the random access procedure.

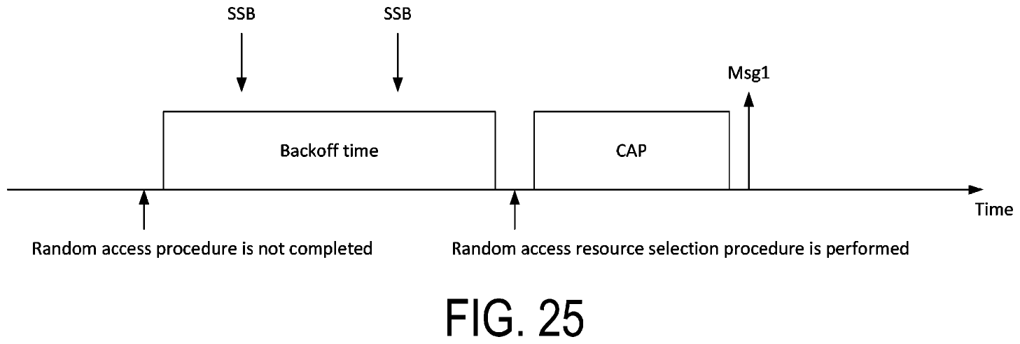

Next, processing of a case that the random access procedure has not completed according to the present embodiment will be described. FIG. 25 is a diagram illustrating a procedure until the Msg1 is transmitted in a case that the random access procedure has not completed according to the present embodiment.

In a case that the random access procedure does not complete, the MAC entity may set back-off time at random according to uniform distribution from 0 to PREAMBLE_BACKOFF, and in a case that a criterion for selecting the CFRA resource is satisfied during the back-off time, the MAC entity may perform the random access resource selection procedure. Otherwise the MAC entity may perform the random access resource selection procedure after the back-off time. Note that the terminal apparatus 1 may receive the SSB and measure the RSRP and the like during the back-off time.

Next, a CAT selection procedure applied before Msg1 transmission for NR-U according to the present embodiment will be described.

In a case that a value obtained based on the BPV and SCALING_FACTOR_BI (value set to 6H) is set to PREAMBLE_BACKOFF, and it is considered that the random access procedure does not complete, the random back-off time may be selected according to uniform distribution from 0 to PREAMBLE_BACKOFF. Note that the value set to SCALING_FACTOR_BI may be given by a higher layer parameter scalingFactorBI. The value set to SCALING_FACTOR_BI may be set to 1 in a case that the random access procedure is started.

In a case that the value set to PREAMBLE_BACKOFF is a value the same as or larger than a prescribed value (for example, 100 ms), and Msg1 transmission is performed after the type I CAP is performed, it may be considered that the value of Nᵢₙᵢₜ is 0. In a case that the value set to PREAMBLE_BACKOFF is a value smaller than the prescribed value (for example, 100 ms), and the Msg1 transmission is performed after the type 1 CAP is performed, the transmission of the Msg1 may be performed after the type 1 CAP has succeeded.

In a case that the type 1 CAP is applied, the Msg1 transmission may be performed based on a larger value as a result of comparison between the value set to PREAMBLE_BACKOFF and a total CCA period obtained by the CWS.

In a case that “0 (zero)” is set to the higher layer parameter scalingFactorBI and/or SCALING_FACTOR_BI, the CAP may be performed based on the applied CAT before the Msg1 transmission. In other words, in such a case, the Msg1 may be transmitted after the type 1 CAP or the type 2 CAP is performed. For example, in a case that “0 (zero)” is set to the higher layer parameter scalingFactorBI, the type of the CAP (in other words, the CAT) performed before Msg1 transmission may be a prescribed CAT. The prescribed CAT may be determined based on a higher layer parameter. The prescribed CAT may be given by DCI. The prescribed CAT may be determined in advance by a specification or the like.

Regarding the MAC entity of the terminal apparatus 1, in a case that the MAC subPDU with the BI is included in the received RAR, the MAC entity may set the value of the BI that takes SCALING_FACTOR_BI into consideration to PREAMBLE_BACKOFF, otherwise, the MAC entity may set the value to 0 ms. In a case that the PREAMBLE_BACKOFF is a value larger than or the same as a prescribed value (for example, 20 ms, 100 ms, or the like), and the random access procedure has not completed, the MAC entity can set back-off time at random according to uniform distribution from 0 to the PREAMBLE_BACKOFF, perform the random access resource selection procedure after the back-off time has elapsed, determine the random access resource (in other words, the RAP, the Msg1), and perform the type 2 CAP before transmission of the Msg1, and in a case that the terminal apparatus 1 considers (determines) that the channel (the NR-U channel, the BWP, the carrier) used for transmitting the Msg1 is clear, the MAC entity can transmit the Msg1. In a case that the PREAMBLE_BACKOFF is a value smaller that the prescribed value (for example, 20 ms, 100 ms, or the like), the MAC entity sets back-off time at random according to uniform distribution from 0 to the PREAMBLE_BACKOFF, performs the random access resource selection procedure after the back-off time has elapsed, determines the random access resource (in other words, the RAP, the Msg1), and performs the type 1 CAP before transmission of the Msg1. In other words, the terminal apparatus 1 may select the CAT performed before Msg1 transmission, based on the value set to PREAMBLE_BACKOFF. Note that the prescribed value may be determined based on a higher layer parameter. The prescribed value may be determined in advance by a specification or the like. The terminal apparatus 1 may select the type 1 CAP in a case that 0 ms is set to PREAMBLE_BACKOFF.

In a case that the MAC subPDU with the BI is not included in the received RAR, and the random access procedure has not completed, the MAC entity of the terminal apparatus 1 may transmit the Msg1 after performing the type 1 CAP.

The MAC entity of the terminal apparatus 1 may determine the CAT before Msg1 transmission according to the value of the back-off time selected at random. For example, based on whether or not the back-off time configured based on PREAMBLE_BACKOFF is larger than the prescribed value (for example, 20 ms, 100 ms, or the like), the terminal apparatus 1 may determine whether the terminal apparatus 1 performs the type 1 CAP or performs the type 2 CAP (in other words, the CAT).

In the present embodiment, in a case that the CAP performed before Msg1 transmission is performed, the type of the CAP (in other words, the CAT) may be determined based on a higher layer parameter. The CAT may be given by DCI. The CAT may be determined in advance by a specification or the like.

In a case that the type 1 CAP is performed before Msg1 transmission, and the back-off time or the value of PREAMBLE_BACKOFF is smaller than the prescribed value, the terminal apparatus 1 may adjust the CWS after changing the value of CW, corresponding to the index p of the CAPC applied to the type 1 CAP to one higher value. For example, to give description with reference to FIG. 9, in a case that the value p of CAPC is 1, the value of CWₚ is 3, and the back-off time or the value of PREAMBLE_BACKOFF is smaller than the prescribed value, the terminal apparatus 1 may adjust the CWS after setting the value of CWₚ corresponding to the index of the CAPC applied to the type 1 CAP to 7.

In a case that the type 1 CAP is performed before Msg1 transmission, and the back-off time or the value of PREAMBLE_BACKOFF is larger than the prescribed value, the terminal apparatus 1 may adjust the CWS after changing the value of CW, corresponding to the index p of the CAPC applied to the type 1 CAP to one higher value. For example, to give description with reference to FIG. 9, in a case that the value p of CAPC is 1, the value of CWₚ is 3, and the back-off time or the value of PREAMBLE_BACKOFF is smaller than the prescribed value, the terminal apparatus 1 may adjust the CWS after setting the value of CWₚ corresponding to the index of the CAPC applied to the type 1 CAP to 7.

In a case that the type 1 CAP is performed before Msg1 transmission, and the back-off time or the value of PREAMBLE_BACKOFF is larger than the prescribed value, the terminal apparatus 1 may adjust the CWS after changing the value of CWₚ corresponding to the index p of the CAPC applied to the type 1 CAP to one lower value. For example, to give description with reference to FIG. 9, in a case that the value p of CAPC is 1, the value of CW, is 7, and the back-off time or the value of PREAMBLE_BACKOFF is smaller than the prescribed value, the terminal apparatus 1 may adjust the CWS after setting the value of CW, corresponding to the index of the CAPC applied to the type 1 CAP to 3.

In a case that the type 1 CAP is performed before Msg1 transmission, and the back-off time or the value of PREAMBLE_BACKOFF is smaller than the prescribed value, the terminal apparatus 1 may lower the value of the index p of the CAPC applied to the type 1 CAP by one stage. In other words, in a case that the back-off time or the value of PREAMBLE_BACKOFF is smaller than the prescribed value, the terminal apparatus 1 may lower the priority of the type 1 CAP before Ms1 transmission.

In a case that the type 1 CAP is performed before Msg1 transmission, and the back-off time or the value of PREAMBLE_BACKOFF is larger than the prescribed value, the terminal apparatus 1 may lower the value of the index p of the CAPC applied to the type 1 CAP by one stage. In other words, in a case that the back-off time or the value of PREAMBLE_BACKOFF is smaller than the prescribed value, the terminal apparatus 1 may lower the priority of the type 1 CAP before Ms1 transmission.

In a case that the type 1 CAP is performed before Msg1 transmission, and the back-off time or the value of PREAMBLE_BACKOFF is smaller than the prescribed value, the terminal apparatus 1 may raise the value of the index p of the CAPC applied to the type 1 CAP by one stage. In other words, in a case that the back-off time or the value of PREAMBLE_BACKOFF is smaller than the prescribed value, the terminal apparatus 1 may raise the priority of the type 1 CAP before Ms1 transmission.

In a case that the type 1 CAP is performed before Msg1 transmission, and the back-off time or the value of PREAMBLE_BACKOFF is larger than the prescribed value, the terminal apparatus 1 may raise the value of the index p of the CAPC applied to the type 1 CAP by one stage. In other words, in a case that the back-off time or the value of PREAMBLE_BACKOFF is larger than the prescribed value, the terminal apparatus 1 may raise the priority of the type 1 CAP before Ms1 transmission.

In a case that the type 1 CAP is performed before Msg1 transmission, the value of the CWS used for the type I CAP may be adjusted based on whether or not the back-off time or the value of PREAMBLE_BACKOFF is larger than the prescribed value (or whether or not the back-off time or the value of PREAMBLE_BACKOFF is smaller than the prescribed value). Whether or not the value of the CWS is adjusted based on the back-off time or the value of PREAMBLE_BACKOFF may be determined based on a higher layer parameter, or may be determined in advance by a specification or the like.

Various aspects of apparatuses according to an aspect of the present embodiment will be described below.

(1) In order to achieve the aforementioned object, aspects of the present invention provide the following measures. Specifically, the first aspect of the present invention is a terminal apparatus including: a radio transmission and/or reception unit configured to transmit a random access preamble and monitor a corresponding random access response (RAR) in a random access procedure; and a Medium Access Control (MAC) layer processing unit configured to increment a value of a preamble transmission counter for counting a number of times of transmission of the random access preamble in a case that the MAC layer processing unit considers that the MAC layer processing unit has failed to succeed in reception of the RAR, wherein the radio transmission and/or reception unit performs Clear Channel Assessment (CCA) before transmitting the random access preamble in a New Radio—Unlicensed (NR-U) carrier, and sets an initial value Nᵢₙᵢₜ used for determining a measurement period for the CCA to a counter N, wherein the Nᵢₙᵢₜ is determined based on a value (CW size) of a Contention Window (CW) configured for at least the random access preamble before the Nᵢₙᵢₜ is set to the N, and the value of the CW is updated in a case that a value of the preamble transmission counter is incremented.

(2) The second aspect of the present invention is the terminal apparatus according to the first aspect, wherein in the random access procedure, the terminal apparatus succeeds in reception of the RAR, transmits a PUSCH (Msg3) corresponding to the RAR, and monitors a contention resolution message (Msg4) corresponding to the Msg3, and in the NR-U carrier, in a case that the terminal apparatus considers that the terminal apparatus has failed to succeed in reception of the Msg4, the terminal apparatus increments the value of the preamble transmission counter, and updates the value of the CW.

(3) The third aspect of the present invention is a method used for a terminal apparatus, including the steps of: in a random access procedure, transmitting a random access preamble, and monitoring a corresponding random access response (RAR); and in a case that it is considered that reception of the RAR has failed to succeed, incrementing a value of a preamble transmission counter for counting a number of times of transmission of the random access preamble, wherein Clear Channel Assessment (CCA) before transmitting the random access preamble is performed in a New Radio—Unlicensed (NR-U) carrier, and an initial value Nᵢₙᵢₜ used for determining a measurement period for the CCA is set to a counter N, wherein the Nᵢₙᵢₜ is determined based on a value (CW size) of a Contention Window (CW) configured for at least the random access preamble before the Nᵢₙᵢₜ is set to the N, and the value of the CW is updated in a case that a value of the preamble transmission counter is incremented.

(4) The fourth aspect of the present invention is the method according to the third aspect, wherein in the random access procedure, reception of the RAR succeeds, a PUSCH (Msg3) corresponding to the RAR is transmitted, and a contention resolution message (Msg4) corresponding to the Msg3 is monitored, and in the NR-U carrier, in a case that it is considered that reception of the Msg4 has failed to succeed, the value of the preamble transmission counter is incremented, and the value of the CW is updated.

(5) The fifth aspect of the present invention is a base station apparatus including: a radio transmission and/or reception unit configured to transmit a Physical Downlink Control Channel (PDCCH) order for performing resource allocation of a random access preamble, and monitor a random access preamble corresponding to the PDCCH order after transmitting the PDCCH order, wherein the radio transmission and/or reception unit performs Clear Channel Assessment (CCA) before transmitting the PDCCH order in a New Radio—Unlicensed (NR-U) carrier, and sets an initial value Nᵢₙᵢₜ used for determining a measurement period for the CCA as a value of a counter N, wherein the Nᵢₙᵢₜ is determined based on a value (CW size) of a Contention Window (CW) configured for at least the PDCCH order before the Nᵢₙᵢₜ is set to the N, and the value of the CW is updated in a case that it is considered that reception of the random access preamble has failed to succeed.

(6) The sixth aspect of the present invention is a base station apparatus including: a radio transmission and/or reception unit configured to receive a random access preamble, transmit a corresponding random access response (RAR), and monitor a PUSCH (Msg3) corresponding to the RAR after transmitting the RAR in a random access procedure, wherein the radio transmission and/or reception unit performs Clear Channel Assessment (CCA) before transmitting the RAR in a New Radio—Unlicensed (NR-U) carrier, and sets an initial value Nᵢₙᵢₜ used for determining a measurement period for the CCA as a value of a counter N, wherein the Nᵢₙᵢₜ is determined based on a value (CW size) of a Contention Window (CW) configured for at least the RAR before the Nᵢₙᵢₜ is set to the N, and the value of the CW is updated in a case that it is considered that reception of the Msg3 has failed to succeed.

(7) The seventh aspect of the present invention is a method used for a base station apparatus, including the steps of: transmitting a Physical Downlink Control Channel (PDCCH) order for performing resource allocation of a random access preamble, and monitoring a random access preamble corresponding to the PDCCH order after transmitting the PDCCH order, wherein Clear Channel Assessment (CCA) is performed before transmitting the PDCCH order in a New Radio—Unlicensed (NR-U) carrier, and an initial value Nᵢₙᵢₜ used for determining a measurement period for the CCA is set as a value of a counter N, wherein the Nᵢₙᵢₜ is determined based on a value (CW size) of a Contention Window (CW) configured for at least the PDCCH order before the Nᵢₙᵢₜ is set to the N, and the value of the CW is updated in a case that it is considered that reception of the random access preamble has failed to succeed.

(8) The eighth aspect of the present invention is a method used for a base station apparatus, including the steps of: receiving a random access preamble, transmitting a corresponding random access response (RAR), and monitoring a PUSCH (Msg3) corresponding to the RAR after transmitting the RAR in a random access procedure, wherein Clear Channel Assessment (CCA) is performed before transmitting the RAR in a New Radio—Unlicensed (NR-U) carrier, and an initial value Nᵢₙᵢₜ used for determining a measurement period for the CCA is set as a value of a counter N, wherein the Nᵢₙᵢₜ is determined based on a value (CW size) of a Contention Window (CW) configured for at least the RAR before the Nit is set to the N, and the value of the CW is updated in a case that it is considered that reception of the Msg3 has failed to succeed.

(9) The ninth aspect of the present invention is a terminal apparatus including: a physical layer processing unit configured to receive a higher layer signal including a scheduling request configuration (SR configuration) and a physical uplink control channel configuration (PUCCH configuration); and a Medium Access Control (MAC) layer processing unit configured to indicate, to the physical layer processing unit, transmission of an SR for new transmission of an uplink shared channel (UL-SCH), wherein the physical layer processing unit performs Clear Channel Assessment (CCA), based on a type of a channel access procedure before transmitting a PUCCH including the SR in a New Radio—Unlicensed (NR-U) carrier, and sets an initial value Nᵢₙᵢₜ used for determining a measurement period for the CCA to a counter N, wherein the Nᵢₙᵢₜ is determined based on a value (CW size) of a Contention Window (CW) configured for at least the SR before the Nᵢₙᵢₜ is set to the N, and in a case that a number of configurable allowable values of the CW is more than one, the value of the CW is updated in a case that a value of the SR counter is incremented.

(10) The tenth aspect of the present invention is the terminal apparatus according to the ninth aspect, wherein in a case that the physical layer processing unit detects an uplink grant for the new transmission of the UL-SCH after the transmission of the SR, the physical layer processing unit sets the value of the CW to an initial value CWₘᵢₙ.

(11) The eleventh aspect of the present invention is the terminal apparatus according to the ninth aspect, wherein in a case that the physical layer processing unit sets the value of the SR counter to 0, the physical layer processing unit sets the value of the CW to an initial value CWₘᵢₙ.

(12) The twelfth aspect of the present invention is a method used for a terminal apparatus, including the steps of: receiving a higher layer signal including a scheduling request configuration (SR configuration) and a physical uplink control channel configuration (PUCCH configuration); indicating, to a physical layer, transmission of an SR for new transmission of an uplink shared channel (UL-SCH); performing Clear Channel Assessment (CCA), based on a type of a channel access procedure before transmitting a PUCCH including the SR in a New Radio—Unlicensed (NR-U) carrier; and setting an initial value Nᵢₙᵢₜ used for determining a measurement period for the CCA to a counter N, wherein the Nᵢₙᵢₜ is determined based on a value (CW size) of a Contention Window (CW) configured for at least the SR before the Nᵢₙᵢₜ is set to the N, and in a case that a number of configurable allowable values of the CW is more than one, the value of the CW is updated in a case that a value of the SR counter is incremented.

(13) The thirteenth aspect of the present invention is a terminal apparatus including: a receiver configured to receive a CSI-RS; a measuring unit configured to measure and evaluate CSI by using the CSI-RS, and update a value of the CSI; and a transmitter configured to transmit the CSI, wherein in a case that, in one BWP corresponding to one bwp-Id of an NR-U carrier, the measuring unit satisfies a first condition that multiple LBT subbands are configured, a second condition that eqi-FormatIndicator corresponding to the one BWP indicates a wideband CQI, and a third condition that it is indicated that LBT has failed in at least one LBT subband out of the multiple LBT subbands, the measuring unit does not update a value of the wideband CQI.

(14) The fourteenth aspect of the present invention is the terminal apparatus according to the thirteenth aspect, wherein in a case that the measuring unit satisfies the first condition, the third condition, and a fourth condition that eqi-FormatIndicator corresponding to the one BWP indicates a subband CQI, the measuring unit updates a value of the subband CQI in each of one or multiple subbands included in the LBT subband in which LBT has succeeded, and does not update the value of the subband CQI in each of the one or multiple subbands included in the LBT subband in which LBT has failed.

(15) The fifteenth aspect of the present invention is a method used for a terminal apparatus, including the steps of: receiving a CSI-RS; measuring and evaluating CSI by using the CSI-RS; updating a value of the CSI; transmitting the CSI; and in a case that, in one BWP corresponding to one bwp-Id of an NR-U carrier, a first condition that multiple LBT subbands are configured, a second condition that eqi-FormatIndicator corresponding to the one BWP indicates a wideband CQI, and a third condition that it is indicated that LBT has failed in at least one LBT subband out of the multiple LBT subbands are satisfied, not updating a value of the wideband CQI.

(16) The sixteenth aspect of the present invention is the method according to the fifteenth aspect, further including the steps of: in a case that the first condition, the third condition, and a fourth condition that eqi-FormatIndicator corresponding to the one BWP indicates a subband CQI are satisfied, updating a value of the subband CQI in each of one or multiple subbands included in the LBT subband in which LBT has succeeded; and not updating the value of the subband CQI in each of the one or multiple subbands included in the LBT subband in which LBT has failed.

(17) The seventeenth aspect of the present invention is a base station apparatus including: a receiver configured to receive a random access preamble; and a transmitter configured to transmit one or multiple Medium Access Control Random Access Responses (MAC RARs) corresponding to the random access preamble, wherein in a case that the transmitter transmits the MAC RAR to a New Radio Access Technology (NR) cell, the transmitter sets a Timing Advance Command (TAC) field with a first size and an Uplink (UL) grant with a second size, the TAC field and the UL grant being included in the MAC RAR, and in a case that the transmitter transmits the MAC RAR to an NR-Unlicensed (NR-U) cell, the transmitter sets a size of the TAC field with a size smaller than the first size and a size of the UL grant with a size larger than the second size, the TAC field and the UL grant being included in the MAC RAR.

(18) The eighteenth aspect of the present invention is the base station apparatus according to the seventeenth aspect, wherein in the NR-U cell, at least one field out of a Physical Uplink Shared Channel Starting Position (PSP) field, a Channel Access Type (CAT) field, and a Channel Access Priority Class (CAPC) field is set to a Random Access Response (RAR) grant corresponding to the UL grant.

(19) The nineteenth aspect of the present invention is a method used for a base station apparatus, including the steps of: receiving a random access preamble; transmitting one or multiple Medium Access Control Random Access Responses (MAC RARs) corresponding to the random access preamble; in a case that the MAC RAR is transmitted to a New Radio Access Technology (NR) cell, setting a Timing Advance Command (TAC) field with a first size and setting an Uplink (UL) grant with a second size, the TAC field and the UL grant being included in the MAC RAR; and in a case that the MAC RAR is transmitted to an NR-Unlicensed (NR-U) cell, setting a size of the TAC field with a size smaller than the first size and setting a size of the UL grant with a size larger than the second size, the TAC field and the UL grant being included in the MAC RAR.

(20) The twentieth aspect of the present invention is the method according to the nineteenth aspect, wherein in the NR-U cell, at least one field out of a Physical Uplink Shared Channel Starting Position (PSP) field, a Channel Access Type (CAT) field, and a Channel Access Priority Class (CAPC) field is set to a Random Access Response (RAR) grant corresponding to the UL grant.

(21) The twenty-first aspect of the present invention is a terminal apparatus including: a transmitter configured to transmit a random access preamble; and a receiver configured to receive one or multiple Medium Access Control Random Access Responses (MAC RARs) corresponding to the random access preamble, wherein the receiver receives the MAC RAR having a first configuration for a New Radio Access Technology (NR) cell, the receiver receives the MAC RAR having a second configuration for an NR-Unlicensed (NR-U) cell, and a size of the MAC RAR having the first configuration and a size of the MAC RAR having the second configuration are same.

(22) The twenty-second aspect of the present invention is a terminal apparatus including: a transmitter configured to transmit a random access preamble; a receiver configured to receive one or multiple Medium Access Control Random Access Responses (MAC RARs) corresponding to the random access preamble; and a MAC layer unit configured to perform a random access procedure, wherein in a case that the random access procedure is not considered to be complete for an NR-Unlicensed (NR-U) cell, prior to transmission of the random access preamble, the transmitter performs a type 2 Channel Access Procedure (CAP) in a case that a value larger than a prescribed value is set to PREAMBLE_BACKOFF, and the transmitter performs a type 1 CAP in a case that a value smaller than the prescribed value is set to the PREAMBLE_BACKOFF.

(23) The twenty-third aspect of the present invention is a method used for a terminal apparatus, including the steps of: transmitting a random access preamble; receiving one or multiple Medium Access Control Random Access Responses (MAC RARs) corresponding to the random access preamble; performing a random access procedure; and in a case that the random access procedure is not considered to be complete for an NR-Unlicensed (NR-U) cell, prior to transmission of the random access preamble, performing a type 2 Channel Access Procedure (CAP) in a case that a value larger than a prescribed value is set to PREAMBLE_BACKOFF, and performing a type 1 CAP in a case that a value smaller than the prescribed value is set to the PREAMBLE_BACKOFF.

Each of the programs running on the base station apparatus 3 and the terminal apparatus 1 according to the present invention may be a program that controls a Central Processing Unit (CPU) and the like, such that each program causes a computer to operate in such a manner as to realize the functions of the above-described embodiment according to the present invention. Also, the information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the aforementioned embodiment may be partially implemented by a computer. In such a case, a program for implementing such control functions may be recorded on a computer-readable recording medium to cause a computer system to read and execute the program recorded on this recording medium.

Note that it is assumed that the “computer system” mentioned here refers to a computer system built into the terminal apparatus 1 or the base station apparatus 3, and the computer system includes an OS and hardware components such as a peripheral device. Furthermore, a “computer-readable recording medium” refers to a portable medium such as a flexible disk, a magneto-optical disk, a ROM, a CD-ROM, and the like, and a storage device such as a hard disk built into the computer system.

Moreover, the “computer-readable recording medium” may include a medium that dynamically retains the program for a short period of time, such as a communication wire that is used to transmit the program over a network such as the Internet or over a communication line such as a telephone line, and a medium that retains the program for a certain period of time, such as a volatile memory within the computer system which functions as a server or a client in a case that the program is transmitted via the communication wire. Furthermore, the aforementioned program may be configured to implement part of the functions described above, and also may be configured to be capable of implementing the functions described above in combination with a program already recorded in the computer system.

Furthermore, the base station apparatus 3 according to the aforementioned embodiment may be achieved as an aggregation (apparatus group) including multiple apparatuses. Each of the apparatuses included in such an apparatus group may include each function, or some or all portions of each functional block of the base station apparatus 3 according to the aforementioned embodiment. As the apparatus group, it is only necessary to have a complete set of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have some or all of the functions of a higher node for an eNodeB and/or a gNB.

Also, some or all portions of each of the terminal apparatus 1 and the base station apparatus 3 according to the aforementioned embodiment may be implemented as an LSI which is a typical integrated circuit or may be implemented as a chip set. The functional blocks of each of the terminal apparatus 1 and the base station apparatus 3 may be individually implemented as a chip, or some or all of the functional blocks may be integrated into a chip. Furthermore, a circuit integration technique is not limited to the LSI, and may be realized with a dedicated circuit or a general-purpose processor. Moreover, in a case that with advances in semiconductor technology, a circuit integration technology with which an LSI is replaced appears, it is also possible to use an integrated circuit based on the technology.

In addition, although the aforementioned embodiments have described the terminal apparatus as an example of a communication apparatus, the present invention is not limited to such a terminal apparatus, and is applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope not depart from the gist of the present invention. Furthermore, in the present invention, various modifications are possible within the scope of claims, and embodiments that are made by suitably combining technical means disclosed according to the different embodiments are also included in the technical scope of the present invention. Furthermore, a configuration in which elements described in the respective embodiments and having mutually the same effects, are substituted for one another is also included.

1. A terminal apparatus comprising:
a transmitter configured to transmit a random access preamble;
a receiver configured to receive one or multiple Medium Access Control Random Access Responses (MAC RARs) corresponding to the random access preamble; and
a MAC layer unit configured to perform a random access procedure, wherein in a case that the random access procedure is not considered to be complete for an NR-Unlicensed (NR-U) cell, prior to transmission of the random access preamble, the transmitter performs a type 2 Channel Access Procedure (CAP) in a case that a value larger than a prescribed value is set to PREAMBLE_BACKOFF, and the transmitter performs a type 1 CAP in a case that a value smaller than the prescribed value is set to the PREAMBLE_BACKOFF.

2. A method comprising the steps of:
transmitting a random access preamble;
receiving one or multiple Medium Access Control Random Access Responses (MAC RARs) corresponding to the random access preamble;
performing a random access procedure; and
in a case that the random access procedure is not considered to be complete for an NR-Unlicensed (NR-U) cell, prior to transmission of the random access preamble, performing a type 2 Channel Access Procedure (CAP) in a case that a value larger than a prescribed value is set to PREAMBLE_BACKOFF, and performing a type 1 CAP in a case that a value smaller than the prescribed value is set to the PREAMBLE_BACKOFF.
